(19) United States
(12) Patent Application Publication
(10) Pub. No.: US 2026/0202615 A1
(43) Pub. Date: Jul. 16, 2026

(54) SEMICONDUCTOR WAVEGUIDE STRUCTURE AND METHOD OF FORMING THE SAME

(71) Applicant: TAIWAN SEMICONDUCTOR MANUFACTURING COMPANY LTD., HSINCHU (TW)

(72) Inventors: WEN-SHUN LO, HSINCHU COUNTY (TW); LEE-SHIAN JENG, HSINCHU CITY (TW); CHUN-HUNG CHEN, HSINCHU CITY (TW); KUO-FANG CHUNG, HSINCHU (TW); CHI-YUAN SHIH, HSINCHU (TW); YINGKIT FELIX TSUI, CUPERTINO, CA (US)

(21) Appl. No.: 19/203,124

(22) Filed: May 8, 2025

Related U.S. Application Data
(60) Provisional application No. 63/745,327, filed on Jan. 15, 2025.

(51) Int. Cl. G02B 6/136; G02B 6/12; G02B 6/122

(52) U.S. Cl. CPC G02B 6/136; G02B 6/1228; G02B 2006/12061; G02B 2006/12097; G02B 2006/12173; G02B 2006/12195

(57) ABSTRACT

A method includes performing a first etch on a substrate, wherein the substrate includes six cross sections arranged in sequence to define five zones along a first direction, wherein the first etch forms a first protrusion region extending from the first to fifth zones and two first connecting regions on two sides of the first protrusion region; performing a second etch on the two first connecting regions to form a strip waveguide along the sixth cross section; performing a third etch on the two first connecting regions to form a rib waveguide along the third cross section; and performing a fourth etch on the two first connecting regions to form a deep-rib waveguide along the first cross section.

### PRIORITY CLAIM AND CROSS-REFERENCE

The present application claims the benefit of prior-filed U.S. provisional application No. 63/745,327, filed on Jan. 15, 2025, the content of which is hereby incorporated by reference in its entirety.

### BACKGROUND

Modern technology advances, such as big data, cloud computation, cloud storage, and Internet of Things (IoT), have driven exponential growth of various applications in processing and communication of data, e.g., high performance computers, data centers, and long-haul telecommunication. To address the emerging need of high data rate transmission, a modern semiconductor structure may include optical elements for providing optical data links that provide improvements in data transmission rate over those of existing electrical data links. While incorporating optical data links in semiconductor devices, various types of optical components may be incorporated into the optical devices for performing different tasks. Such optical components may have different design and performance requirements. The performance of the optical device may rely on robust integration of these optical components.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a schematic diagram of a semiconductor device, in accordance with some embodiments of the present disclosure.

FIGS. 1B, 1C and 1D are schematic cross-sectional views of a deep-rib waveguide, a rib waveguide and a strip waveguide, respectively, in accordance with some embodiments of the present disclosure.

FIGS. 2A, 2B, 2C, 2D, 2E and 2F are schematic cross-sectional views of intermediate stages of a method of forming a semiconductor waveguide device, in accordance with some embodiments of the present disclosure.

FIG. 3 is a schematic plan view of a photomask, in accordance with some embodiments of the present disclosure.

FIG. 4A is a schematic top view of a semiconductor waveguide device, in accordance with some embodiments of the present disclosure.

FIGS. 4B and 4C are schematic perspective views of the semiconductor waveguide device shown in FIG. 4A, in accordance with some embodiments of the present disclosure.

FIGS. 5A, 5B, 5C, 5D, 5E and 5F are schematic cross-sectional views of the semiconductor waveguide device shown in FIG. 4A, in accordance with some embodiments of the present disclosure.

FIG. 6A is a schematic plan view of a photomask, in accordance with some embodiments of the present disclosure.

FIG. 6B is a schematic plan view of overlaid photomasks, in accordance with some embodiments of the present disclosure.

FIG. 7A is a schematic top view of a semiconductor waveguide device, in accordance with some embodiments of the present disclosure.

FIGS. 7B and 7C are schematic perspective views of the semiconductor waveguide device shown in FIG. 7A, in accordance with some embodiments of the present disclosure.

FIGS. 8A, 8B, 8C, 8D, 8E and 8F are schematic cross-sectional views of the semiconductor waveguide device shown in FIG. 7A, in accordance with some embodiments of the present disclosure.

FIG. 9A is a schematic plan view of a photomask, in accordance with some embodiments of the present disclosure.

FIG. 9B is a schematic plan view of overlaid photomasks, in accordance with some embodiments of the present disclosure.

FIG. 10A is a schematic top view of a semiconductor waveguide device, in accordance with some embodiments of the present disclosure.

FIGS. 10B and 10C are schematic perspective views of the semiconductor waveguide device shown in FIG. 7A, in accordance with some embodiments of the present disclosure.

FIGS. 11A, 11B, 11C, 11D, 11E and 11F are schematic cross-sectional views of the semiconductor waveguide device shown in FIG. 10A, in accordance with some embodiments of the present disclosure.

FIG. 12A is a schematic plan view of a photomask, in accordance with some embodiments of the present disclosure.

FIG. 12B is a schematic plan view of overlaid photomasks, in accordance with some embodiments of the present disclosure.

FIG. 13A is a schematic top view of a semiconductor waveguide device, in accordance with some embodiments of the present disclosure.

FIGS. 13B and 13C are schematic perspective views of the semiconductor waveguide device shown in FIG. 13A, in accordance with some embodiments of the present disclosure.

FIGS. 14A, 14B, 14C, 14D, 14E and 14F are schematic cross-sectional views of the semiconductor waveguide device shown in FIG. 13A, in accordance with some embodiments of the present disclosure.

FIG. 15A is a schematic plan view of a photomask, in accordance with some embodiments of the present disclosure.

FIG. 15B is a schematic plan view of overlaid photomasks, in accordance with some embodiments of the present disclosure.

FIG. 16A is a schematic top view of a semiconductor waveguide device, in accordance with some embodiments of the present disclosure.

FIGS. 16B and 16C are schematic perspective views of the semiconductor waveguide device shown in FIG. 16A, in accordance with some embodiments of the present disclosure.

FIGS. 17A, 17B, 17C, 17D, 17E and 17F are schematic cross-sectional views of the semiconductor waveguide device shown in FIG. 16A, in accordance with some embodiments of the present disclosure.

FIGS. 18A, 18B, 18C, 18D, 18E and 18F are schematic cross-sectional views of a semiconductor waveguide device, in accordance with some embodiments of the present disclosure.

FIGS. 19A, 19B, 19C, 19D, 19E and 19F are schematic cross-sectional views of a semiconductor waveguide device, in accordance with some embodiments of the present disclosure.

FIGS. 20A, 20B, 20C, 20D, 20E and 20F are schematic cross-sectional views of a semiconductor waveguide device, in accordance with some embodiments of the present disclosure.

FIG. 21 is a schematic cross-sectional view of a semiconductor device, in accordance with some embodiments of the present disclosure.

FIGS. 22A, 22B, 22C, 22D, 22E and 22F are schematic cross-sectional views of a semiconductor waveguide device, in accordance with some embodiments of the present disclosure.

FIG. 23 is a schematic cross-sectional view of a semiconductor device, in accordance with some embodiments of the present disclosure.

FIGS. 24A, 24B, 24C, 24D, 24E and 24F are schematic cross-sectional views of a semiconductor waveguide device, in accordance with some embodiments of the present disclosure.

FIG. 25 is a schematic cross-sectional view of a semiconductor device, in accordance with some embodiments of the present disclosure.

FIG. 26 is a schematic block diagram of photomasks, in accordance with some embodiments of the present disclosure.

FIG. 27 shows a flowchart of a method of manufacturing a semiconductor waveguide device, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the deviation normally found in the respective testing measurements. Also, as used herein, the terms “about,” “substantial” or “substantially” generally mean within 10%, 5%, 1% or 0.5% of a given value or range. Alternatively, the terms “about,” “substantial” or “substantially” mean within an acceptable standard error of the mean when considered by one of ordinary skill in the art. Other than in the operating/working examples, or unless otherwise expressly specified, all of the numerical ranges, amounts, values and percentages such as those for quantities of materials, durations of time, temperatures, operating conditions, ratios of amounts, and the likes thereof disclosed herein should be understood as modified in all instances by the terms “about,” “substantial” or “substantially.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as being from one endpoint to another endpoint or between two endpoints. All ranges disclosed herein are inclusive of the endpoints, unless specified otherwise.

Silicon photonics is an emerging and promising technique for advanced semiconductor manufacturing, and is being adopted in applications such as high-performance computing, high-speed data transmission, microwave photonics, and optical sensing. The silicon photonic technique can provide advantages such as high data transmission rate, low transmission loss, high production yield, low manufacturing cost, and high compatibility with the mature complementary metal-oxide-semiconductor (CMOS) technique. In the development of silicon photonic devices, various kinds of photonic (optical) components are used to perform different functions and integrated to complete the task of signal transmission or processing. Such photonic components may be formed with different types of waveguides. Examples of these waveguides include a strip waveguide, e.g., used in an optical filter, a rib waveguide, e.g., used in an optical grating coupler, and a deep-rib waveguide, e.g., used in a micro-ring modulator. When the photonic components with different types of waveguides are integrated, optical transitional waveguides or similar structures may be needed to smoothly guide the optical signal from one type of waveguide to another with minimized transmission loss.

In some situations, design of the optical transitional waveguide may be challenging when a new photonic component is incorporated into an existing photonic device. That is because when the new photonic component is introduced, it usually includes a waveguide different from those of existing photonic components on existing photonic devices, and thus a new transitional structure (waveguide) is proposed to connect the new waveguide of the new photonic component to an existing waveguide of the existing photonic device. However, the manufacturing of the new transitional waveguide may affect design parameters of the original photonic device, such as the configuration or the forming process of the mask layers. For example, a mask layer used for forming the existing photonic device may be excessively or completely consumed by an additional etching process used to form the transitional structure. As a result, device reliability is significantly reduced. However, if a circuit redesign task is otherwise provided to address the parameter adjustment of the mask layer due to the impact of the transitional structure on the original photonic device, manufacturing cost and time are inevitably increased.

To address the abovementioned issues, the present disclosure proposes a structure and a forming method for a waveguide device, which adopts a transitional structure to connect a deep-rib waveguide and a strip waveguide with minimized impact on the original design of the existing photonic device. The transitional structure may include a rib waveguide in the middle of the waveguide device between the deep-rib waveguide and the strip waveguide, wherein the optical signal is guided to propagate between the deep-rib waveguide and the strip waveguide via the rib waveguide. Photomasks with suitable patterns are proposed to implement the rib waveguide and the transitional waveguides between the rib waveguide and each of the deep-rib waveguide and the strip waveguide. Due to the design of the photomasks used for forming the deep-rib waveguide, the rib waveguide, and the strip waveguide along with the transitional waveguides, the goal of reducing the impact on the original mask layers can be achieved. For example, in the region of the transitional waveguide proximal to the new photonic component including the strip waveguide, an amount of etching performed on the hard mask layer is substantially equal to that performed on other regions of the transitional waveguide proximal to an existing photonic component including the deep-rib waveguide. That means that the design of the mask layers used in forming the existing photonic components can be kept without significant changes. Further, a transmission loss exhibited by the proposed transitional waveguide device is still acceptable. Therefore, the manufacturing cost and design cycle can be greatly reduced.

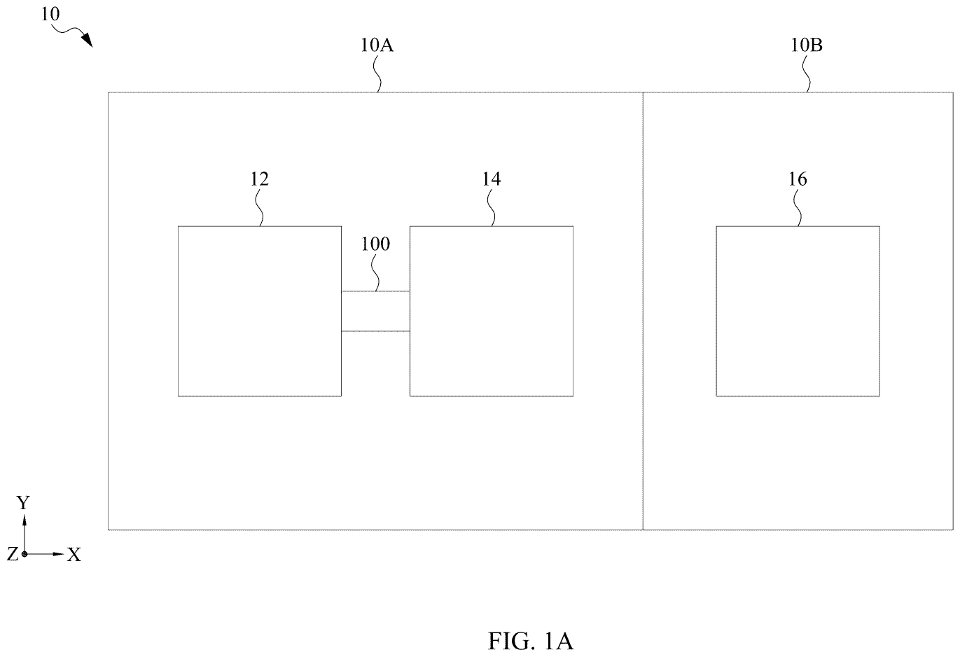

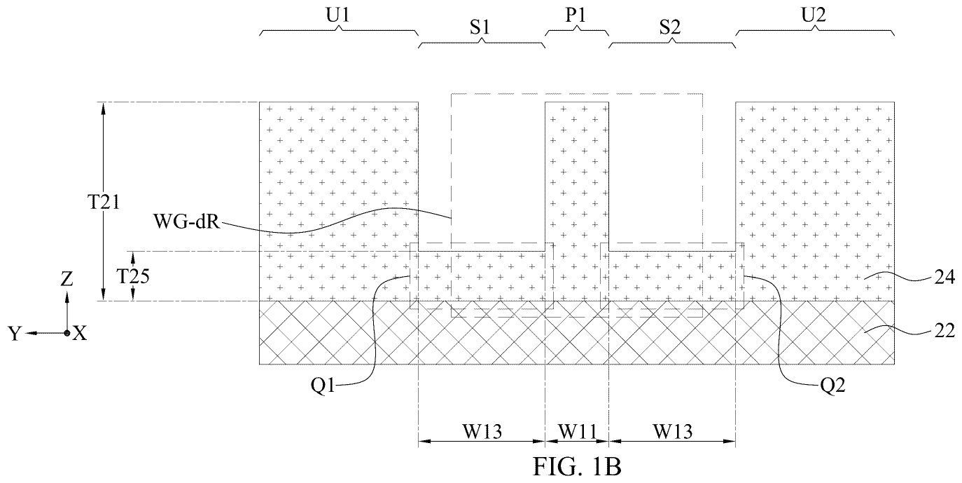

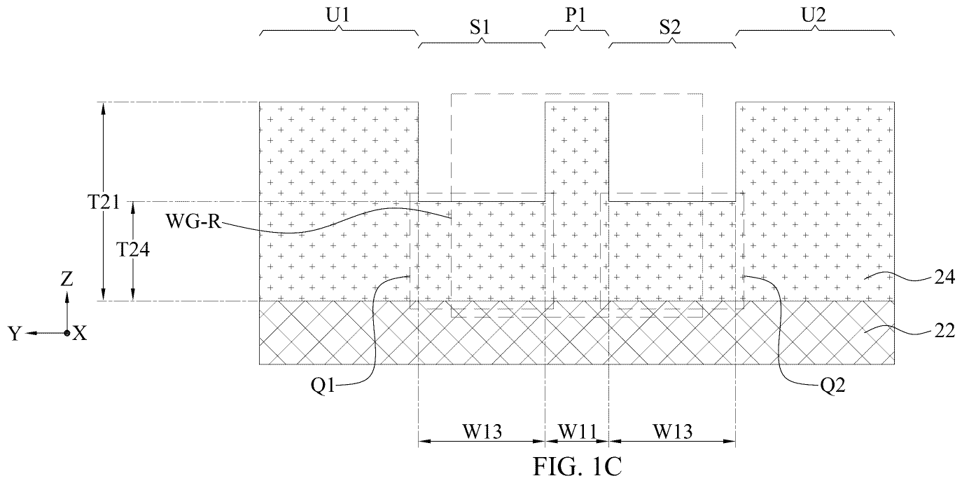

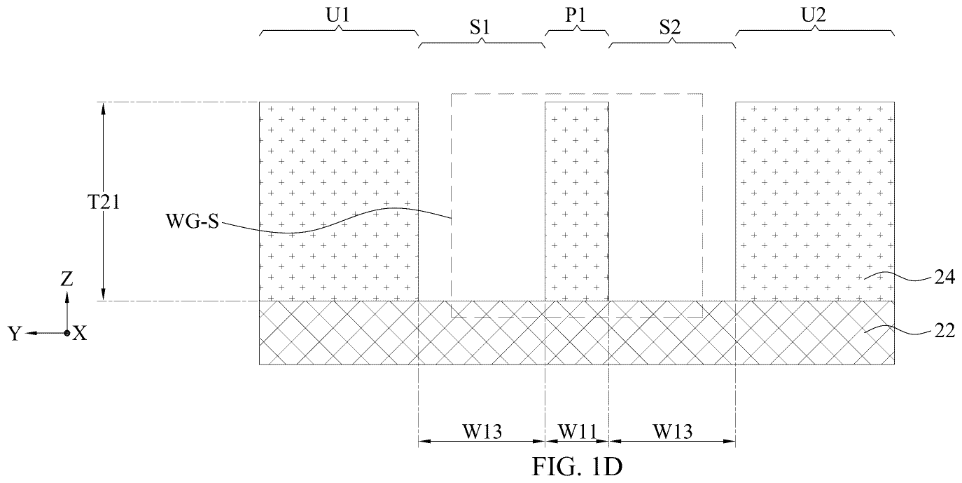

FIG. 1 is a schematic diagram of a semiconductor device 10, in accordance with some embodiments of the present disclosure. The semiconductor device 10 may include a photonic device area 10A and an electronic device area 10B, wherein the photonic device area 10A includes a plurality of photonic devices, e.g., photonic devices 12 and 14, while the electronic device area 10B includes a plurality of electronic devices, e.g., an electronic device 16. According to some embodiments, the photonic devices in the photonic device area 10A and the electronic devices in the electronic device area 10B are formed on a same substrate. According to some embodiments, the photonic device 12 includes a first waveguide of a first waveguide type, e.g., a deep-rib waveguide. According to some embodiments, the photonic device 14 includes a second waveguide of a second waveguide type, e.g., a strip waveguide.

According to some embodiments, the photonic device area 10A further includes a semiconductor waveguide device 100 between and connecting the photonic devices 12 and 14. The semiconductor waveguide device 100 may include three types of waveguides, e.g., a deep-rib waveguide, a rib waveguide and a strip waveguide, along different cross sections, and may include transitional waveguides between the abovementioned waveguides.

FIGS. 1B, 1C and 1D are schematic cross-sectional views of a deep-rib waveguide WG-dR, a rib waveguide WG-R and a strip waveguide WG-S, respectively, in accordance with some embodiments of the present disclosure. According to some embodiments, each of the deep-rib waveguide WG-dR, the rib waveguide WG-R and the strip waveguide WG-S, as defined by dashed-line boxes in FIGS. 1B to 1D, is formed in a silicon layer 24 over a dielectric layer 22. Light or optical signals are constrained in an area of the silicon layer 24 within the dashed-line boxes. Each of the deep-rib waveguide WG-dR, the rib waveguide WG-R and the strip waveguide WG-S includes a protrusion region P1 at a central area thereof. According to some embodiments, each of the deep-rib waveguide WG-dR, the rib waveguide WG-R and the strip waveguide WG-S includes a first support region U1 and a second support region U2 on two sides of the protrusion region P1. The protrusion region P1 is separated from the first support region U1 and the second support region U2 by a first strip region S1 and a second strip region S2, respectively. Each of the deep-rib waveguide WG-dR and the rib waveguide WG-R further includes a first connecting region Q1 and a second connecting region Q2 arranged on two sides of, and connected to, a bottom portion of the protrusion region P1. The strip waveguide WG-S includes only an upright structure of the protrusion structure P1 and is free of connecting regions around the protrusion region P1. According to some embodiments, the protrusion region P1 of the strip waveguide WG-S has a substantially equal width W11 from a bottom to a top of the strip waveguide WG-S.

According to some embodiments, the protrusion region P1 for the deep-rib waveguide WG-dR, the rib waveguide WG-R and the strip waveguide WG-S has a thickness T21 between about 240 nanometers (nm) and 300 nm, e.g., 270 nm, in which the thickness T21 is substantially equal to the thickness of the silicon layer 24. The first support region U1 and the second support region U2 may have a thickness equal to the thickness T21 of the protrusion region P1. According to some embodiments, the protrusion region P1 has a width W11 between about 200 nm and about 500 nm, e.g., 350 nm. The first strip region S1 or the second strip region S2 may have a width W13 between about 600 nm and about 3000 nm, e.g., 1800 nm.

The deep-rib waveguide WG-dR and the rib waveguide WG-R have different thicknesses of the first connecting region Q1 and the second connecting region Q2. According to some embodiments, the first connecting region Q1 or the second connecting region Q2 of the deep-rib waveguide WG-dR has a thickness T1 between about 50 nm and about 90 nm, e.g., 70 nm. According to some embodiments, the first connecting region Q1 or the second connecting region Q2 of the rib waveguide WG-R has a thickness T2 between about 120 nm and about 180 nm, e.g., 150 nm. According to some embodiments, the thickness T2 of the rib waveguide WG-R is greater than the thickness T1 of the deep-rib waveguide WG-dR. A ratio of the thickness T1 of the deep-rib waveguide WG-dR to the thickness T2 of the rib waveguide WG-R is between about 50% and about 80%.

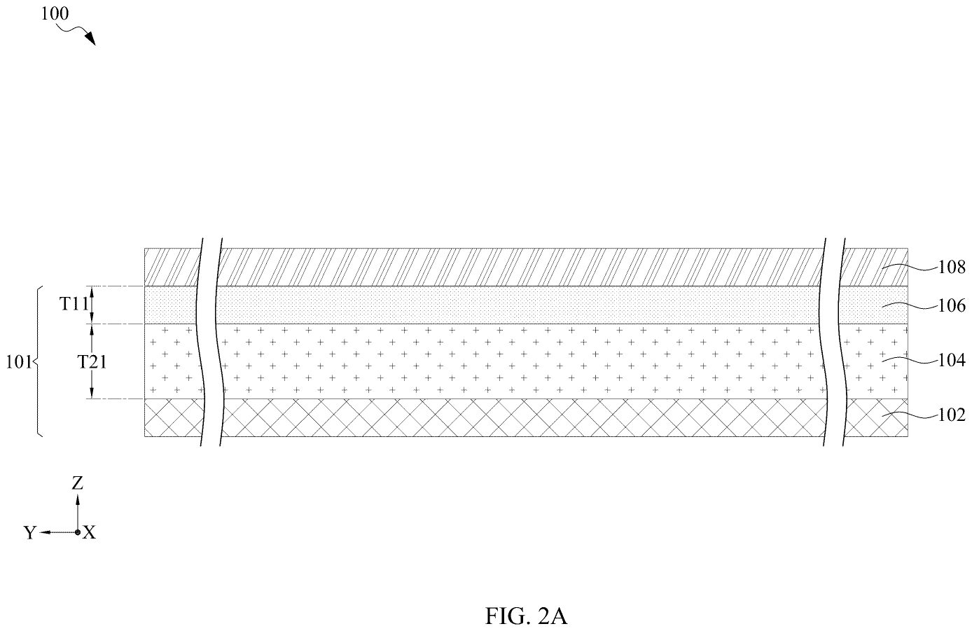

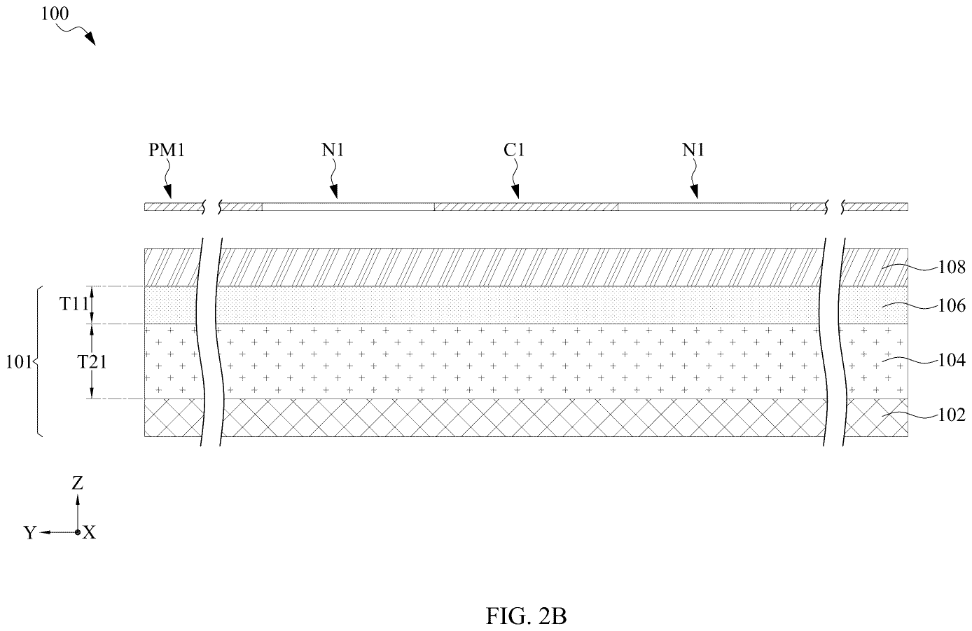

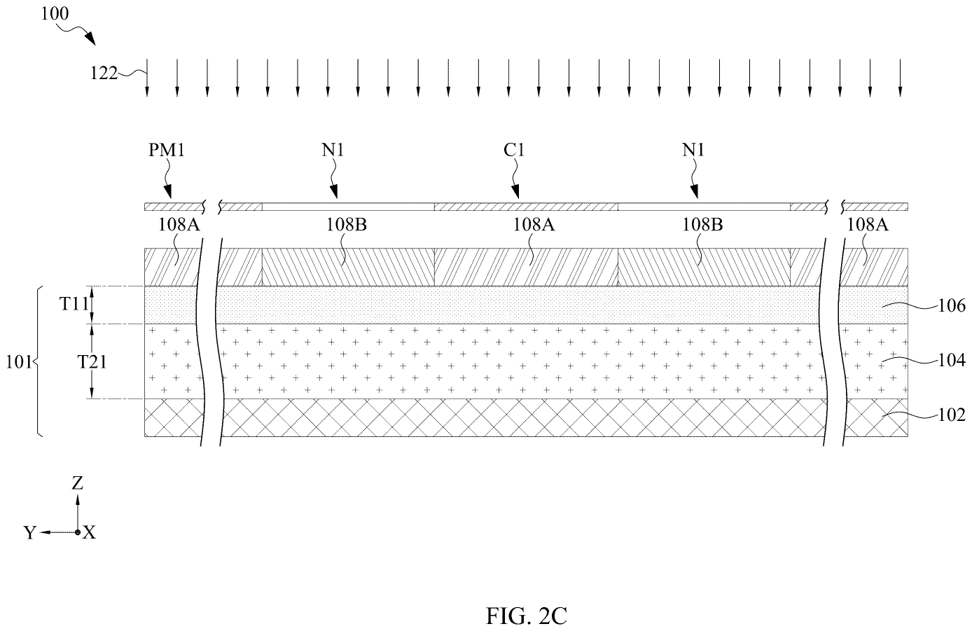

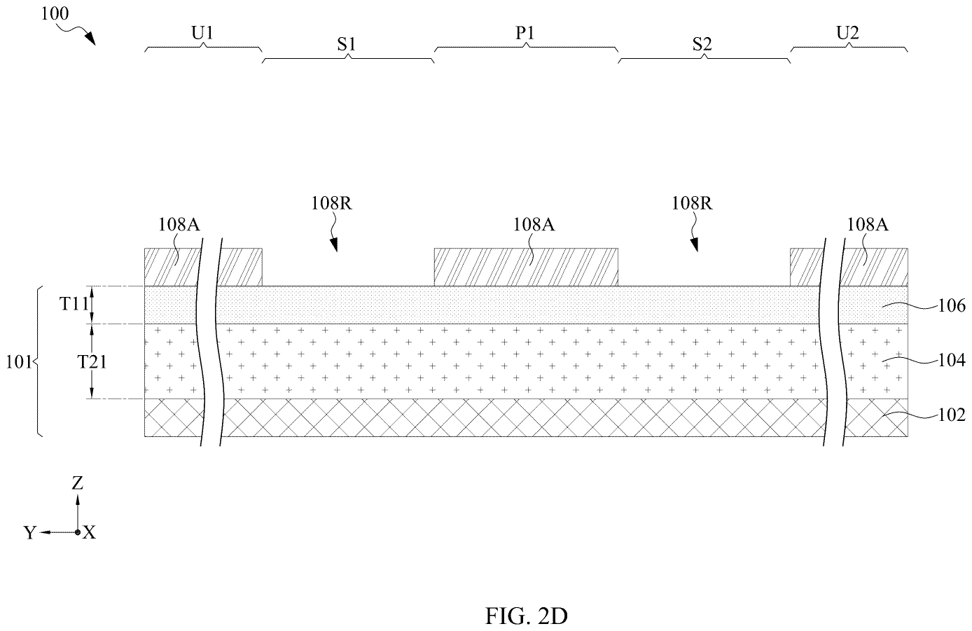

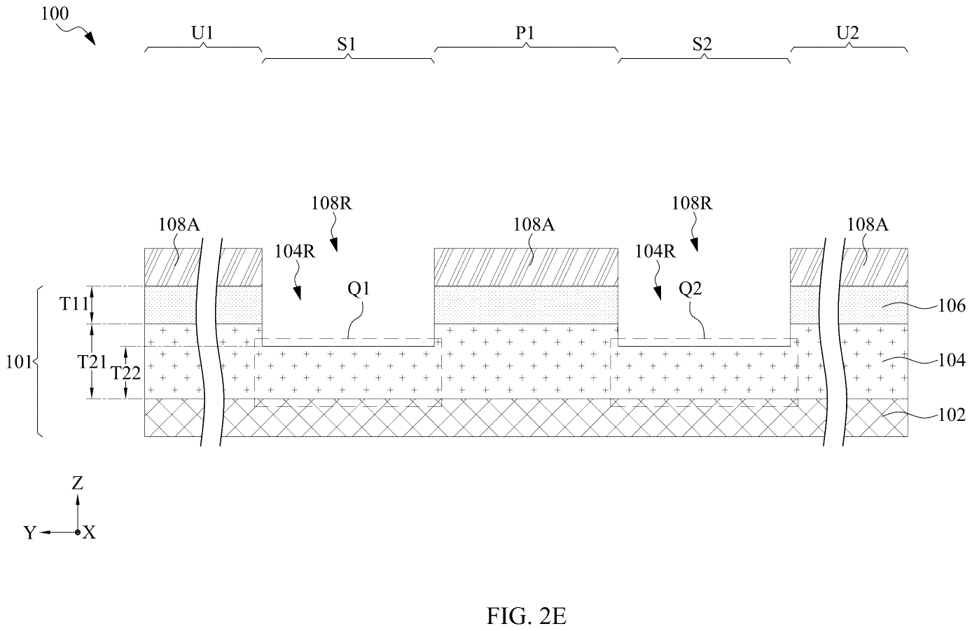

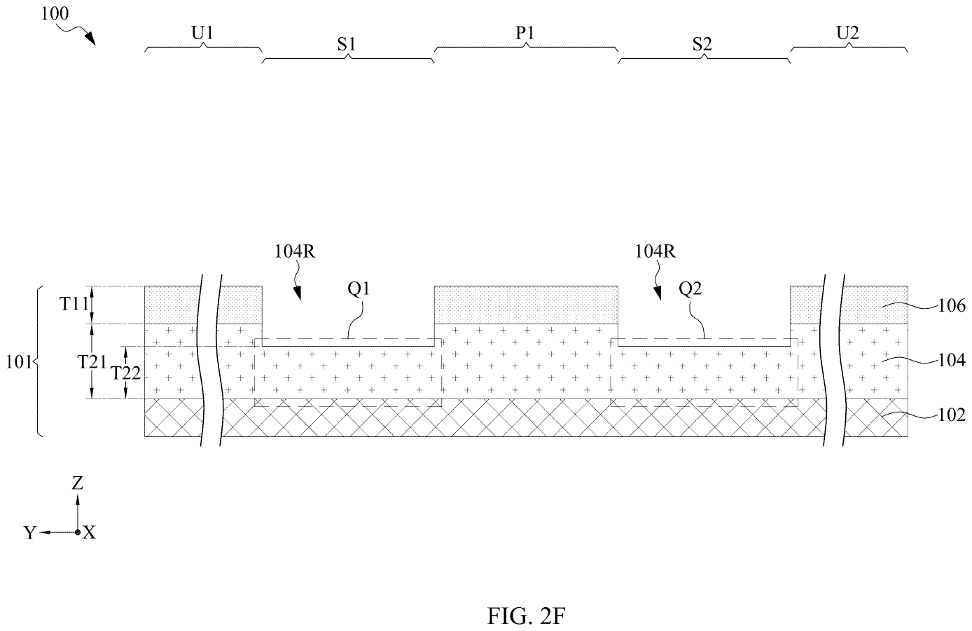

FIGS. 2A, 2B, 2C, 2D, 2E and 2F are schematic cross-sectional views of intermediate stages of a method of forming the semiconductor waveguide device 100, in accordance with some embodiments of the present disclosure. Referring to FIG. 2A, the semiconductor waveguide device 100 includes a substrate 101 having a layer stack, which includes a dielectric layer 102, a silicon layer 104 and a hard mask layer 106 (or hardmask layer) arranged from bottom to top. The semiconductor waveguide device 100 may further include a mask layer 108 over the hard mask layer 106. According to some embodiments, the dielectric layer 102 is a silicon oxide layer. According to some embodiments, the hard mask layer 106 is a silicon nitride layer. According to some embodiments, the mask layer 108 is a photosensitive layer, e.g., a photoresist layer.

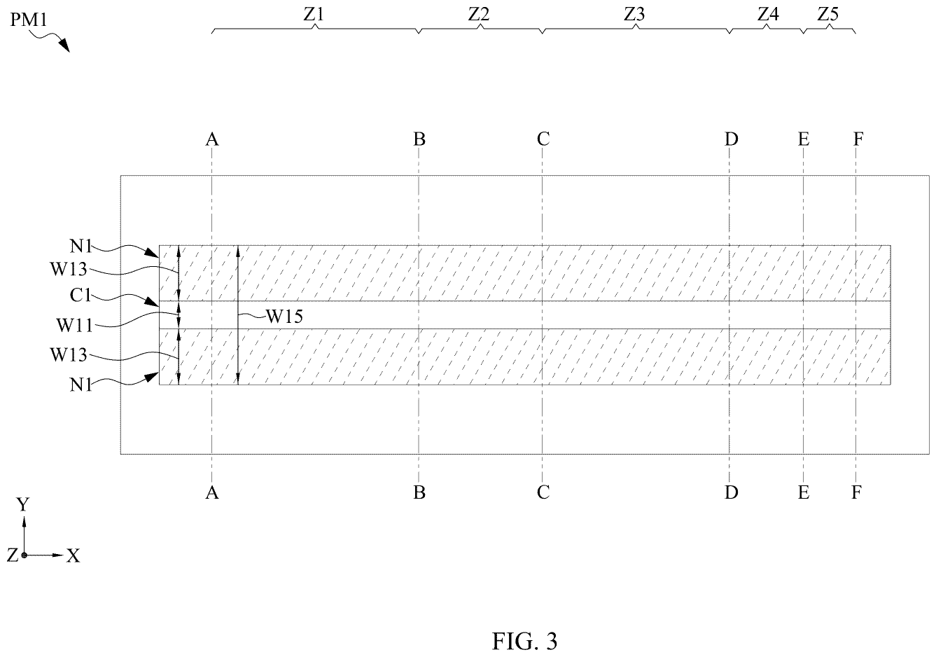

Referring to FIG. 2B, a photomask PM1 is provided over the semiconductor waveguide device 100 in a photolithography operation. FIG. 3 is a schematic plan view of the photomask PM1, in accordance with some embodiments of the present disclosure. As shown in FIG. 3, according to some embodiments, the photomask PM1 includes openings N1 including two strip regions arranged in parallel and extending in an X-axis direction. Other areas of the photomask PM1 are opaque and do not have openings, including a central region C1 arranged between the two strip regions N1. According to some embodiments, the central region C1 has a width W11 measured in a Y-axis direction, while each of the strip regions N1 has a width W13 measured in the Y-axis direction. According to some embodiments, a width W15 is defined as a distance measured in the Y-axis direction between two outer sides of the two strip regions N1.

Referring to FIG. 2C, a radiation beam 122 is emitted from a radiation source (not separately shown) and impinges on the mask layer 108 through the photomask PM1. According to some embodiments, the radiation beam 122 includes a wavelength in the bandwidth of ultraviolet light. According to some embodiments where the mask layer 108 include a positive photoresist, portions of the photosensitive material in regions 108B of the mask layer 108 are exposed through the strip regions N1 of the photomask PM1 and react to the radiation beam 122. The photosensitive materials in the regions 108B are degraded by energy of the radiation beam 122. According to some embodiments, portions of the photosensitive material in regions 108A of the mask layer 108 are covered by opaque materials of the photomask PM1, and thus such regions, e.g., the central region C1, are kept intact during exposure of the mask layer 108 to the radiation beam 122. The radiation beam 122 forms a patterning light on the mask layer 108 through the photomask PM1.

Referring to FIG. 2D, a developer (not separately shown) is used to dissolve the degraded regions 108B of the mask layer 108 during a development operation and remove the degraded regions 108B. Openings 108R are formed in the mask layer 108. After the development operation, the mask layer 108 is patterned to expose portions of an upper surface of the hard mask layer 106, in which a pattern of the photomask PM1 is transferred to the mask layer 108.

Referring to FIG. 2E, a first etching operation is performed on the hard mask layer 106 using the mask layer 108 as an etching mask. The first etching operation may include a dry etch, a wet etch, a combination thereof, e.g., a reactive ion etch (RIE), or the like. After the first etching operation, shown in FIG. 2E, the pattern of the photomask PM1 is further transferred to the hard mask layer 106. The first etching operation extends the openings 108R through the hard mask layer 106 and forms recesses in the first strip region S1 and the second strip region S2 of the hard mask layer 106.

According to some embodiments, the first etching operation causes the recesses of the hard mask layer 106 to extend further downward to the silicon layer 104 and forms recesses 104R in the silicon layer 104. According to some embodiments, the first etching operation includes multiple etches, and the recesses 104R are formed by another etch of the first etching operation using the hard mask layer 106 as an etching mask. After the first etching operation on the silicon layer 104, a protrusion region P1, a first support region U1, a second support region U2, a first connecting region Q1 and a second connecting region Q2 are formed corresponding to the pattern of the photomask PM1. According to some embodiments, the silicon layer 104 includes a thickness T21 measured in the Z-axis direction between about 240 nanometers (nm) and about 300 nm, e.g., 270 nm. According to some embodiments, the first connecting region Q1 or the second connecting region Q2 includes a thickness T22 measured in the Z-axis direction between about 180 nanometers (nm) and about 240 nm, e.g., 210 nm.

Referring to FIG. 2F, the mask layer 108 is removed or stripped after the first etching operation is completed. The mask layer 108 may be removed or stripped by a plasma etching or a plasma ashing.

The photolithography and etching operations discussed above with reference to FIGS. 2A to 2F show a pattern transfer process from the photomask PM1 to the hard mask layer 106 and the silicon layer 104. In the paragraphs below, additional iterations of the pattern transfer process are described, wherein the iterations utilize other photomasks, i.e., photomasks PM2, PM3, PM4 and PM5, to transfer more patterns onto the silicon layer 104. The deposition and removal of the mask layer 108 and the exposure/development operations of the photomasks PM2, PM3, PM4 and PM5 may be omitted for brevity, as the photolithography and etching operations performed using the photomasks PM2, PM3, PM4 and PM5 are same as those described above with reference to FIGS. 2A to 2F.

According to embodiments where the photosensitive material of the mask layer includes a negative photoresist, a layout of the mask layer 108 can be maintained as that formed by the photomask PM1 and the positive photoresist of the mask layer 108. The key to maintaining the same layout is to use a photomask PM11 with a reversed layout, in which opaque areas (openings) of the photomask PM11 correspond to openings (opaque areas) of the photomask PM1. In such manner, photoresist material in the region 108B of the mask layer 108 is not exposed to the radiation beam 122, and will be dissolved and removed during a subsequent development operation. Therefore, the layout of the photomask PM1 can be successfully transferred to the mask layer 108 regardless of the type of the photoresist.

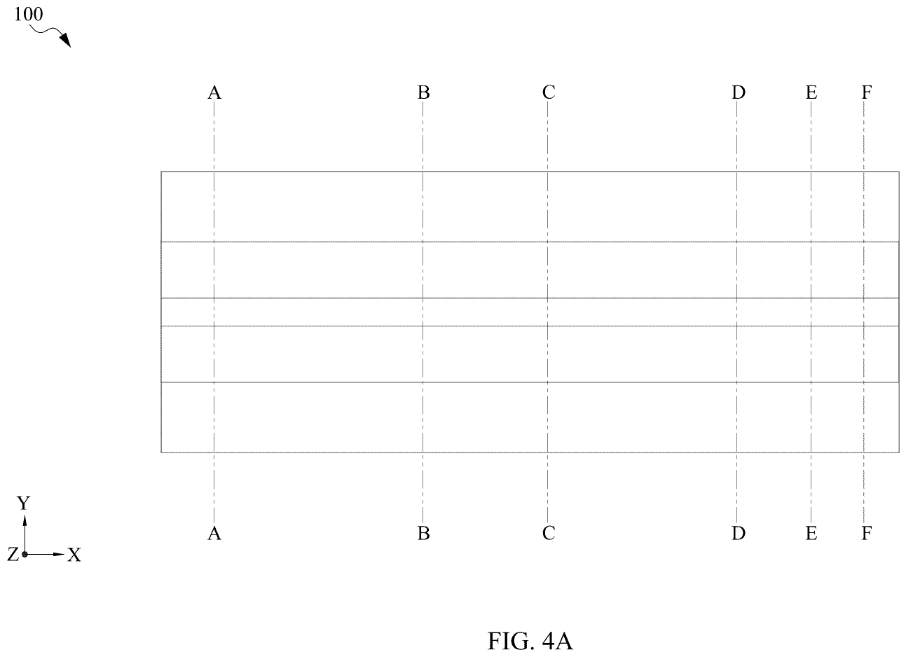

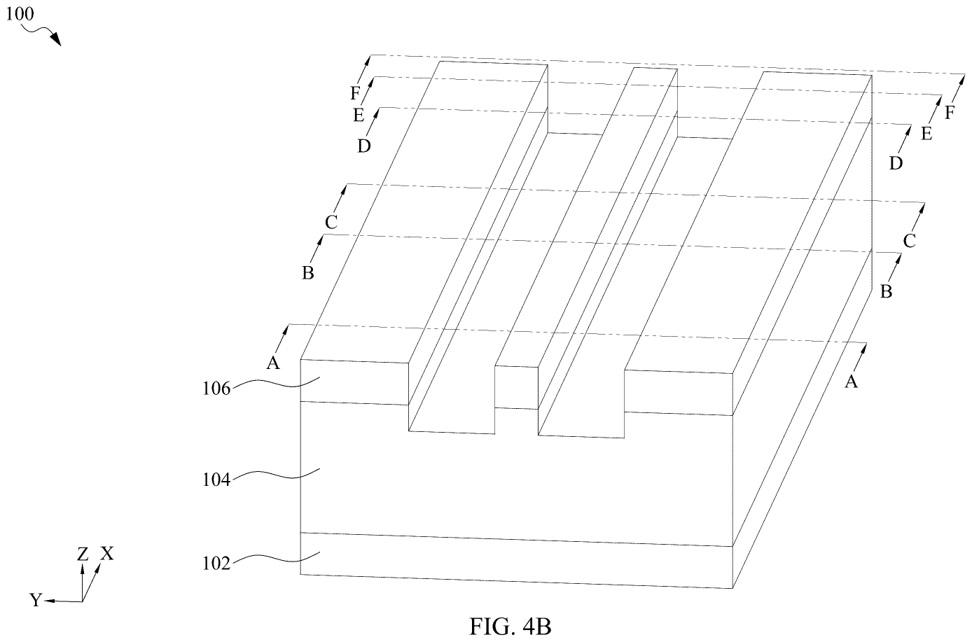

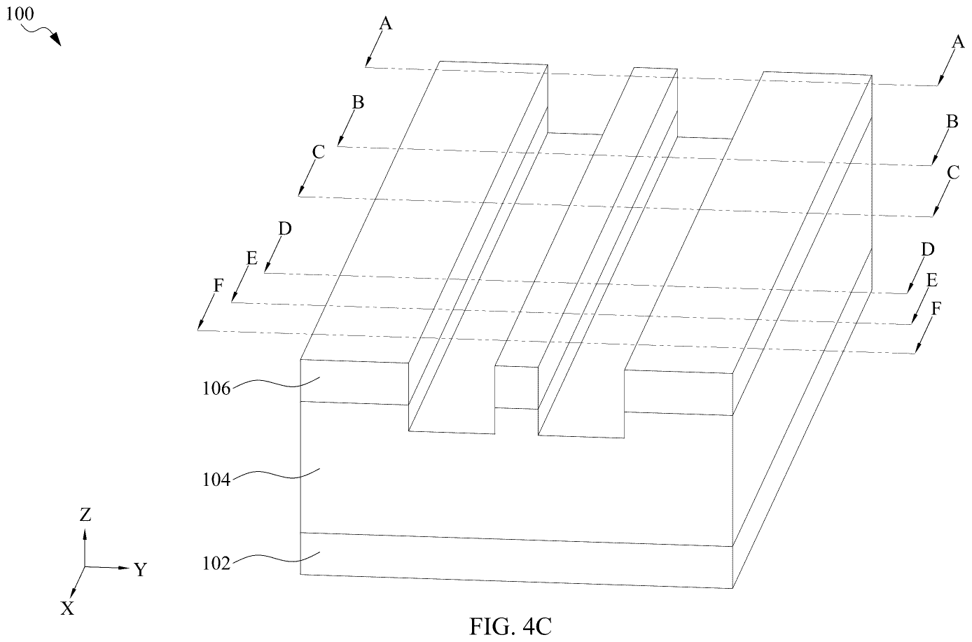

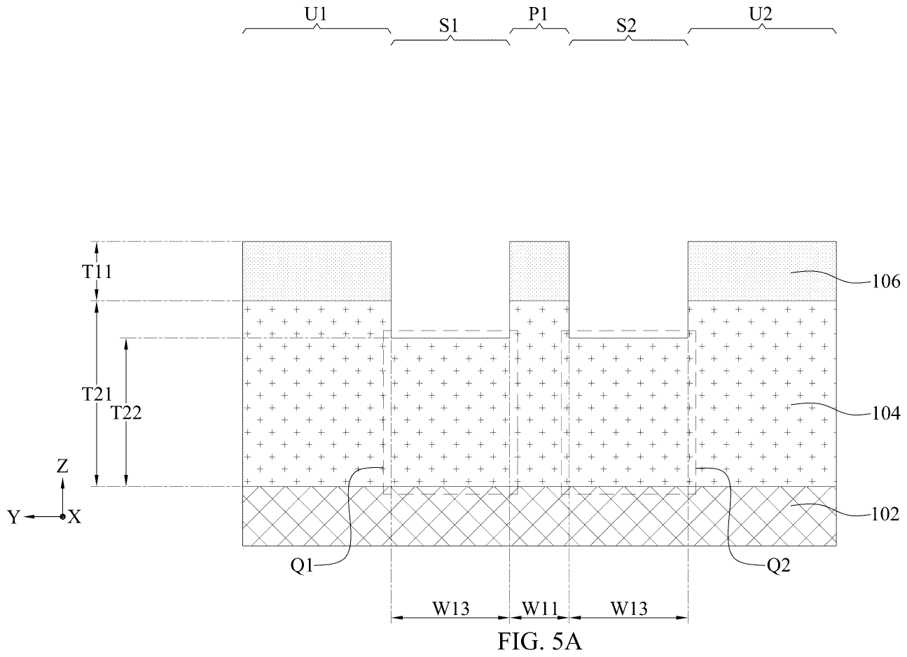

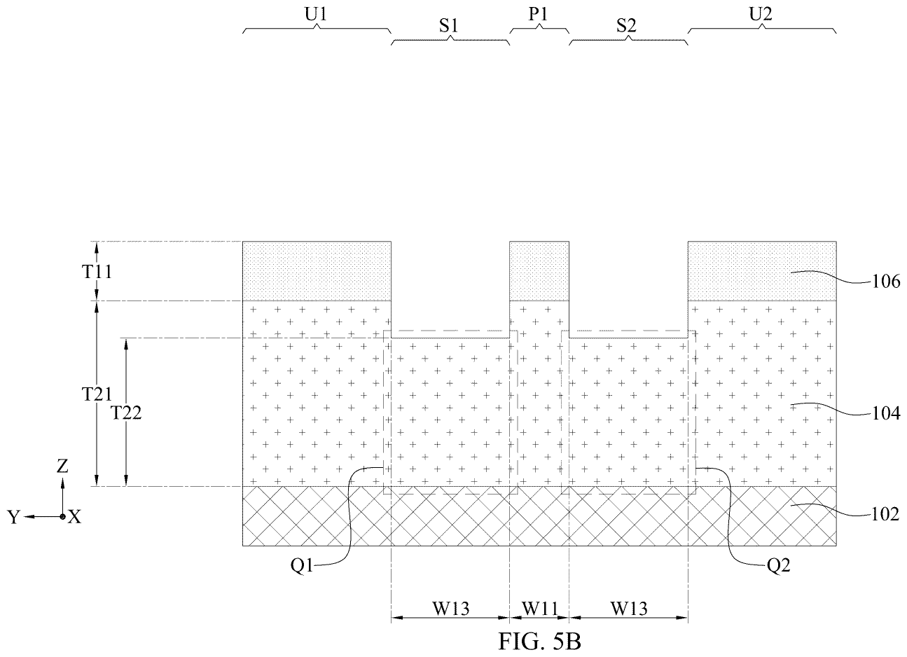

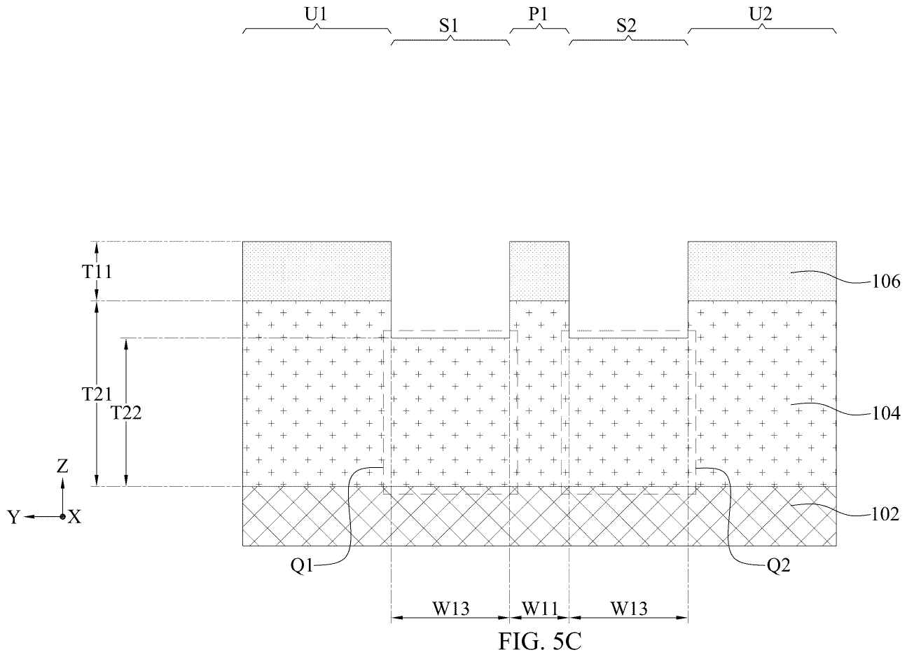

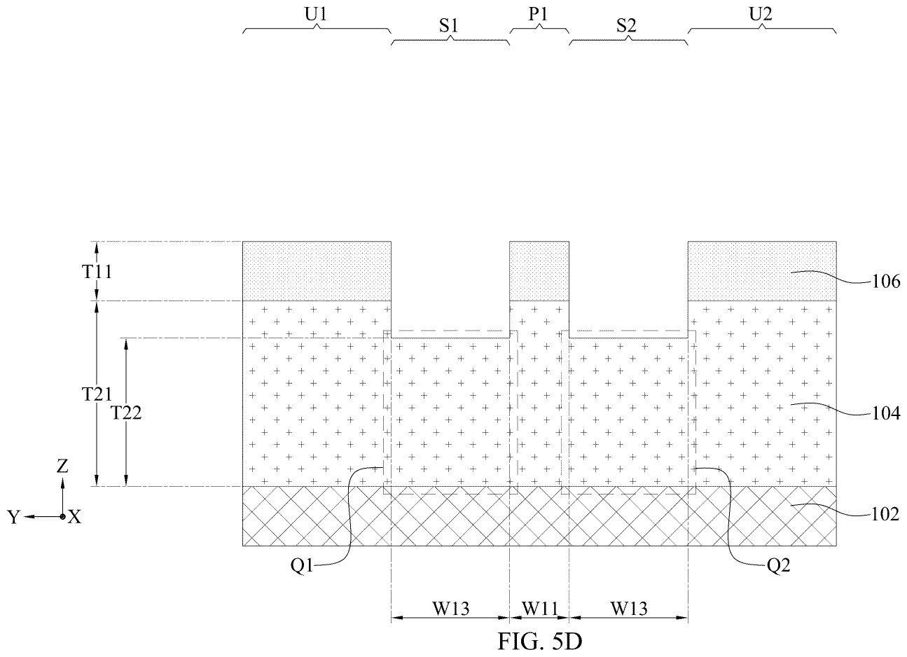

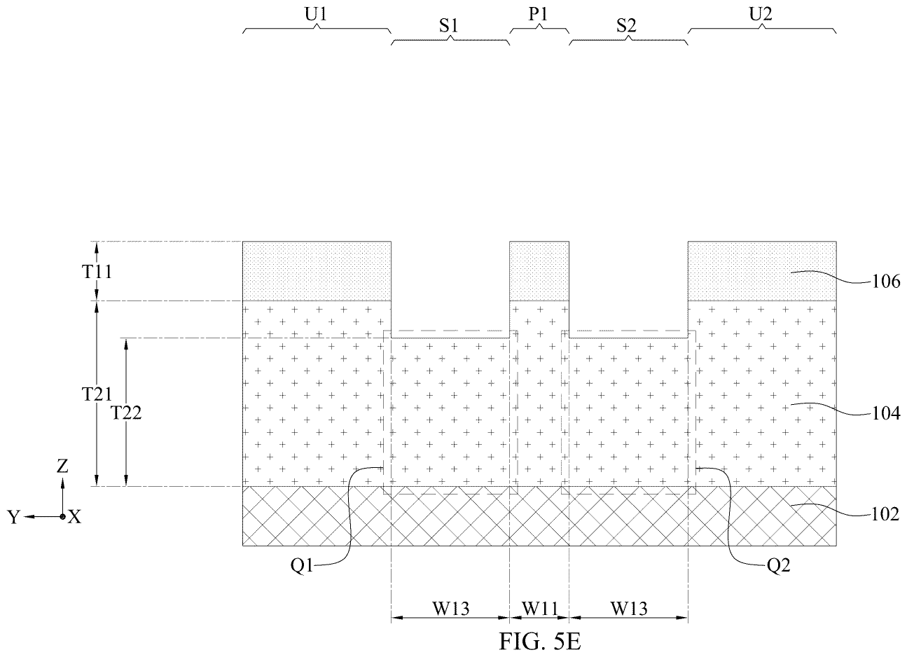

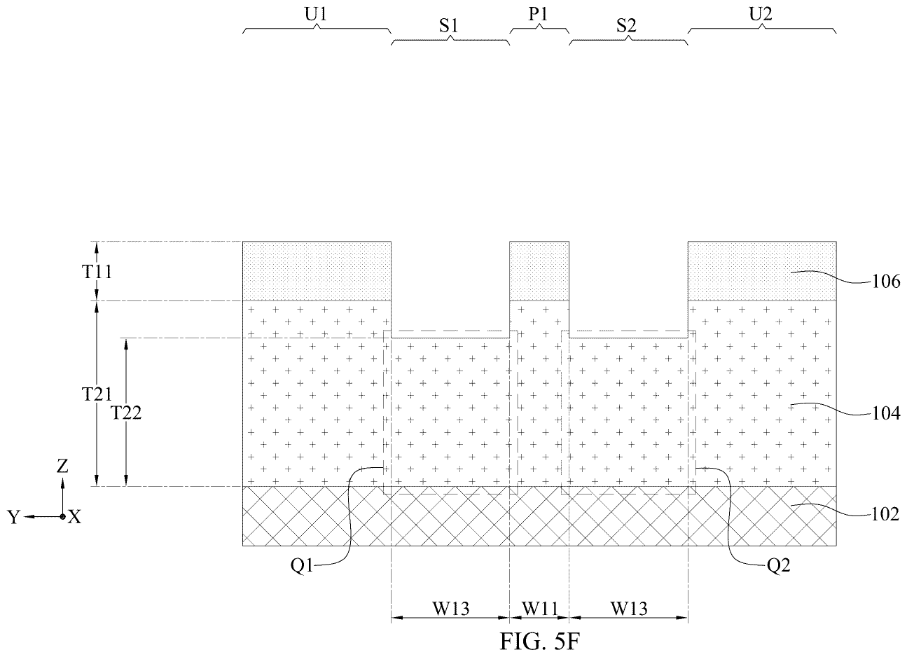

FIG. 4A is a schematic top view of the semiconductor waveguide device 100 after the first etching operation using the photomask PM1, in accordance with some embodiments of the present disclosure. FIGS. 4B and 4C are schematic perspective views of the semiconductor waveguide device 100 shown in FIG. 4A from different viewing angles, in accordance with some embodiments of the present disclosure. According to some embodiments, FIGS. 5A, 5B, 5C, 5D, 5E and 5F are schematic cross-sectional views taken along cross-sections AA, BB, CC, DD, EE and FF, respectively, of the substrate 101 of the semiconductor waveguide device 100 in FIG. 4A. Further, the six cross sections AA, BB, CC, DD, EE and FF define five zones Z1, Z2, Z3, Z4 and Z5. Referring to FIG. 3, the photomask PM1 also defines the six cross sections AA, BB, CC, DD, EE and FF and the zones Z1, Z2, Z3, Z4 and Z5 for ease of reference. Referring to FIG. 1A and FIGS. 4A, 4B and 4C, the cross sections AA and FF may be proximal to the photonic devices 12 and 14, respectively. According to other embodiments, the cross sections AA and FF may be proximal to the photonic devices 14 and 12, respectively.

Referring to FIG. 2F and FIG. 4A, FIG. 4B or FIG. 4C, it can be seen that the recesses 104R corresponding to the openings N1 of the two strip regions of the photomask PM1 are formed in the strip regions S1 and S2 of the hard mask layer 106 and the silicon layer 104 that extend across the six cross sections AA, BB, CC, DD, EE and FF. Therefore, the cross-sectional views of FIG. 2F and FIGS. 5A, 5B, 5C, 5D, 5E and 5F have profiles that are substantially same as profiles of the protrusion region P1, the first support region U1, the second support region U2, the first connecting region Q1 and the second connecting region Q2.

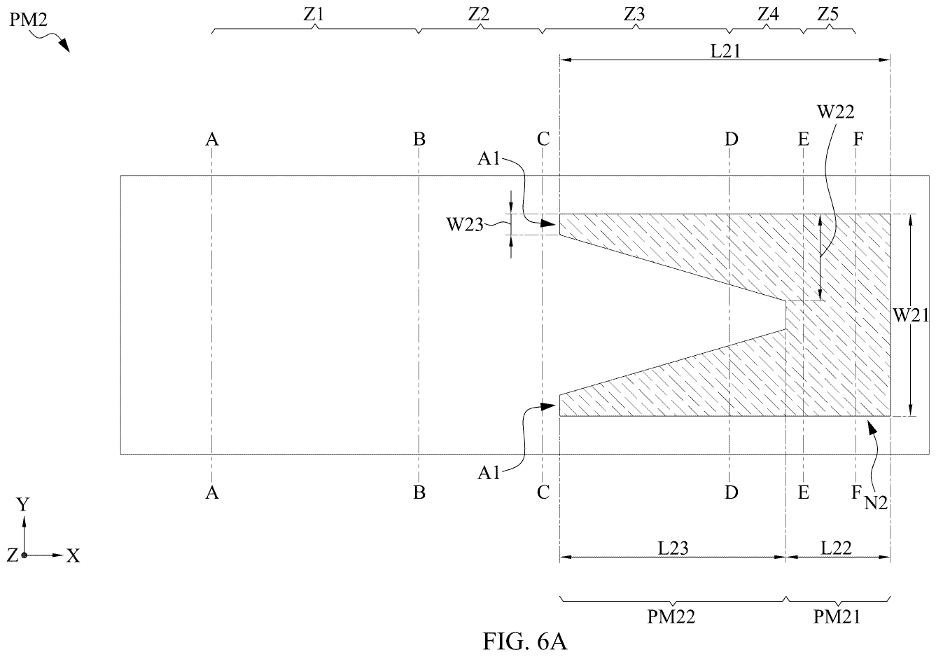

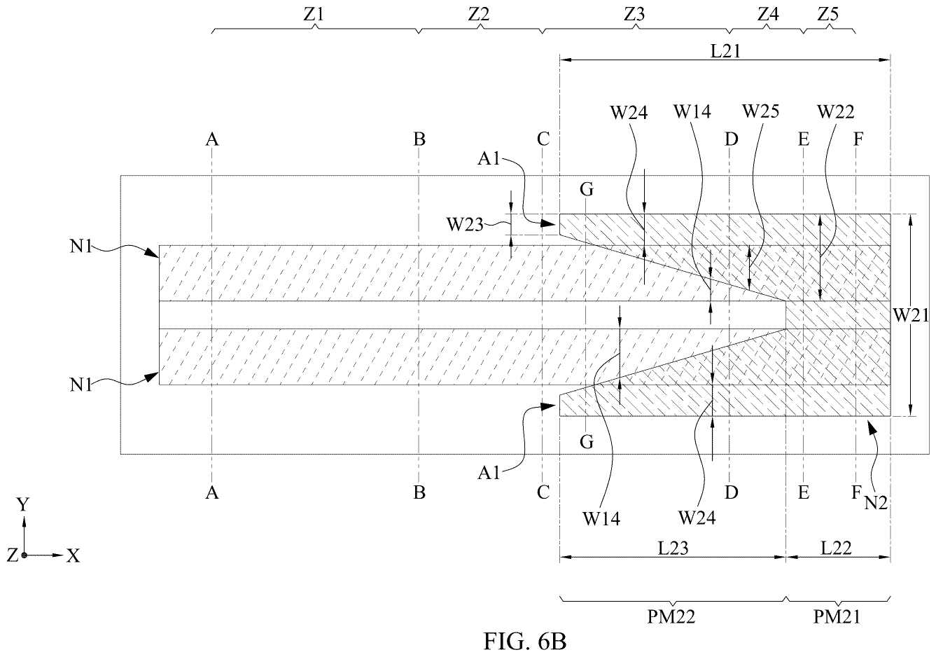

FIG. 6A is a schematic plan view of a photomask PM2, in accordance with some embodiments of the present disclosure. According to some embodiments, the photomask PM2 includes an opening N2 with a reversed-C shape having a width W21 measured in the Y-axis direction and a length L21 measured in the X-axis direction. The opening N2 includes a first portion PM21 and two second portions PM22 connected to the first portion PM21. According to some embodiments, the first portion PM21 is substantially of a rectangular shape extending in the zone Z5, wherein the first portion PM21 includes the width W21 and a length L22. According to some embodiments, the second portions PM22 are of substantially equal shapes and areas. Each of the second portions PM22 includes a length L23 and extends from a location near the cross section EE, through the zone Z4, and to the end side A1 in the zone Z3. The two second portions PM22 may be mirror images of each other with respect to a hypothetical horizontal line between the two second portions PM22. Each of the two second portions PM22 tapers from a first width W22 at one side in the zone Z4 near the cross section EE to a second width W23 on the end side A1 in the zone Z3 proximal to the cross section CC or a central line of the substrate 101 of the semiconductor waveguide device 100. The mouth of the reversed-C shape formed by the first portion PM21 and the two second portions PM22 includes a trapezoidal shape with two lateral sides tapering from the end sides A1 of the second portions PM22 to the first portion PM21.

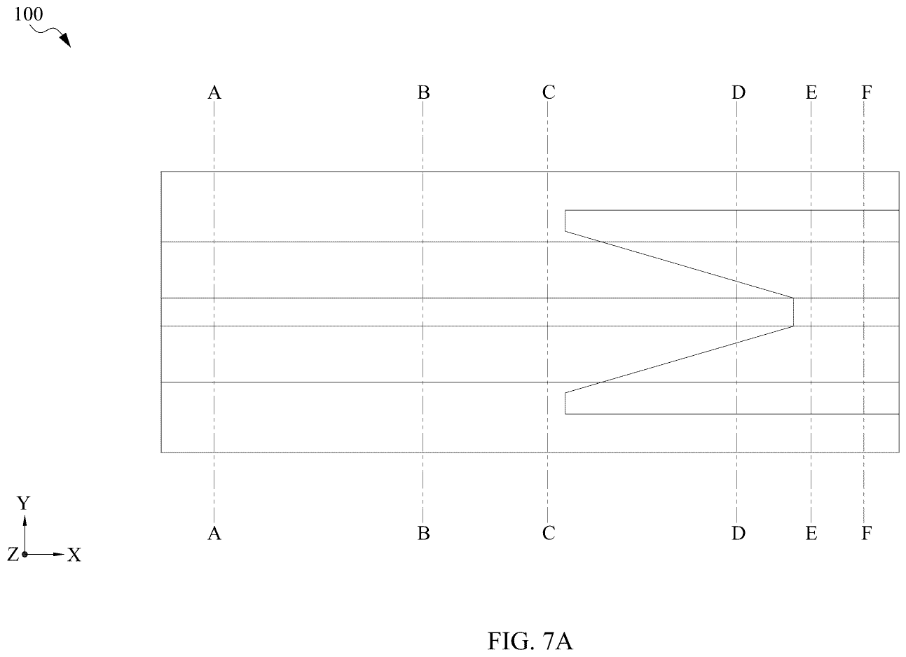

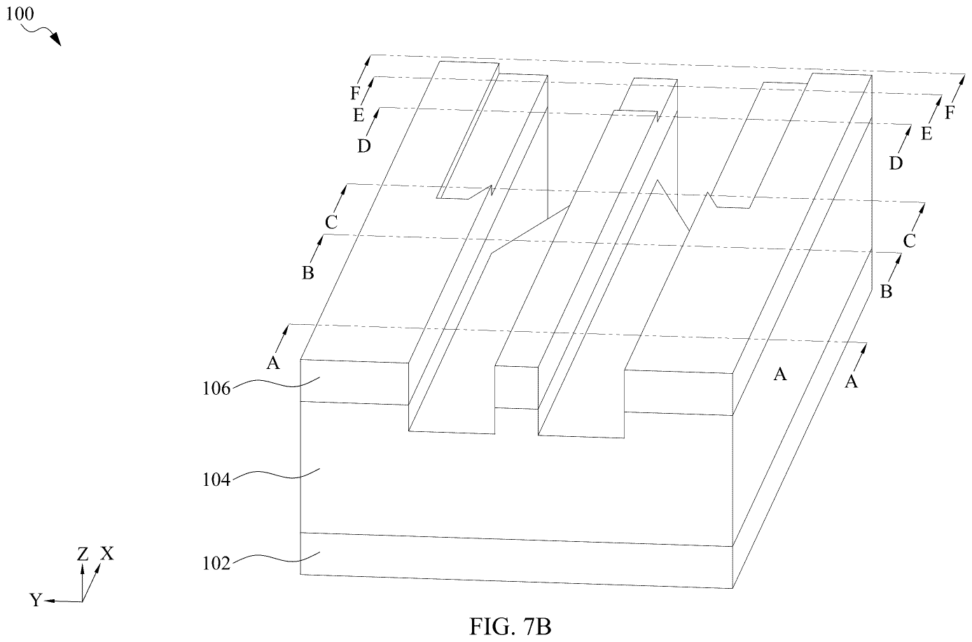

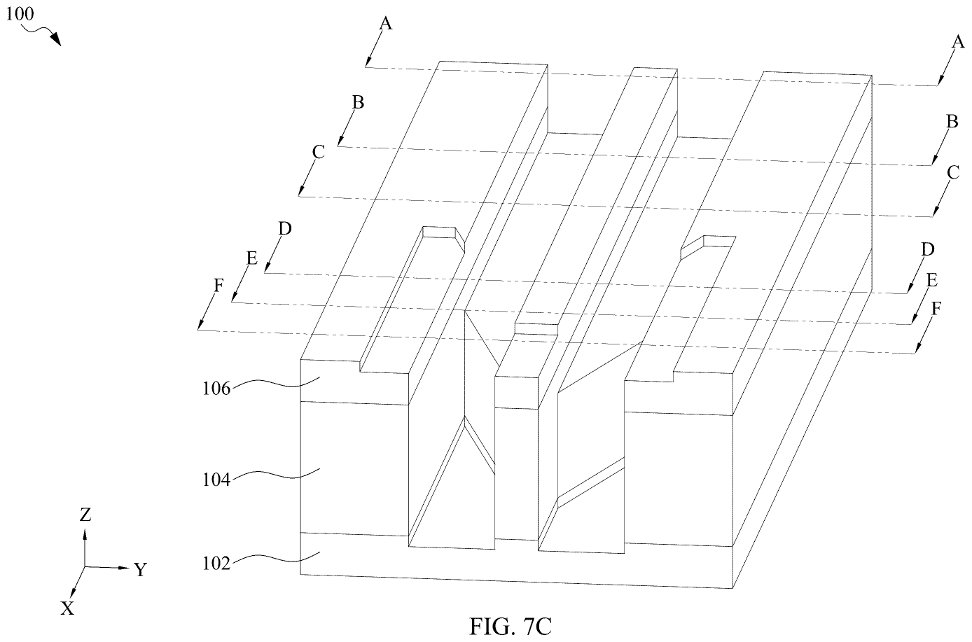

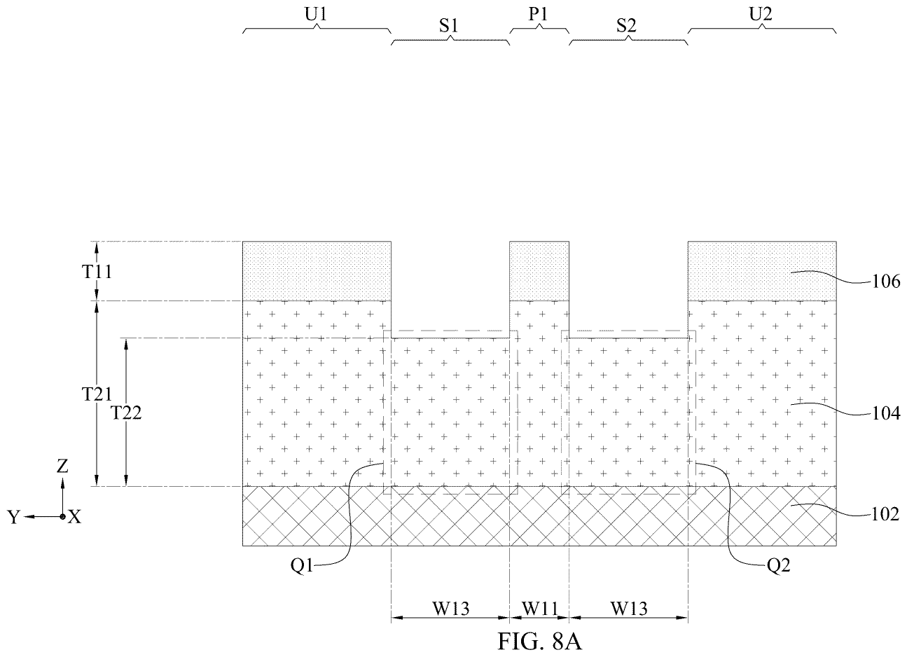

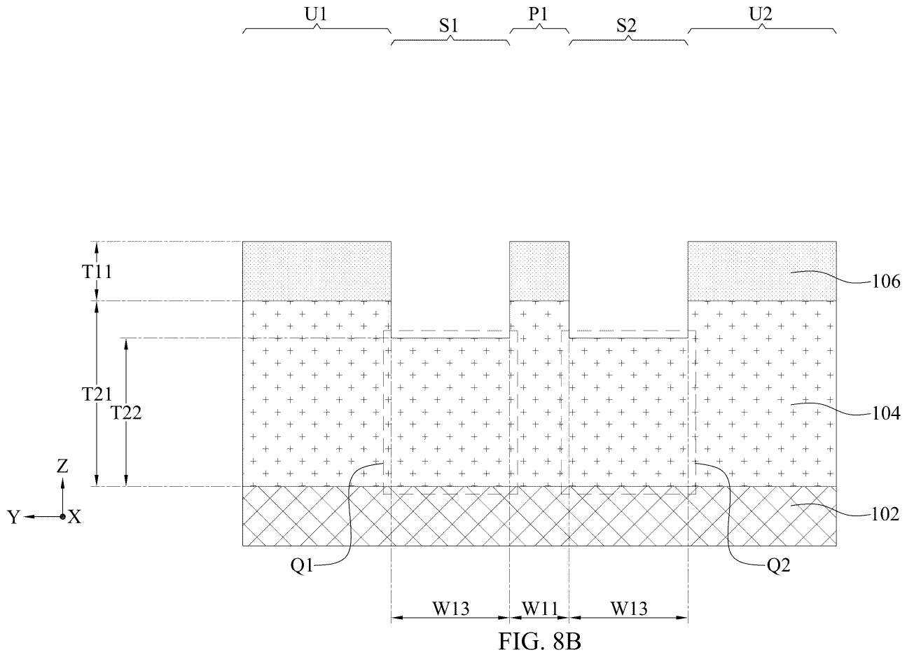

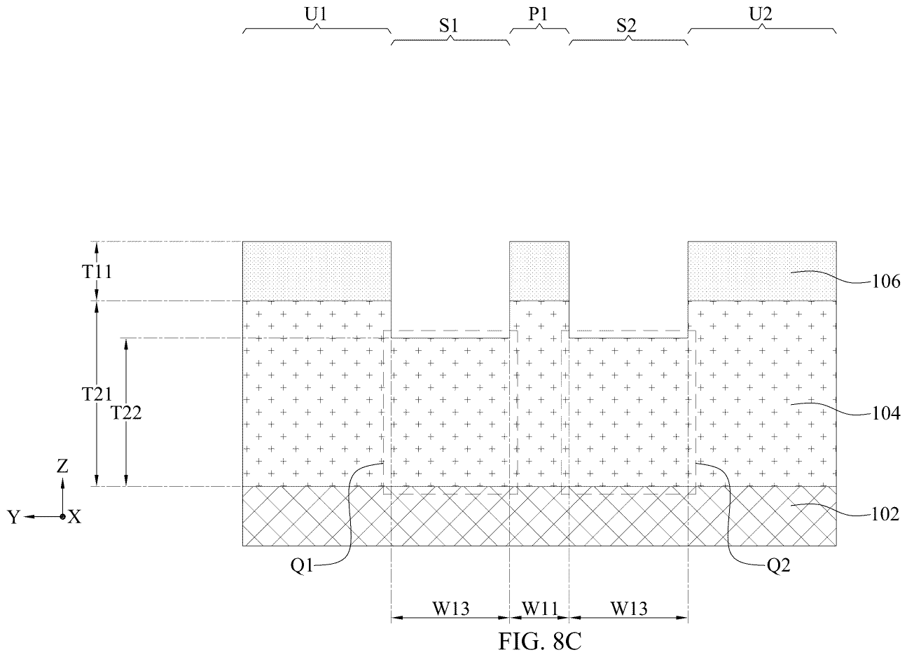

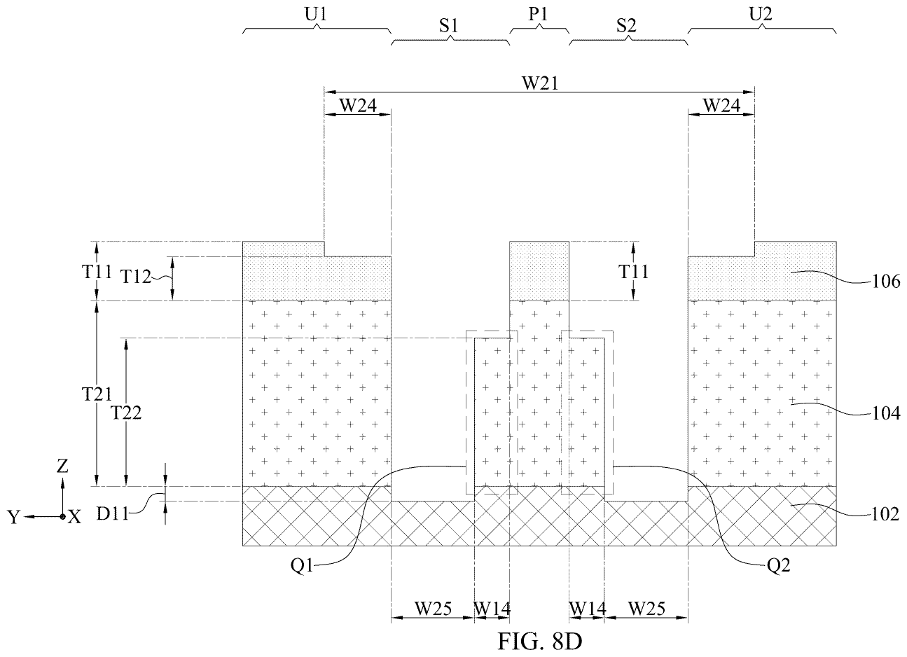

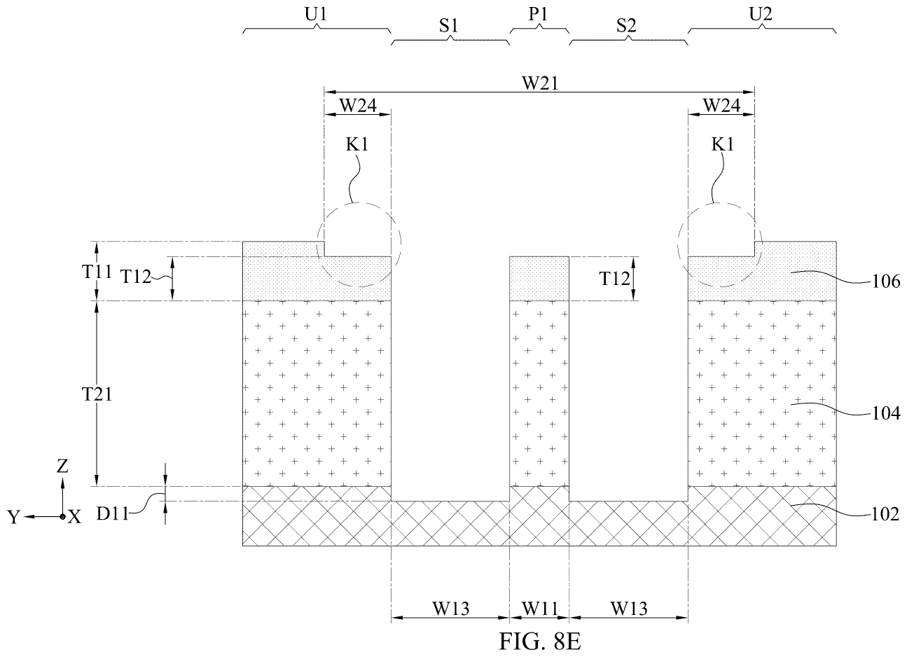

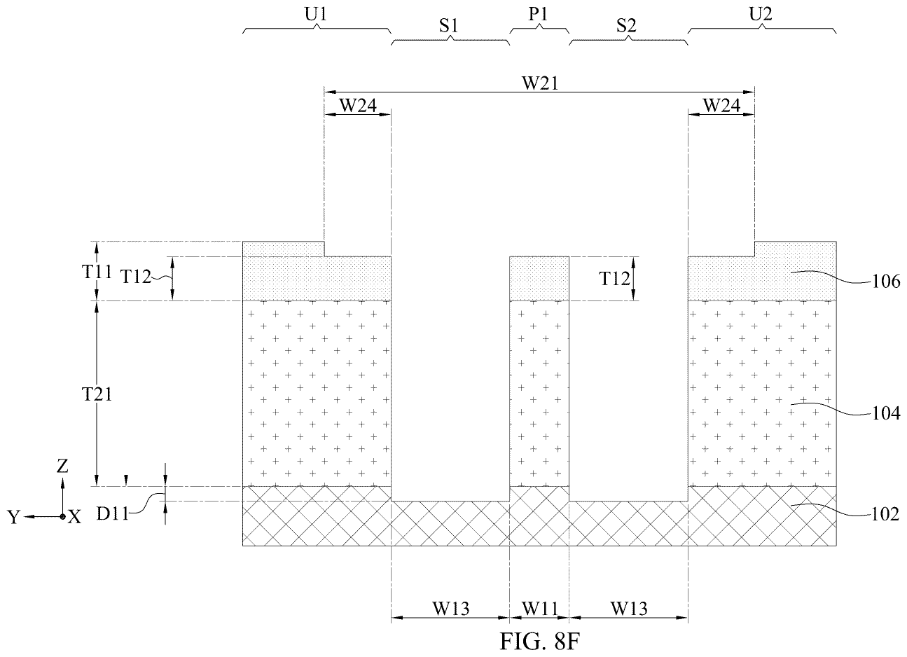

According to some embodiments, a second etching operation is performed on the semiconductor waveguide device 100 using the photomask PM2 in a manner similar to that described with reference to FIGS. 2A to 2F. The second etching operation may be a dry etch, a wet etch, an RIE, or the like. FIG. 7A is a schematic top view of the semiconductor waveguide device 100 after the first and second etching operations, in accordance with some embodiments of the present disclosure. FIGS. 7B and 7C are schematic perspective views of the semiconductor waveguide device 100 shown in FIG. 7A, in accordance with some embodiments of the present disclosure. FIGS. 8A, 8B, 8C, 8D, 8E and 8F are schematic cross-sectional views of the semiconductor waveguide device 100 shown in FIG. 7A, in accordance with some embodiments of the present disclosure.

FIG. 6B is a schematic plan view of overlaid photomasks PM1 and PM2, in accordance with some embodiments of the present disclosure. The plan view of the overlaid photomasks PM1 and PM2 may help illustrate overlapping areas of the photomasks PM1 and PM2 more clearly. Some subtle profile changes in thickness, heights, widths or depths in the hard mask layer 106, the silicon layer 104 and the dielectric layer 102 shown in the cross-sectional views of FIGS. 7A to 7C and 8A to 8F may correspond to such overlapping areas.

Referring to FIGS. 6B, 7A to 7C and 8A to 8C, since the opening N2 of the photomask PM2 does not extend into the zones Z1 and Z2, profiles of the semiconductor waveguide device 100 along the cross sections AA, BB and CC shown in FIGS. 8A, 8B and 8C, respectively, are kept substantially same as profiles of the semiconductor waveguide device 100 shown in FIGS. 5A, 5B and 5C. According to some embodiments, the photomask PM2 is used to form a strip waveguide WG-S in an area around the zone Z5 or along the cross section FF, and to form a transitional waveguide between the strip waveguide WG-S and a rib waveguide WG-R that is to be formed in an area around the cross section CC.

According to some embodiments, the opening N2 of the photomask PM2 causes the second etching operation to consume a thickness of the hard mask layer 106 in the protrusion region P1, the first support region U1 and the second support region U2. Referring to FIG. 6B, the opening N2 overlaps the first support region U1 and the second support region U2 in the zones Z3, Z4 and Z5 with an overlap area having the length L21 and a width W24 measured in the Y-axis direction. As a result, the second etching operation consumes an area of the hard mask layer 106 on a side of the first support region U1 and the second support region U2 facing the protrusion region P1 with a length L21 and a width W24. Referring to FIGS. 8D, 8E and 8F, the consumed area forms a step K1 on an upper corner of the hard mask layer 106 of each of the first support region U1 and the second support region U2. The hard mask layer 106 thus includes a reduced thickness T12 at the step K1 on the corner of the first support region U1 or the second support region U2 after the second etching operation.

According to some embodiments, the first portion PM21 of the opening N2 overlaps the entire protrusion region P1 in an area around the zone Z5. As a result, the second etching operation consumes a thickness of the hard mask layer 106 of the first protrusion region P1 in the zone Z5. Referring to FIGS. 8E and 8F, the hard mask layer 106 of the protrusion region P1 thus includes the reduced thickness T12 after the second etching operation.

According to some embodiments, the first portion PM21 of the opening N2 causes portions of the first connecting region Q1 and the second connecting region Q2 in the silicon layer 104 to be removed during the second etching operation. As a result, portions of the first connecting region Q1 and the second connecting region Q2 in the zone Z5 are completely removed from the silicon layer 104. The removed portions correspond to the first portion PM21 of the opening N2. Further, the semiconductor waveguide device 100 forms a strip waveguide WG-S in the zone Z5 or along the cross sections EE and FF. Moreover, referring to FIGS. 8E and 8F, the hard mask layer 106 of the protrusion region P1 includes a reduced thickness T12 along the cross sections EE and FF and the zone Z5, and maintains the thickness T11 outside the zone Z5.

According to some embodiments, the two second portions PM22 of the opening N2 cause portions of the first connecting region Q1 and the second connecting region Q2 in the silicon layer 104 to be partially removed during the second etching operation. The partially removed portions correspond to tapering shapes of the second portions PM22 of the opening N2. Thus, remaining portions of the first connecting region Q1 and the second connecting region Q2, referred to herein as a wing portion Q1 or Q2, are formed including a tapering shape from a top-view perspective. Referring to FIG. 6B, the wing portions Q1 and Q2 include a reducing width W14 measured in the Y-axis direction from a cross section GG in the zone Z3 to a location along the cross section EE, wherein the cross section GG is taken at an intersection of the second portion PM22 of the photomask PM2 and the strip region N1 of the photomask PM1. Referring to FIG. 8D, the wing portions Q1 and Q2 with a width W14 are formed along the cross section DD.

According to some embodiments, during the formation of the wing portions Q1 and Q2, the second etching operation removes the portions of the first connecting region Q1 and the second connecting region Q2 outside the range of the subsequently-formed wing portions Q1 and Q2. The third etching operation may proceed farther downward to remove a thickness or a depth D11 of the dielectric layer 102 during the formation of the wing portions Q1 and Q2 to ensure that the silicon layer 104 is completely removed in such areas. Referring to FIG. 6B, the etched areas of the etched dielectric layer 102 correspond to intersections of the photomask PM2 with each of the strip regions N1 of the photomask PM1, wherein each of the etched areas has a width W25. Referring to FIGS. 8D, 8E and 8F, the dielectric layer 102 exposed through the silicon layer 104 between the wing portion Q1 and the first support region U1 or between the wing portion Q2 and the second support region U2 has a recess with the width W25 and the depth D11, wherein the width W25 is substantially equal to the width W13 along the cross sections EE and FF.

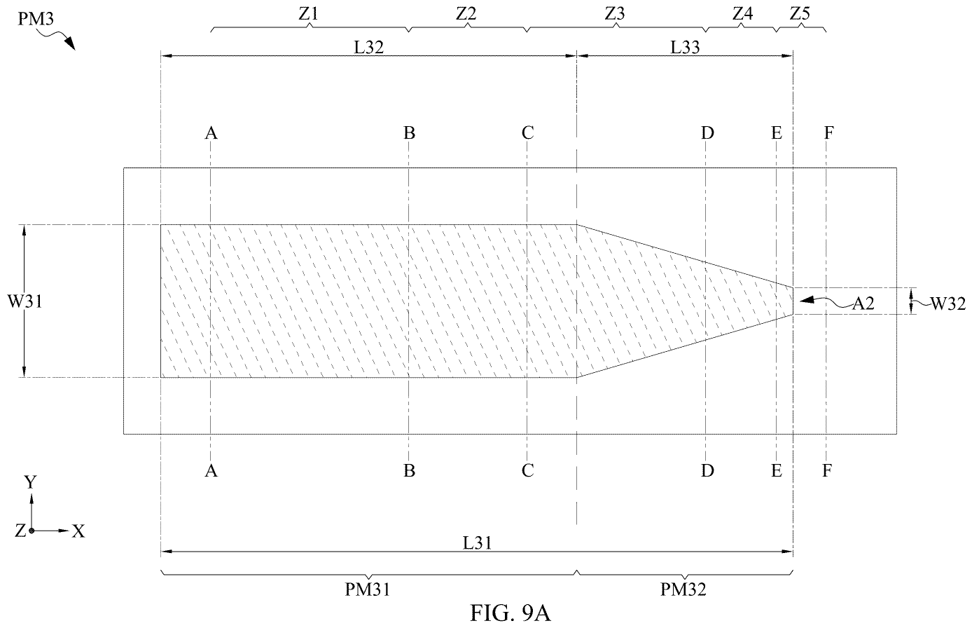

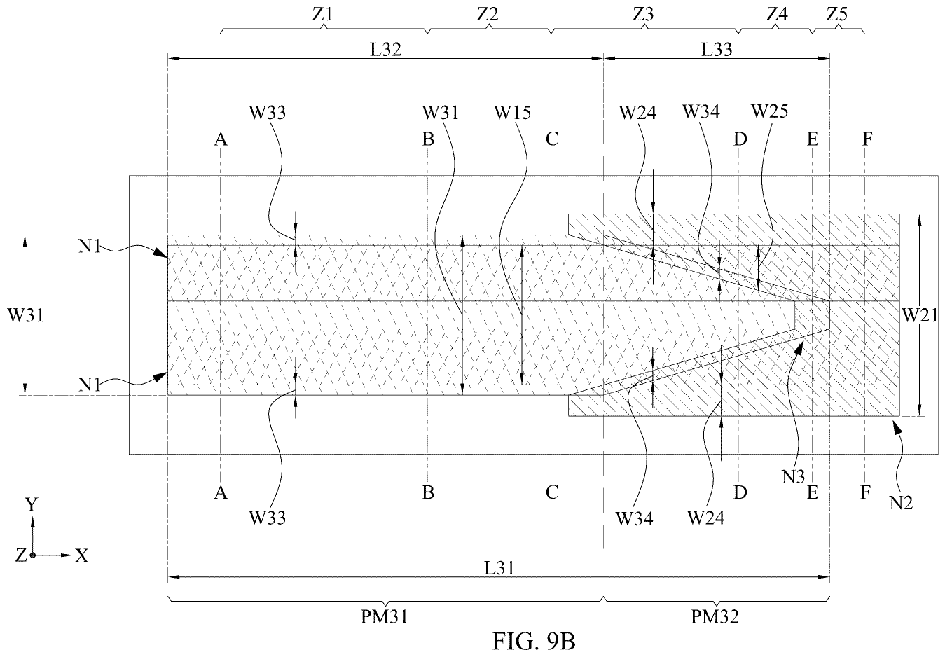

FIG. 9A is a schematic plan view of a photomask PM3, in accordance with some embodiments of the present disclosure. According to some embodiments, the photomask PM3 includes an opening N3 with a pencil-like shape, which includes a rectangular shape and a tapering tip extending in the X-axis direction. The opening N3 includes a length L31 measured in the X-axis direction and a width W31 measured in the Y-axis direction. The opening N3 includes a first portion PM31 and a second portion PM32 connected to the first portion PM31. According to some embodiments, the first portion PM31 is substantially of a rectangular shape extending in the zones Z1, Z2 and Z3, wherein the first portion PM31 includes the width W31 and a length L32. According to some embodiments, the second portion PM32 includes a length L33 and extends from a location in the zone Z3, through the zone Z4, and to the end side A2 in the zone Z5. The second portion PM32 tapers from the width W31 in a location in the zone Z3 to the width W32 on the end side A2 in the zone Z5.

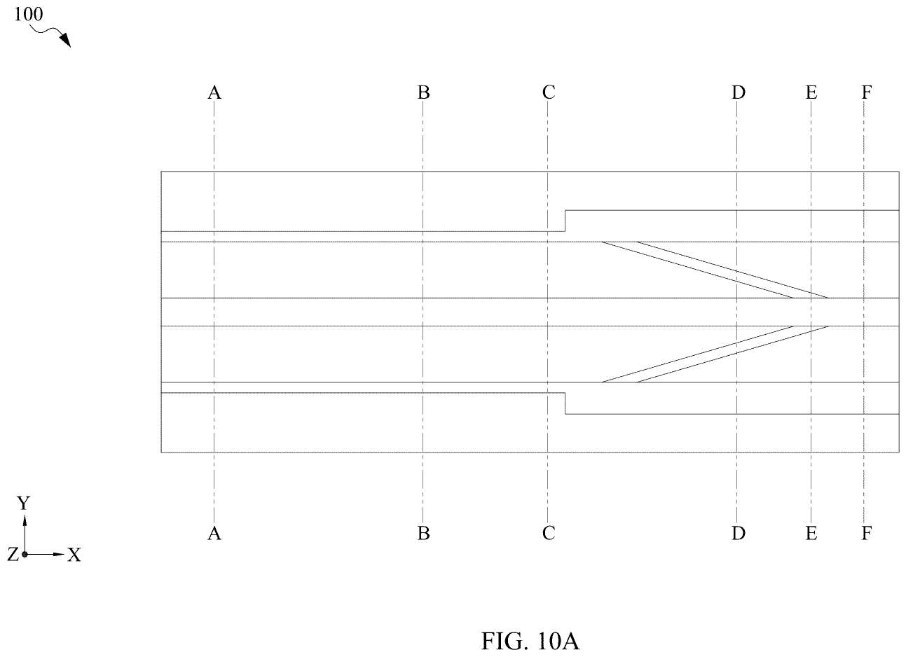

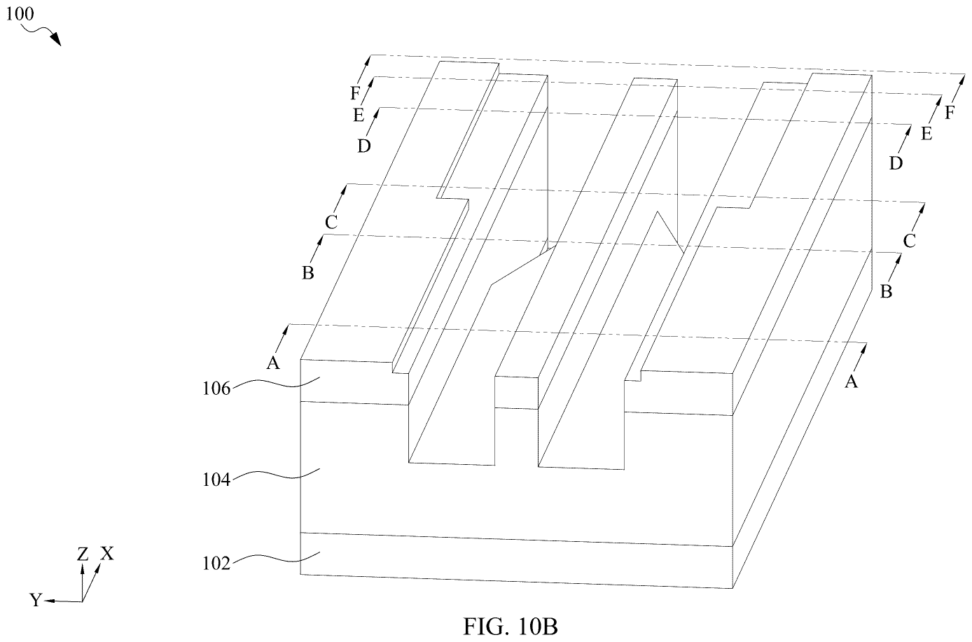

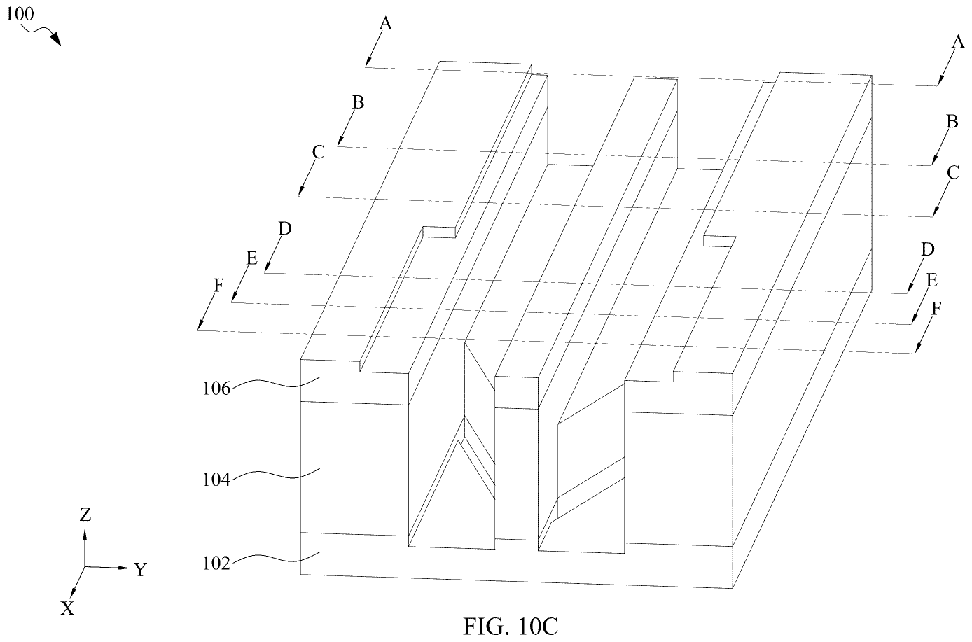

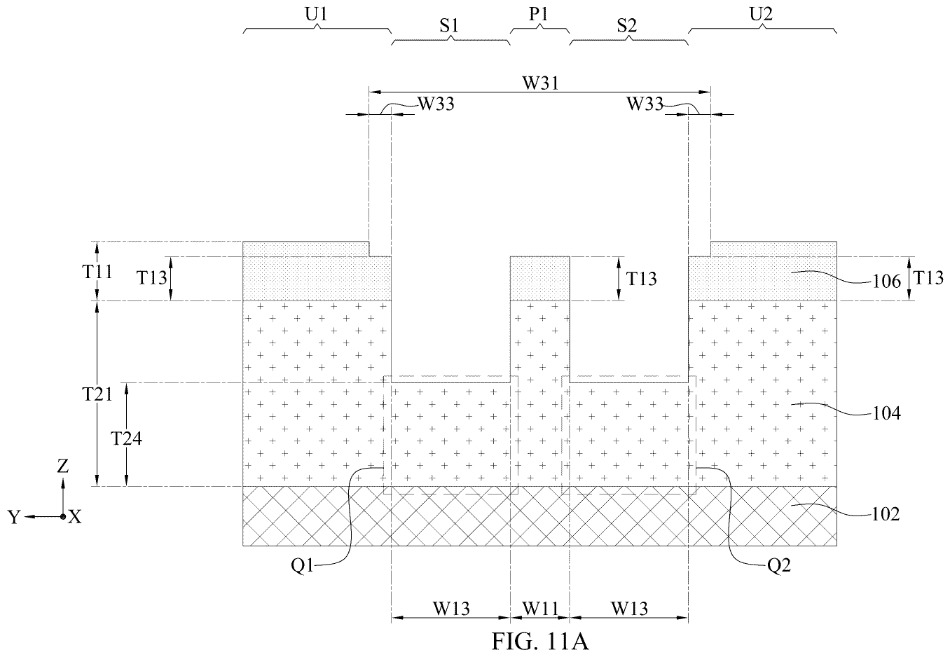

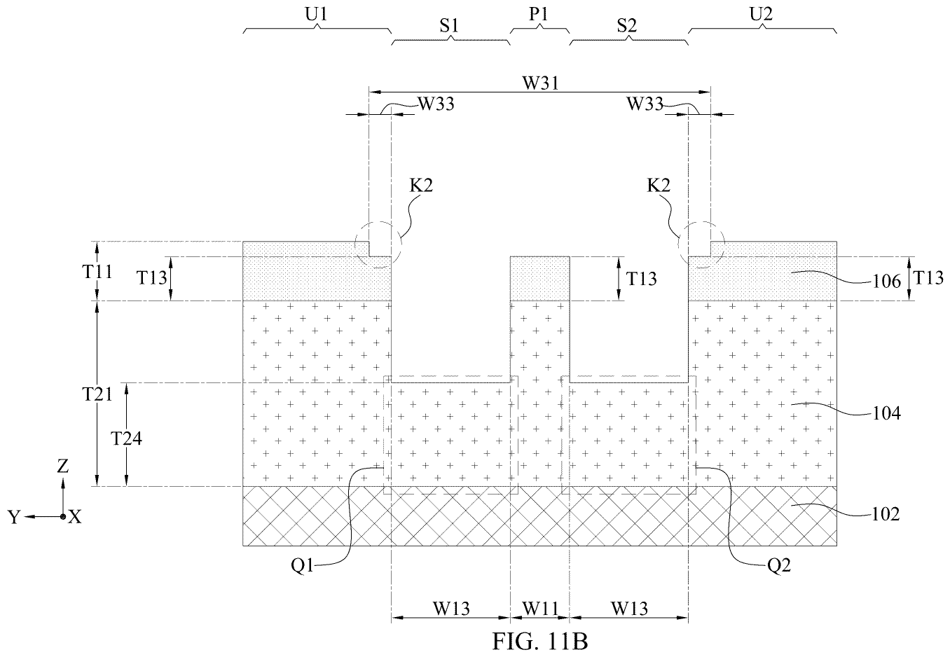

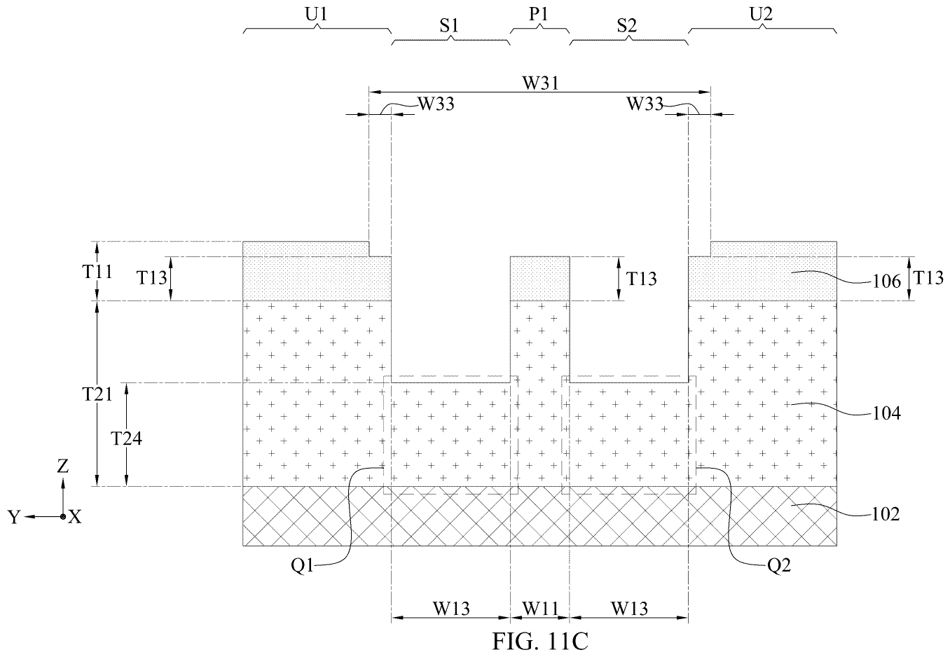

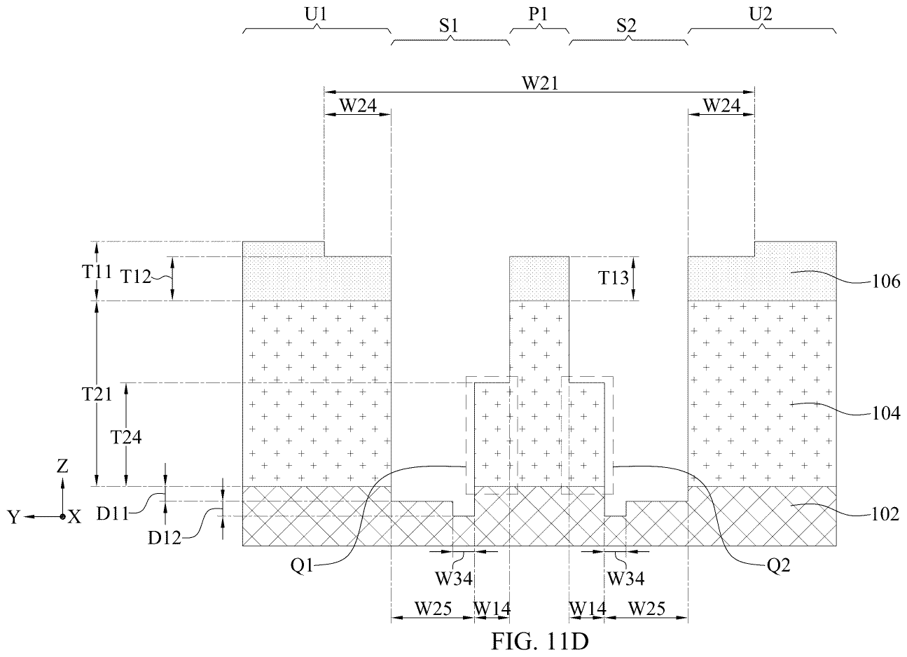

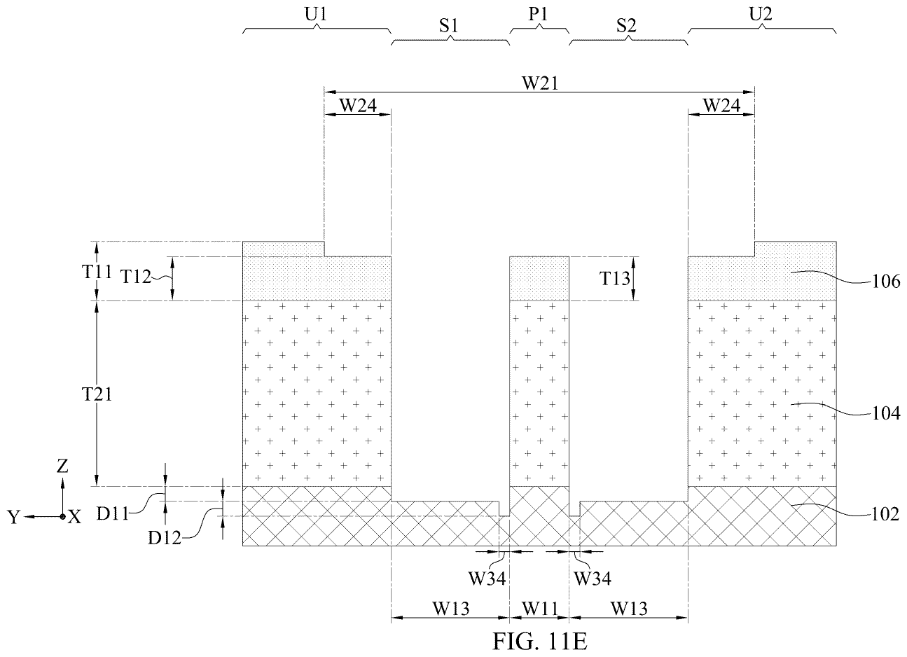

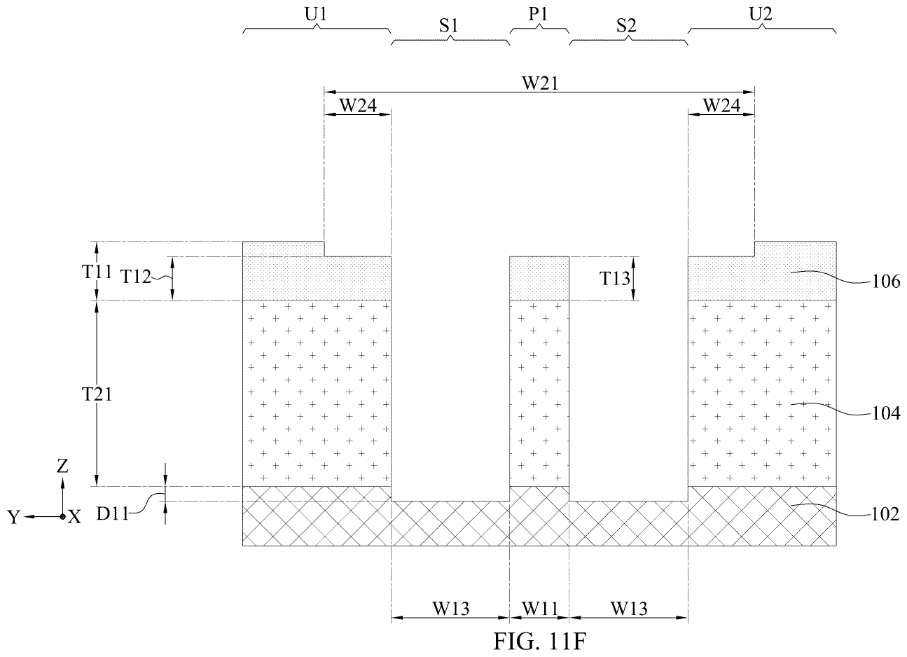

According to some embodiments, a third etching operation is performed on the semiconductor waveguide device 100 using the photomask PM3 in a manner similar to that described with reference to FIGS. 2A to 2F. The third etching operation may be a dry etch, a wet etch, an RIE, or the like. FIG. 10A is a schematic top view of the semiconductor waveguide device 100 after the first, second and third etching operations, in accordance with some embodiments of the present disclosure. FIGS. 10B and 10C are schematic perspective views of the semiconductor waveguide device 100 shown in FIG. 10A, in accordance with some embodiments of the present disclosure. FIGS. 11A, 11B, 11C, 11D, 11E and 11F are schematic cross-sectional views of the semiconductor waveguide device 100 shown in FIG. 10A, in accordance with some embodiments of the present disclosure.

FIG. 9B is a schematic plan view of overlaid photomasks PM1, PM2 and PM3, in accordance with some embodiments of the present disclosure. Referring to FIGS. 9B, 10A to 10C and 11F, since the opening N3 of the photomask PM3 does not extend into the area of the right half of the zone Z5 (including the cross section FF), the profile of the semiconductor waveguide device 100 taken along the cross section FF shown in FIG. 11F is kept substantially same as the profile of the semiconductor waveguide device 100 shown in FIG. 8F. According to some embodiments, the photomask PM3 is used to form a rib waveguide WG-R in an area around the cross section CC, and to form a transitional waveguide between the rib waveguide WG-R and a deep-rib waveguide WG-dR that is to be formed in an area around the cross section AA.

According to some embodiments, the opening N3 of the photomask PM3 causes the third etching operation to consume a thickness of the hard mask layer 106 in the protrusion region P1, the first support region U1 and the second support region U2. Referring to FIG. 9B, the first portion PM31 overlaps the first support region U1 and the second support region U2 in the zones Z1, Z2 and Z3 with an overlap area having the length L31 and a width W33 measured in the Y-axis direction. As a result, the third etching operation consumes an area of the hard mask layer 106 on a side of the first support region U1 and the second support region U2 facing the protrusion region P1 with a length L31 and a width W33. Referring to FIGS. 11A, 11B and 11C, the consumed area forms a step K2 on an upper corner of the hard mask layer 106 of each of the first support region U1 and the second support region U2. The hard mask layer 106 thus includes a reduced thickness T13 at the step K1 on the upper corner of the first support region U1 or the second support region U2 after the third etching operation.

According to some embodiments, the first portion PM31 of the opening N3 overlaps the entire protrusion region P1 in an area around the zones Z1, Z2, Z3 and Z4. As a result, the third etching operation consumes a thickness of the hard mask layer 106 of the first protrusion region P1 in the entirety of zones Z1, Z2, Z3, Z4 and part of the zone Z5. Referring to FIGS. 11A, 11B, 11C and 11D, the hard mask layer 106 of the protrusion region P1 includes a reduced thickness T13 along the cross sections AA, BB, CC and DD, and includes a reduced thickness T14, wherein the thickness T14 results from the second and third etching operations. Further, the protrusion region P1 maintains the thickness T12 in an area of the zone Z5 offset from the opening N3, as can also be seen in the cross-sectional view of FIG. 11F.

According to some embodiments, the first portion PM31 of the opening N3 causes portions of the first connecting region Q1 and the second connecting region Q2 in the silicon layer 104 to be removed during the third etching operation. As a result, a thickness of the first connecting region Q1 and the second connecting region Q2 in the entirety of zones Z1 and Z2 and part of zone Z3 is removed from the silicon layer 104. The area of the removed thickness corresponds to the first portion PM31 of the opening N3. Referring to FIGS. 11A, 11B and 11C, the first connecting region Q1 and the second connecting region Q2 include a reduced thickness T24 in the silicon layer 104. Thus, the semiconductor waveguide device 100 forms a rib waveguide WG-R around the cross section CC.

According to some embodiments, the second portion PM32 of the opening N1 causes a thickness of the first connecting region Q1 and the second connecting region Q2 in the silicon layer 104 to be further removed during the third etching operation. The area of the removed thickness corresponds to tapering shapes of the second portions PM22 of the opening N2 instead of tapering shapes of the second portion PM32 of the opening N3 because the portions of the silicon layer 104 between the tapering shape of the second portion PM22 and the tapering shape of the second portion PM32 are removed during the second etching operation. Thus, the wing portions Q1 and Q2 are formed including a tapering shape from a top-view perspective and a thickness T24.

According to some embodiments, during the thickness reduction of the wing portions Q1 and Q2, the third etching operation may proceed farther downward to cause a removed thickness or a depth D12, greater than the depth D11, of the dielectric layer 102 to ensure that the silicon layer 104 is completely removed in such areas. Referring to FIG. 9B, the more deeply etched areas of the etched dielectric layer 102 correspond to an intersection of the tapering shape of the second portion PM22 of the photomask PM2 and the tapering shape of the second portion PM32 of the photomask PM3, and the deeply etched area has a width W34. Referring to FIGS. 11D, 11E and 11F, the dielectric layer 102 exposed through the silicon layer 104 has a recess with the width W34 and the depth D12, wherein the width W34 reduces to zero in an area of the zone Z5 offset from the opening N3 or along the cross section FF.

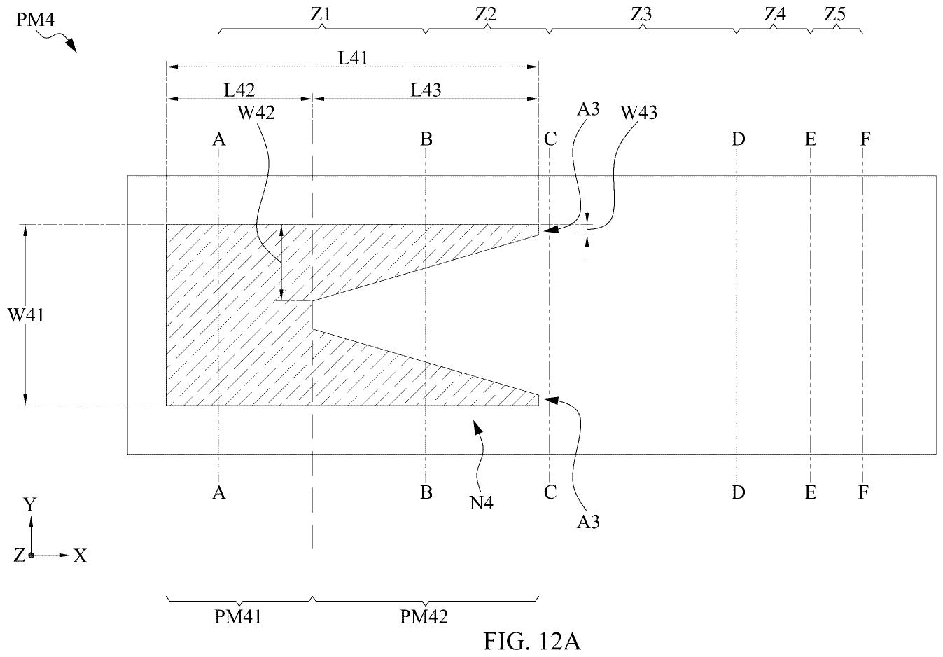

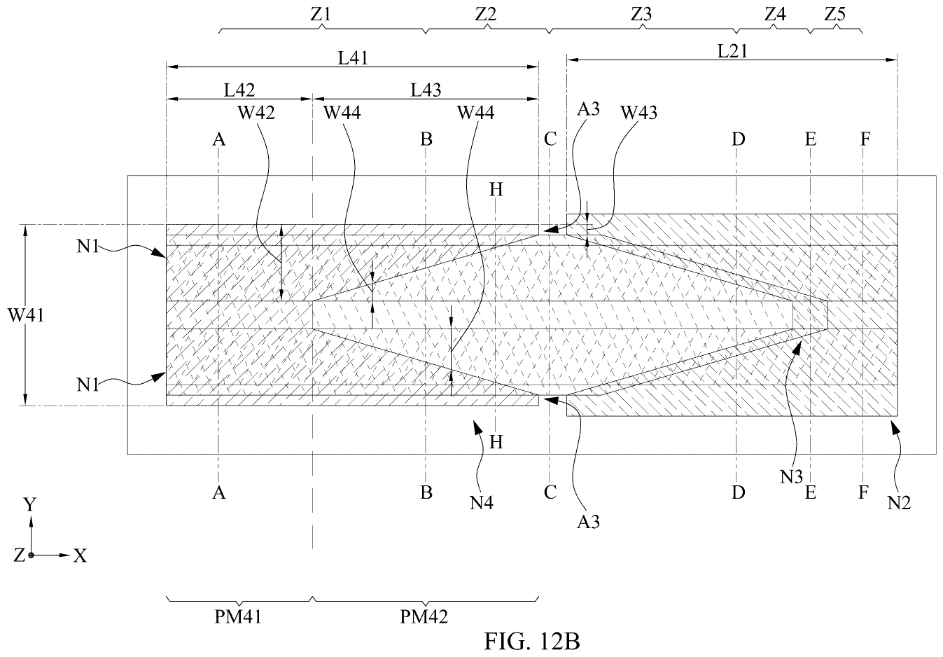

FIG. 12A is a schematic plan view of a photomask PM4, in accordance with some embodiments of the present disclosure. According to some embodiments, the photomask PM4 includes an opening N4 with a C shape having a width W41 measured in the Y-axis direction and a length L41 measured in the X-axis direction. The opening N4 includes a first portion PM41 and two second portions PM42 connected to the first portion PM41. According to some embodiments, the first portion PM41 is substantially of a rectangular shape extending into the zones Z1 and Z2, wherein the first portion PM41 includes the width W41 and a length L42. According to some embodiments, the second portions PM42 are of substantially equal shapes and areas. Each of the second portions PM42 includes a length L43 and extends from a location in the zone Z2 to the end side A3 in the zone Z3. The two second portions PM42 may be mirror images of each other with respect to a hypothetical horizontal line between the two second portions PM42. Each of the two second portions PM42 tapers from a first width W42 in the zone Z1 to a second width W43 on the end side A3 in the zone Z2 proximal to the cross section CC or a central line of the substrate 101 of the semiconductor waveguide device 100. The mouth of the C shape formed by the first portion PM41 and the two second portions PM42 includes a trapezoidal shape with two lateral sides tapering from the end sides A3 of the second portions PM42 to the first portion PM41.

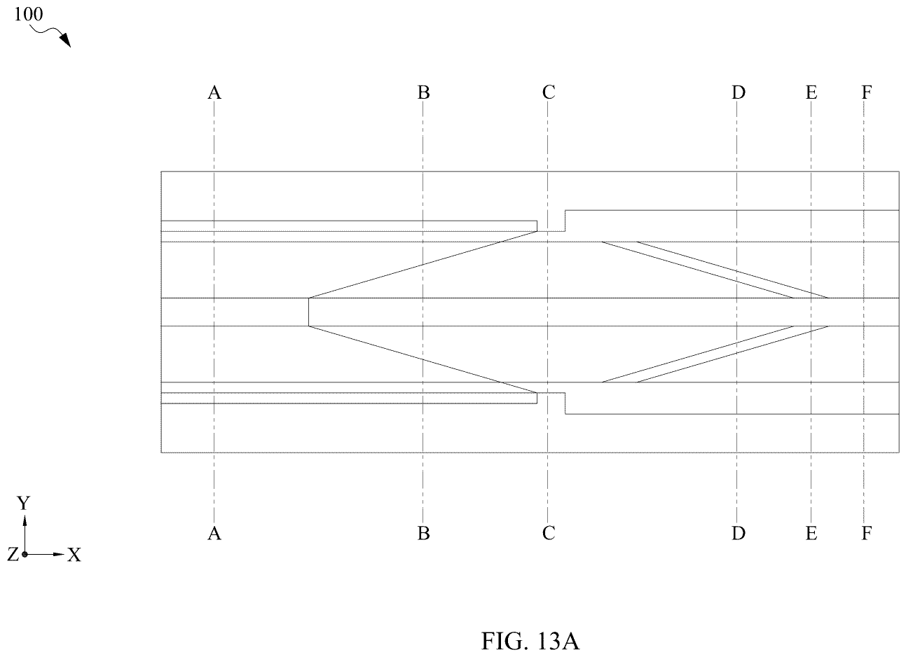

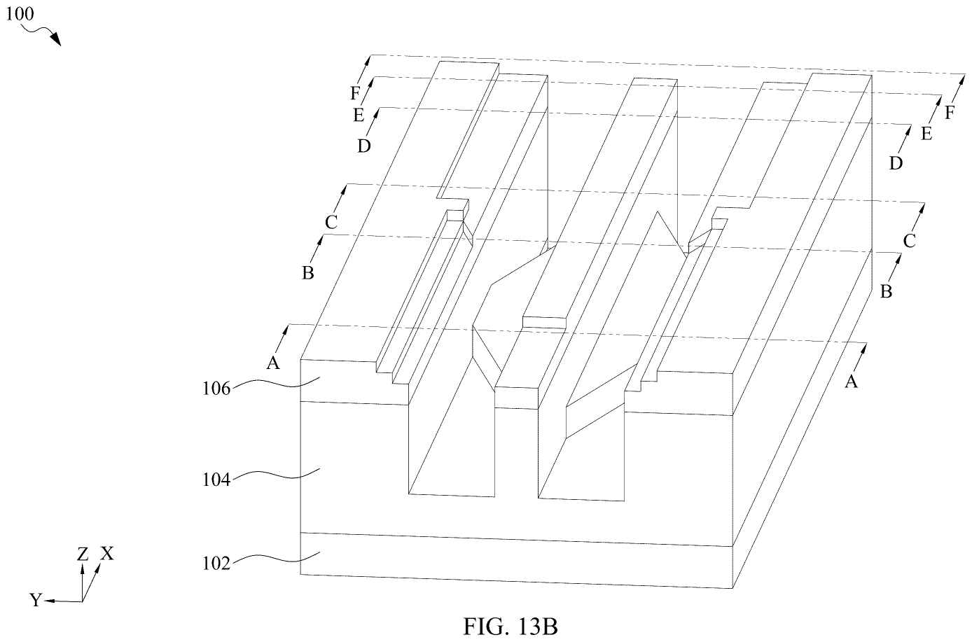

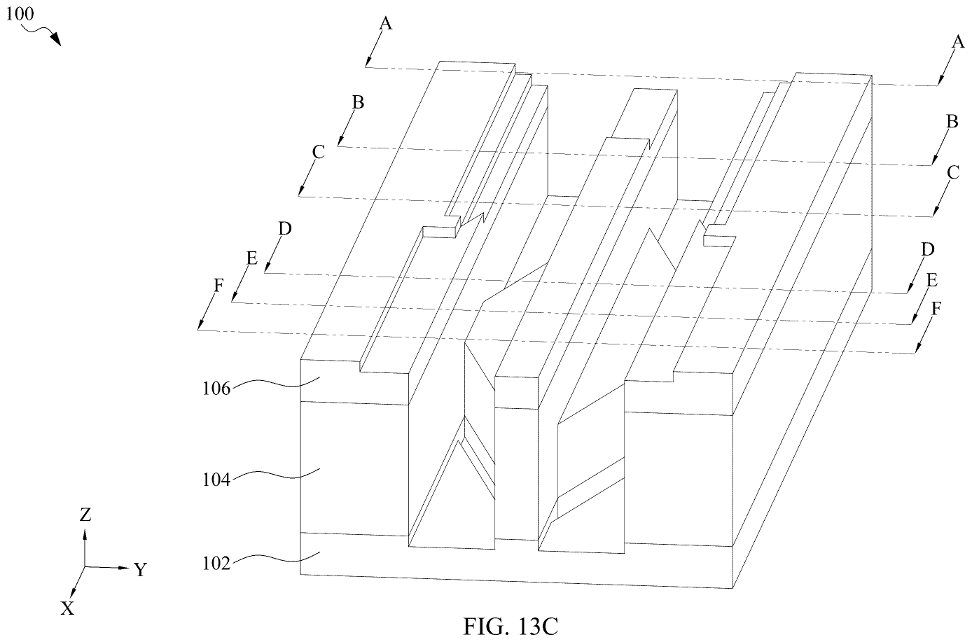

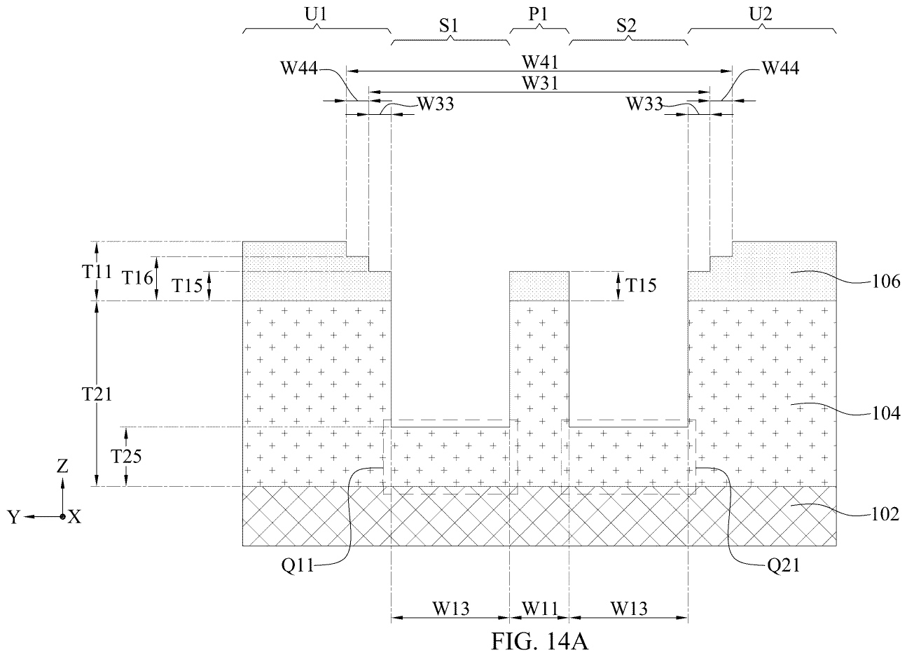

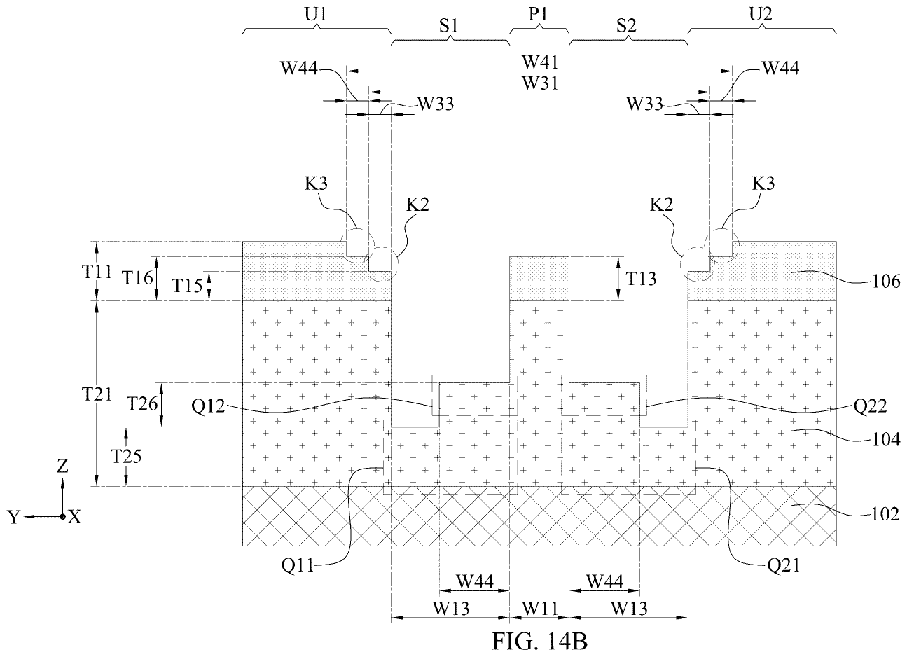

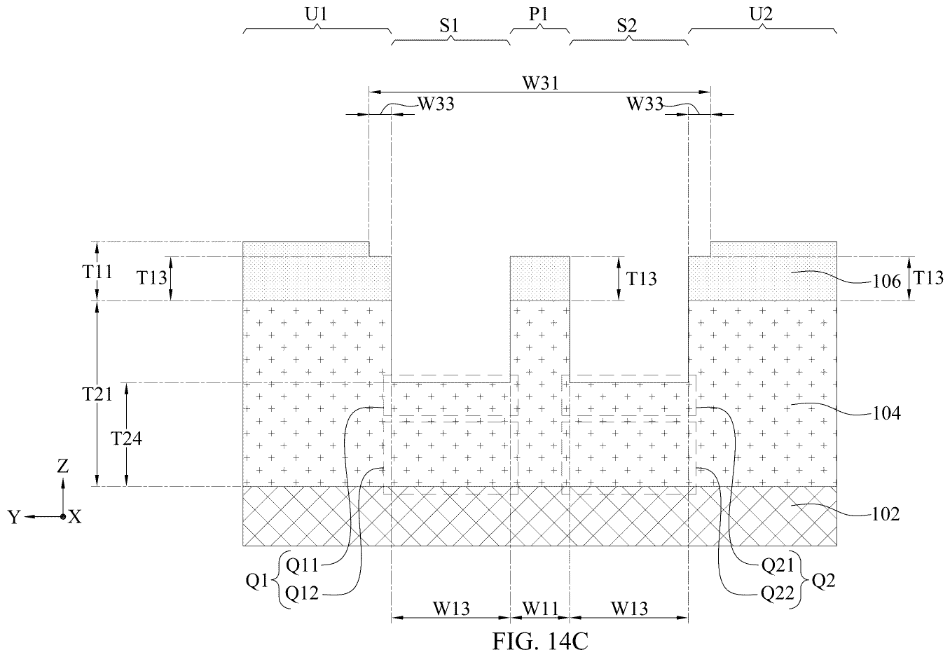

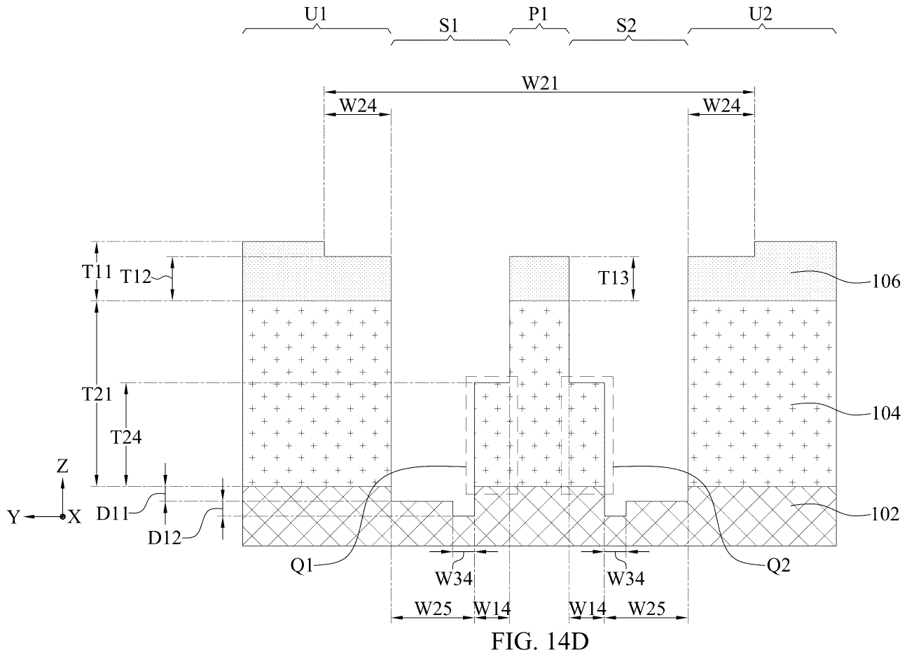

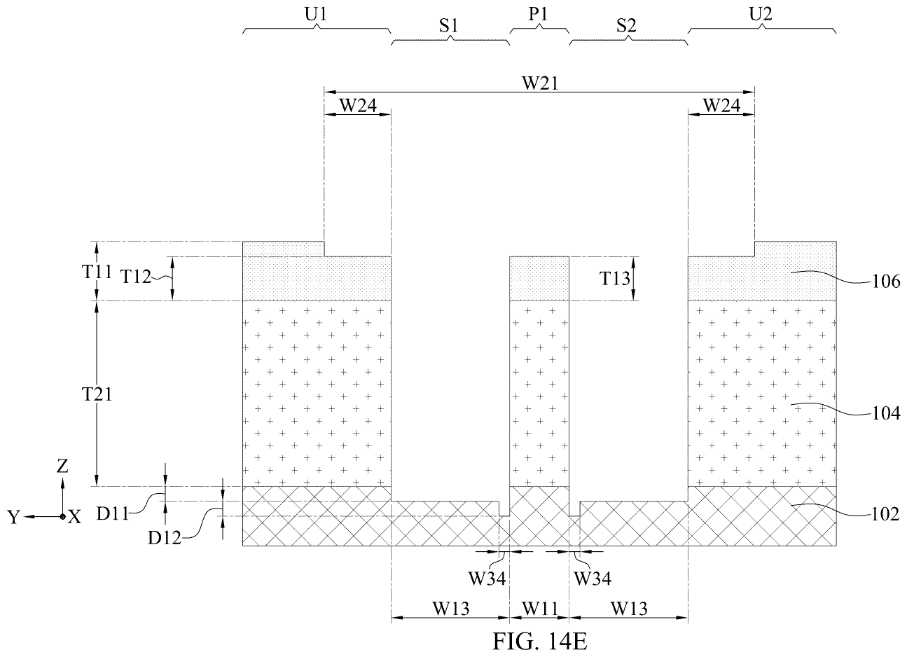

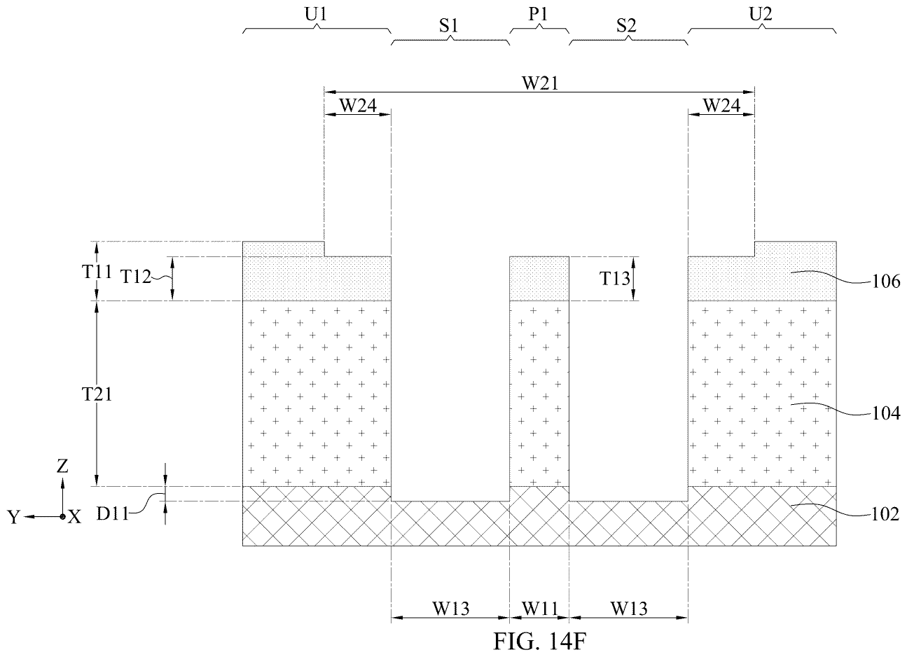

According to some embodiments, a fourth etching operation is performed on the semiconductor waveguide device 100 using the photomask PM4 in a manner similar to that described with reference to FIGS. 2A to 2F. The fourth etching operation may be a dry etch, a wet etch, an RIE, or the like. FIG. 13A is a schematic top view of the semiconductor waveguide device 100 after the first, second, third and fourth etching operations, in accordance with some embodiments of the present disclosure. FIGS. 13B and 13C are schematic perspective views of the semiconductor waveguide device 100 shown in FIG. 13A, in accordance with some embodiments of the present disclosure. FIGS. 14A, 14B, 14C, 14D, 14E and 14F are schematic cross-sectional views of the semiconductor waveguide device 100 shown in FIG. 13A, in accordance with some embodiments of the present disclosure.

FIG. 12B is a schematic plan view of overlaid photomasks PM1, PM2, PM3 and PM4, in accordance with some embodiments of the present disclosure. Referring to FIGS. 12B, 13A to 13C and 14C to 14F, since the opening N4 of the photomask PM4 does not extend into the zones Z3, Z4 and Z5, the profiles of the semiconductor waveguide device 100 along the cross sections CC, DD, EE and FF shown in FIGS. 14C, 14D, 14E and 14F, respectively, are kept substantially same as profiles of the semiconductor waveguide device 100 shown in FIGS. 11C, 11D, 11E and 11F. According to some embodiments, the photomask PM4 is used to form a deep-rib waveguide WG-dR in an area around the cross section AA, and forms a transitional waveguide between the deep-rib waveguide WG-dR and the rib waveguide WG-R formed around the cross section CC.

According to some embodiments, the opening N4 of the photomask PM4 causes the fourth etching operation to consume a thickness of the hard mask layer 106 in the protrusion region P1, the first support region U1 and the second support region U2. Referring to FIG. 12B, the opening N4 overlaps the first support region U1 and the second support region U2 in the zones Z1 and Z2 with an overlap area having the length L41 and a width W44 measured in the Y-axis direction. As a result, the fourth etching operation further consumes an area of the hard mask layer 106 on a side of the first support region U1 and the second support region U2 facing the protrusion region P1 with a length L41 and a width W44. Referring to FIGS. 14A and 14B, the consumed area forms a second step K3 on top of the step K2 on an upper corner of the hard mask layer 106 of each of the first support region U1 and the second support region U2. The hard mask layer 106 thus includes reduced thicknesses T15 and T16 at the steps K2 and K3, respectively, on the corner of the first support region U1 or the second support region U2 after the fourth etching operation, wherein the thickness T15 is less than the thickness T16.

According to some embodiments, the first portion PM41 of the opening N4 overlaps the entire protrusion region P1 in an area around the cross section AA. As a result, the fourth etching operation consumes a thickness of the hard mask layer 106 of the first protrusion region P1 in part of the zone Z1, including the cross section AA. Referring to FIG. 14A, the hard mask layer 106 of the protrusion region P1 thus includes the reduced thickness T15 after the fourth etching operation.

According to some embodiments, the first portion PM41 of the opening N4 causes a thickness of the first connecting region Q1 and the second connecting region Q2 in the silicon layer 104 to be removed during the fourth etching operation. As a result, a thickness of the first connecting region Q1 and the second connecting region Q2 in the zone Z1 is removed from the silicon layer 104. An area of the removed thickness corresponds to the first portion PM41 of the opening N4. A remaining portion of the first connecting region Q1 or the second connecting region Q2 has a thickness T25. Further, referring to FIG. 14A, the semiconductor waveguide device 100 forms a deep-rib waveguide WG-dR in the zone Z1 or along the cross section AA with a thickness T25 of the first connecting region Q1 or the second connecting region Q2.

According to some embodiments, the two second portions PM42 of the opening N4 cause a thickness of the first connecting region Q1 and the second connecting region Q2 in the silicon layer 104 to be removed during the fourth etching operation. The area of the removed thickness corresponds to tapering shapes of the second portions PM42 of the opening N4. Thus, the remaining portions of the first connecting region Q1 and the second connecting region Q2 include respective base portions Q11 and Q21 having the thickness T25 and respective wing portions Q21 or Q22, over the base portions Q11 and Q21. The wing portions Q21 and Q22 are formed including a tapering shape from a top-view perspective. Referring to FIG. 12B, the wing portions Q21 and Q22 include a reducing width W44 measured in the Y-axis direction from a cross section HH in the zone Z2 to a cross section II, wherein the cross section HH is taken at an intersection of the second portion PM42 of the photomask PM4 and the strip region N1 of the photomask PM1, and the cross section II is taken at an interface between the first portion PM41 and the second portion PM42. Referring to FIG. 14B, the wing portions Q21 and Q22 with a width W44 are formed along the cross section DD.

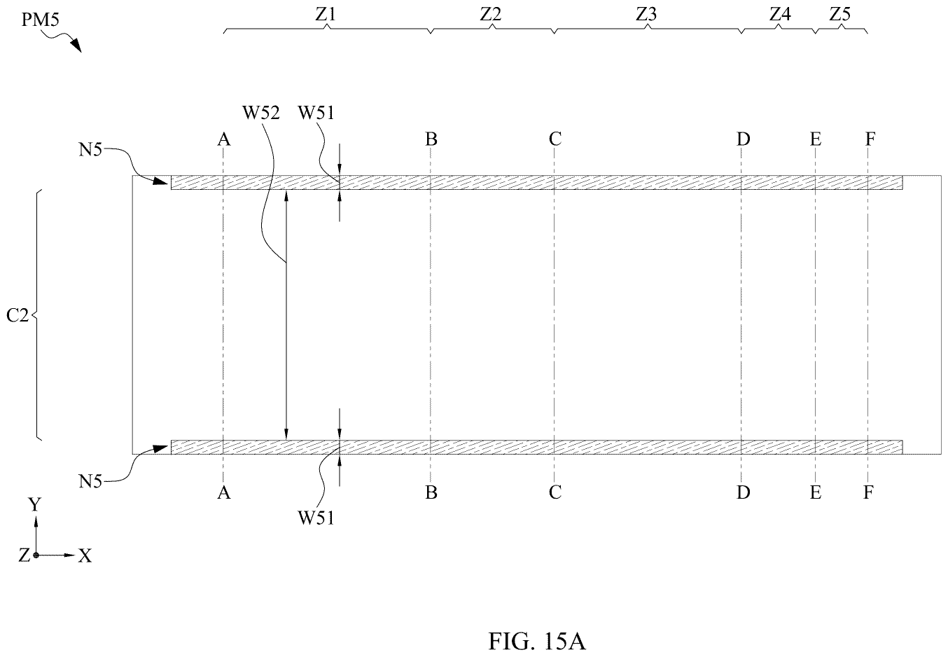

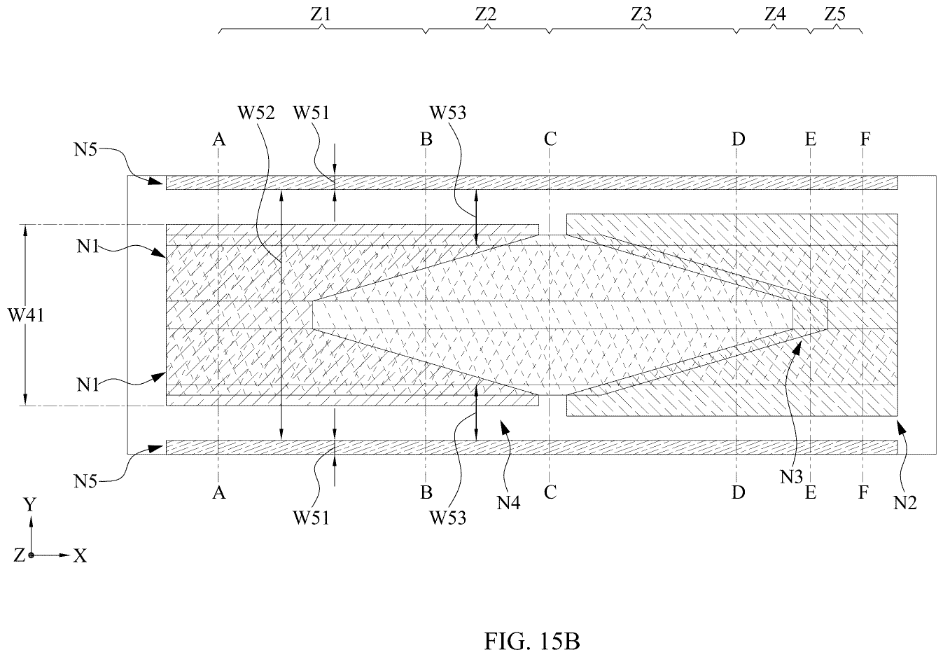

FIG. 15A is a schematic plan view of the photomask PM5, in accordance with some embodiments of the present disclosure. As shown in FIG. 15A, according to some embodiments, the photomask PM5 includes openings N5 including two strip regions arranged in parallel and extending in the X-axis direction. Other areas of the photomask PM5 are opaque and do not have openings, including a central region C2 arranged between the two strip regions N5. According to some embodiments, each of the strip regions N5 has a width W51 measured in the Y-axis direction, and the central region C2 has a width W52 measured in the Y-axis direction. According to some embodiments, the width W51 is defined as a distance measured in the Y-axis direction between two outer sides of the first support region U1 and the second support region U2.

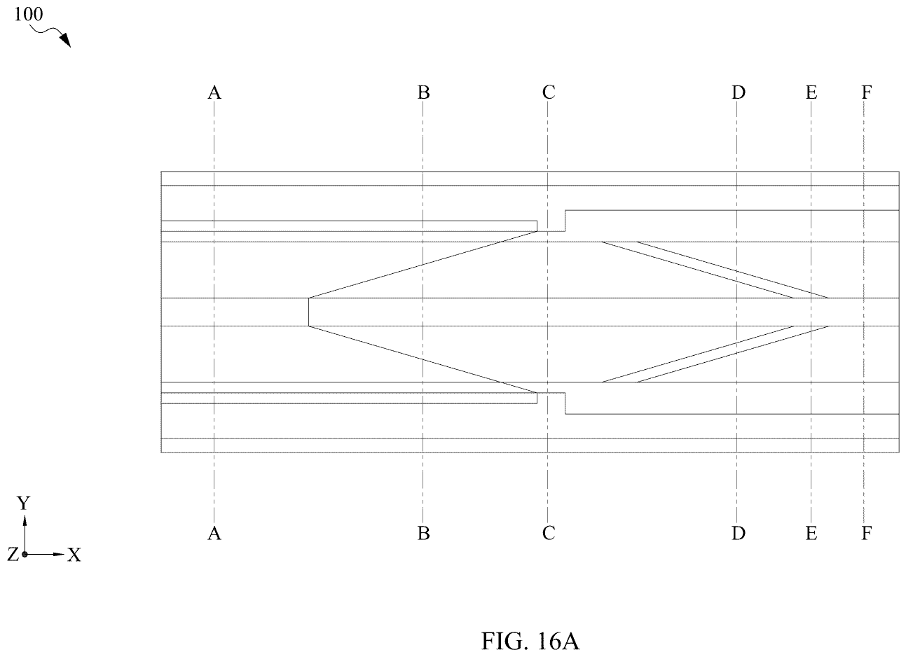

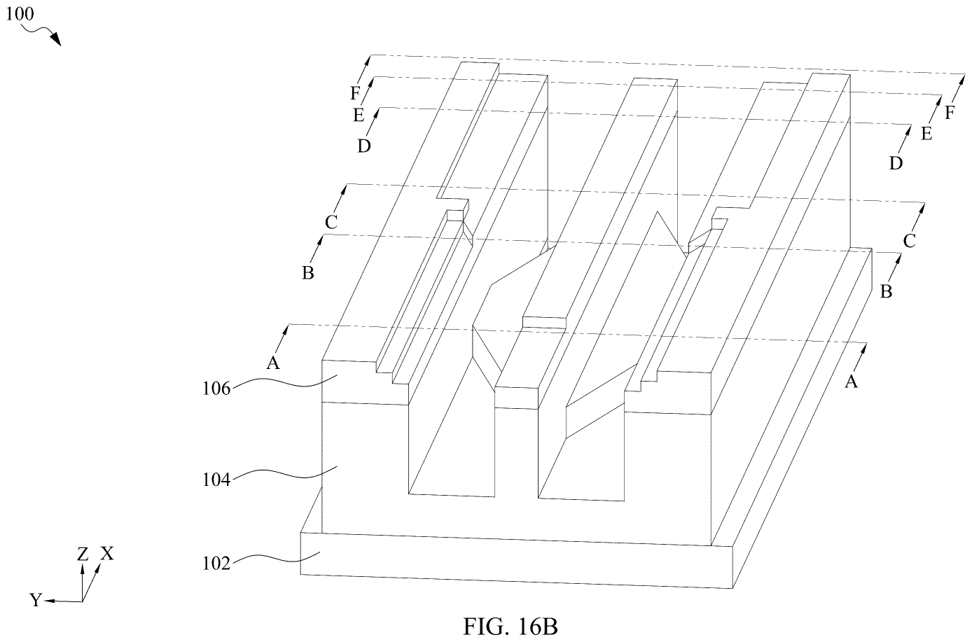

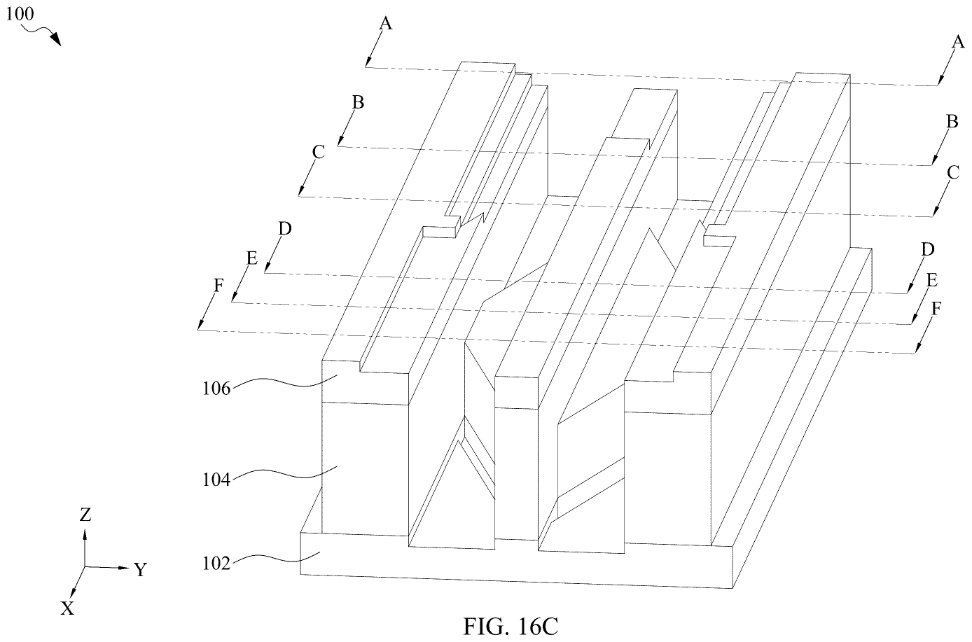

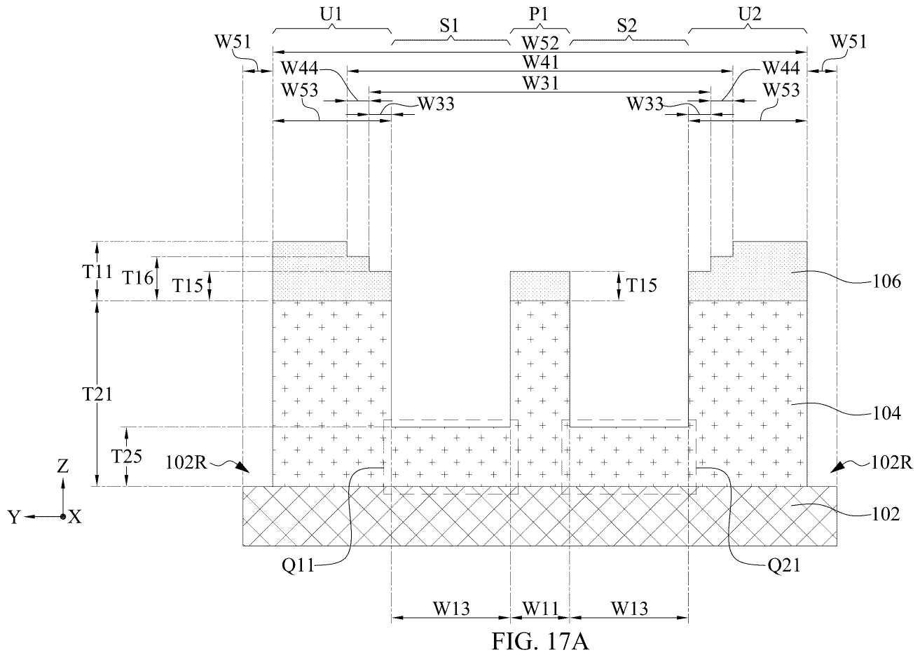

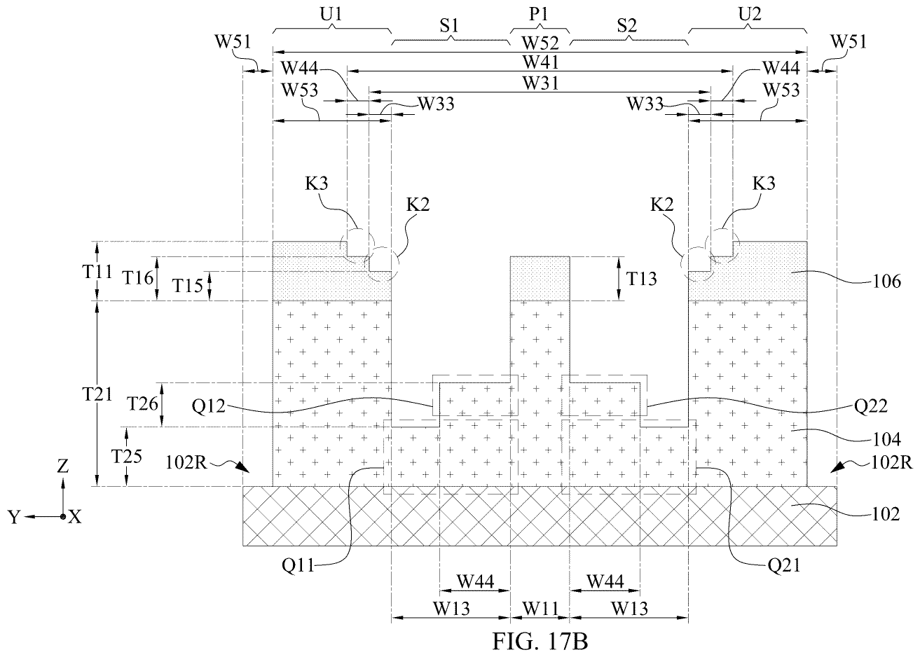

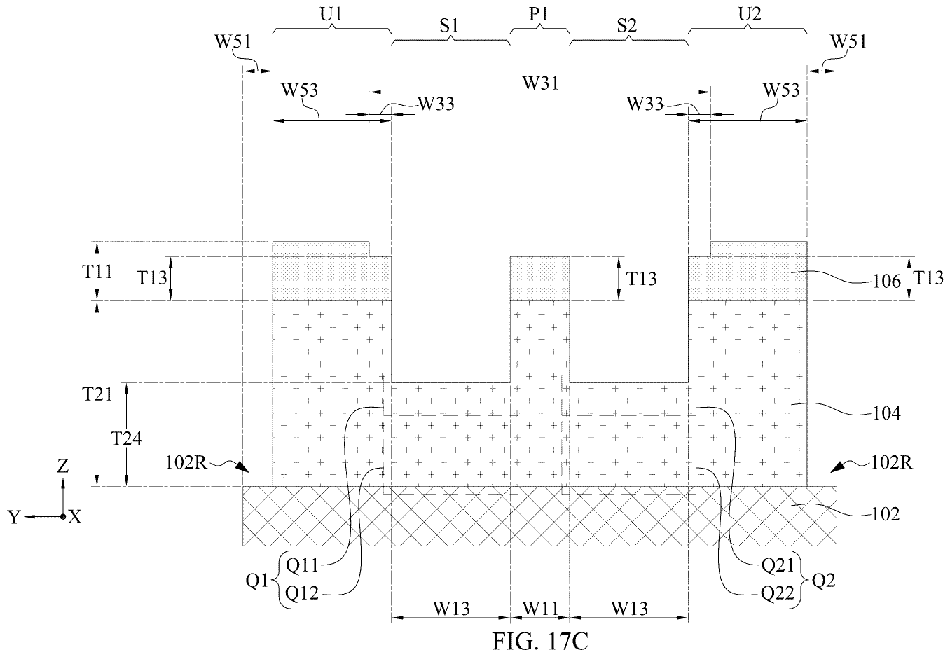

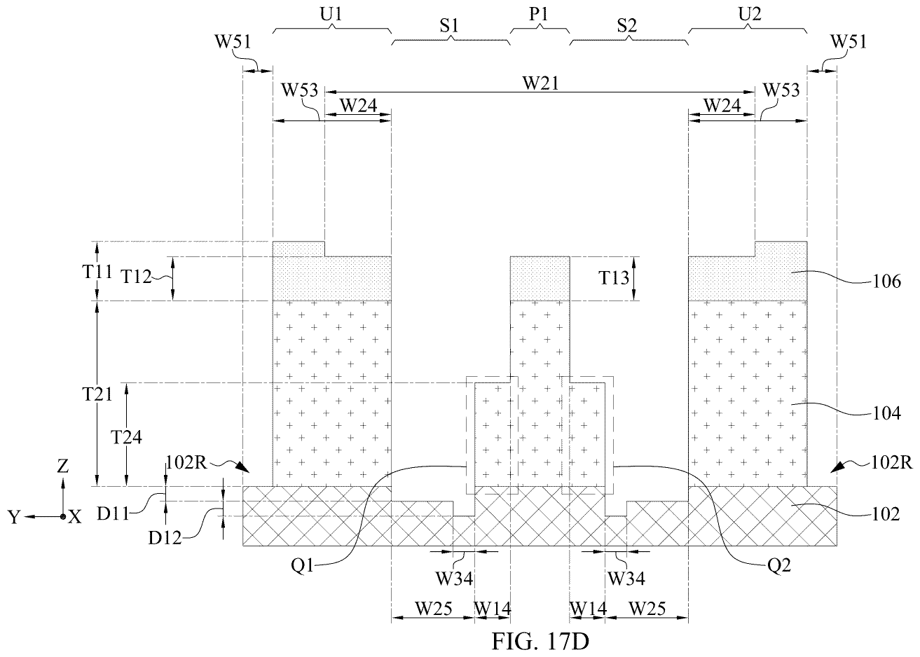

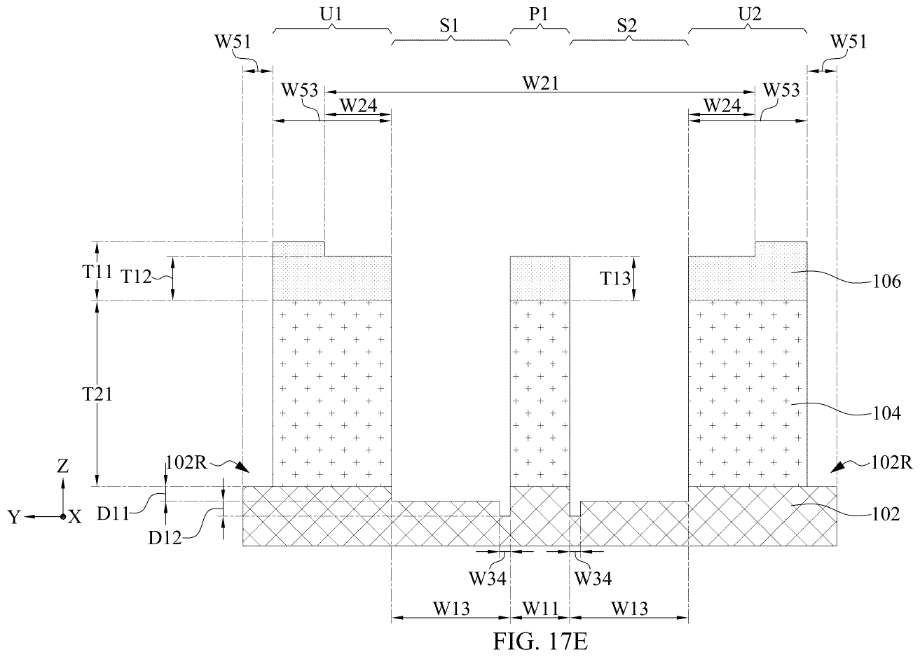

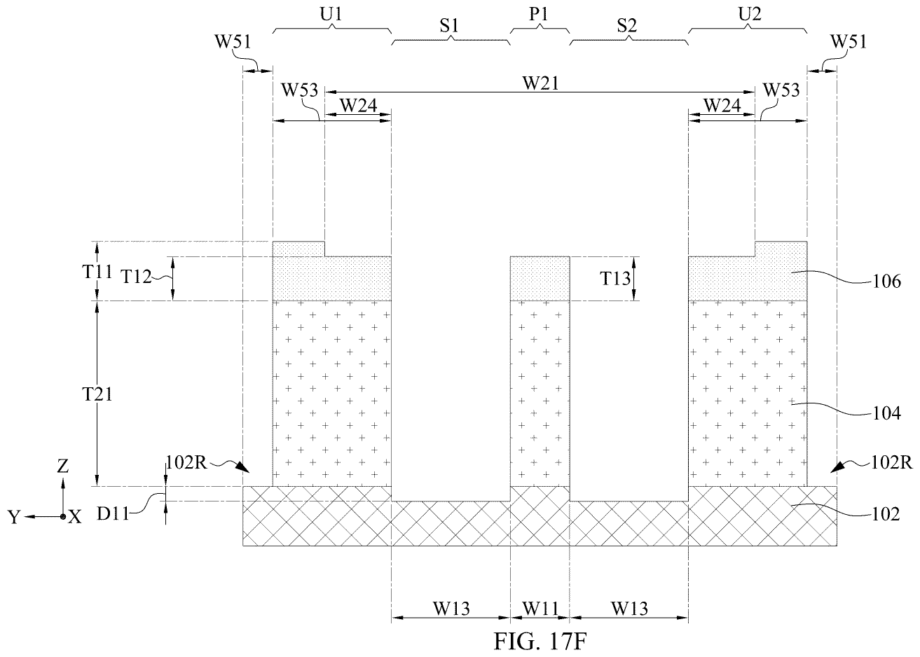

According to some embodiments, a fifth etching operation is performed on the semiconductor waveguide device 100 using the photomask PM5 in a manner similar to that described with reference to FIGS. 2A to 2F. The fifth etching operation may be a dry etch, a wet etch, an RIE, or the like. FIG. 16A is a schematic top view of the semiconductor waveguide device 100 after the first, second, third, fourth and fifth etching operations, in accordance with some embodiments of the present disclosure. FIGS. 16B and 16C are schematic perspective views of the semiconductor waveguide device 100 shown in FIG. 16A, in accordance with some embodiments of the present disclosure. FIGS. 17A, 17B, 17C, 17D, 17E and 17F are schematic cross-sectional views of the semiconductor waveguide device 100 shown in FIG. 16A, in accordance with some embodiments of the present disclosure.

FIG. 15B is a schematic plan view of overlaid photomasks PM1, PM2, PM3, PM4 and PM5, in accordance with some embodiments of the present disclosure. Referring to FIGS. 15B, 16A to 16C and 17A to 17F, since the opening N5 of the photomask PM5 does not extend into the major areas of the semiconductor waveguide device 100 throughout the zones Z1 to Z5 corresponding to the photomasks PM1 through PM4 discussed above, the profiles of the semiconductor waveguide device 100 in the main area along the cross sections AA, BB, CC, DD, EE and FF shown in FIGS. 17A to 17F, respectively, are kept substantially same as the profiles shown in FIGS. 14A to 14F. According to some embodiments, the photomask PM5 is used to form an isolation region surrounding the semiconductor waveguide device 100 across the cross sections AA to FF.

According to some embodiments, the openings N5 of the photomask PM5 cause the fifth etching operation to consume the entire hard mask layer 106 and the entire silicon layer 104 in an outer area of the first support region U1 and the second support region U2. The dielectric layer 102 with a width W41 is exposed through the first support region U1 and the second support region U2. As a result, after the fourth etching operation, the first support region U1 and the second support region U2 include a width W53 measured in the Y-axis direction. One or more recesses 102R are formed during the fifth etching operation. Referring to FIGS. 1A and 16B, according to some embodiments, the width W51 is determined to accommodate a layout of the photonic device area to remove excess areas of the first support region U1 and the second support region U2 to maintain their widths W53 within a predetermined range. In such manner, components of the semiconductor waveguide device 100 may be protected from external interference.

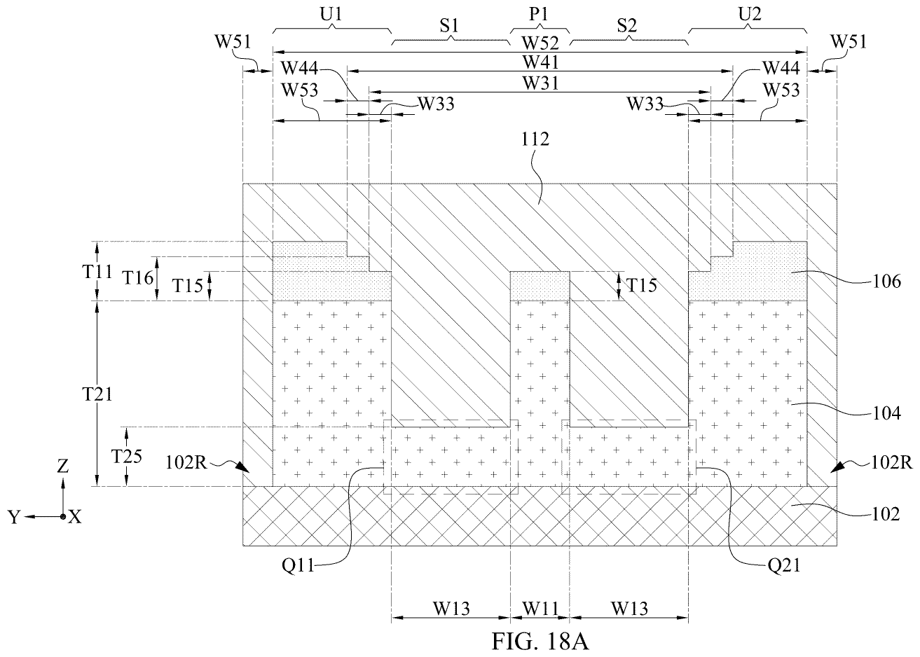

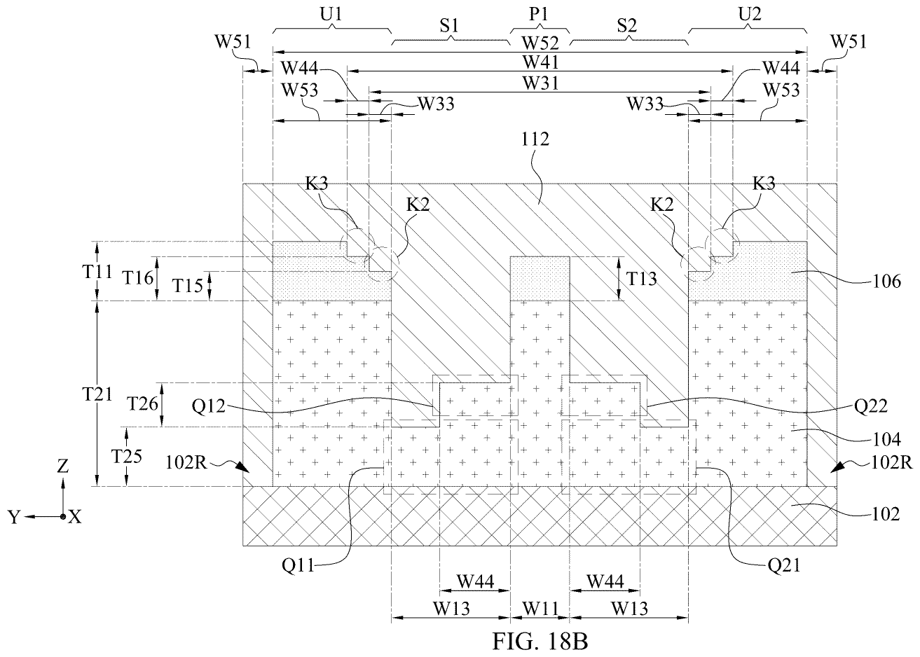

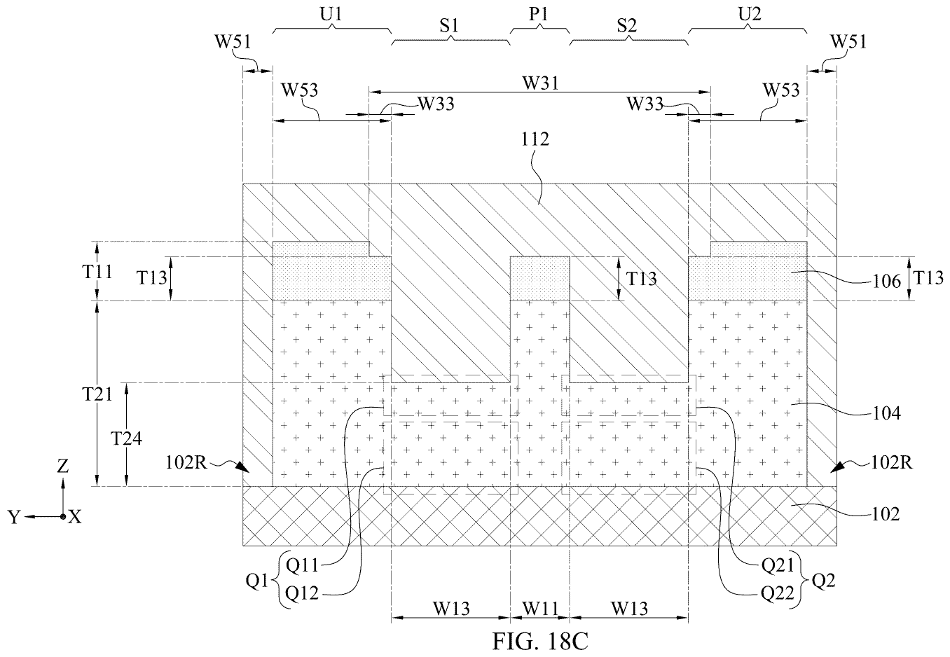

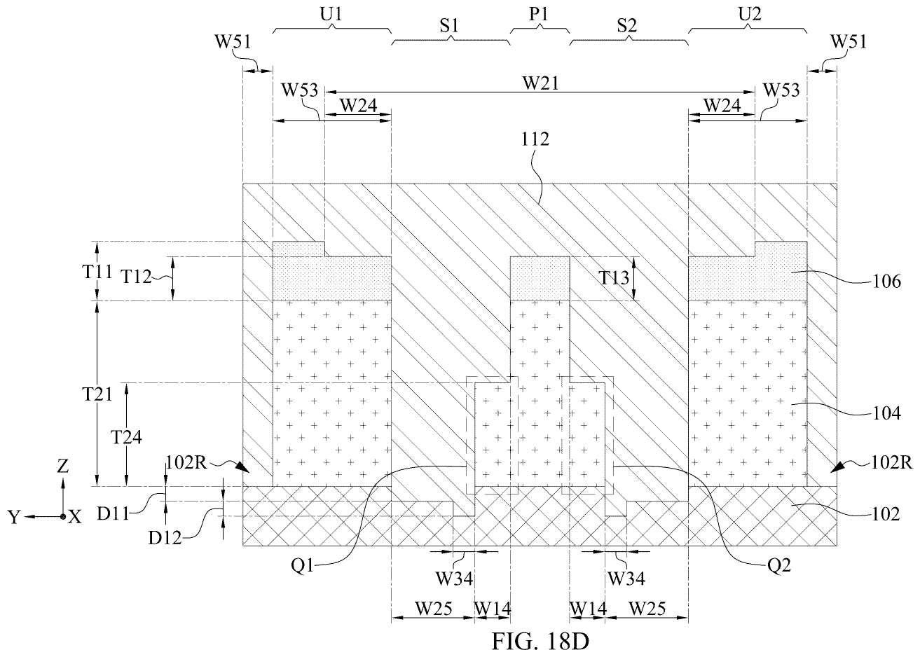

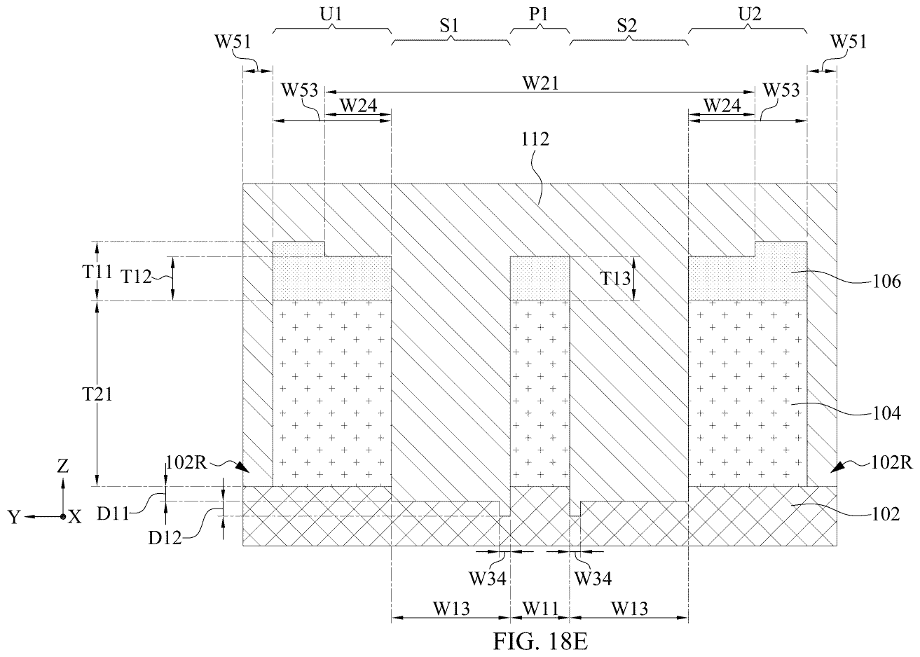

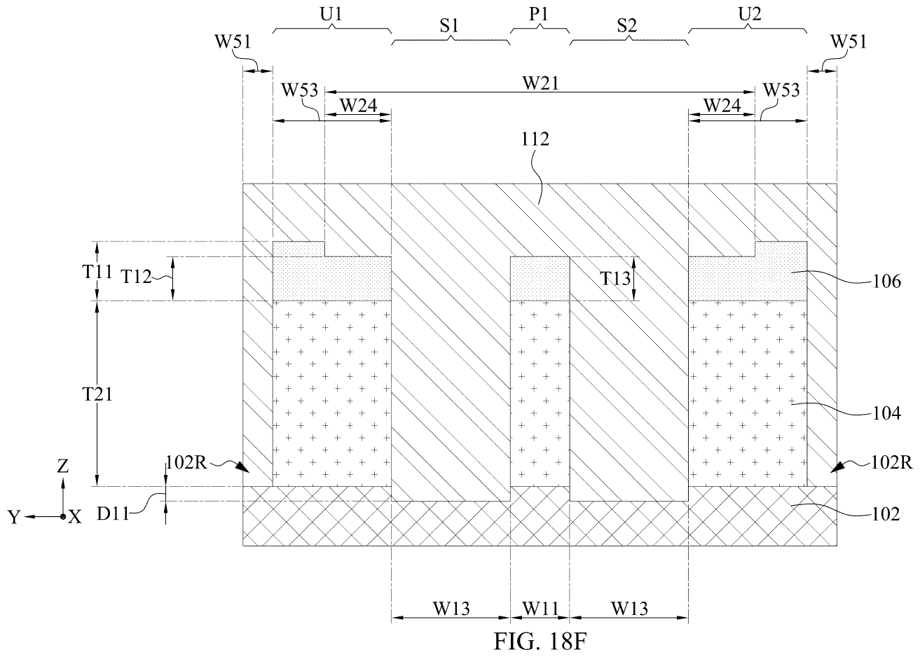

FIGS. 18A, 18B, 18C, 18D, 18E and 18F are schematic cross-sectional views of the semiconductor waveguide device 100, in accordance with some embodiments of the present disclosure. A dielectric layer 116 is deposited over the semiconductor waveguide device 100. The dielectric layer 116 may include silicon oxide or other suitable dielectric materials. The dielectric layer 116 may include a material same as that of the dielectric layer 102. According to some embodiments, the dielectric layer 116 fills the recesses 104R in the first strip region S1 and the second strip region S2. The dielectric layer 116 may be deposited over the protrusion region P1, the first support region U1 and the second support region U2. The dielectric layer 116 may also fill the recesses 102R. According to some embodiments, another dielectric layer (not separately shown) is deposited on the upper surfaces and sidewalls of components of the semiconductor waveguide device 100 in a conformal manner before the deposition of the dielectric layer 116. Such other dielectric layer may be used to improve physical or optical properties of the dielectric layer 116.

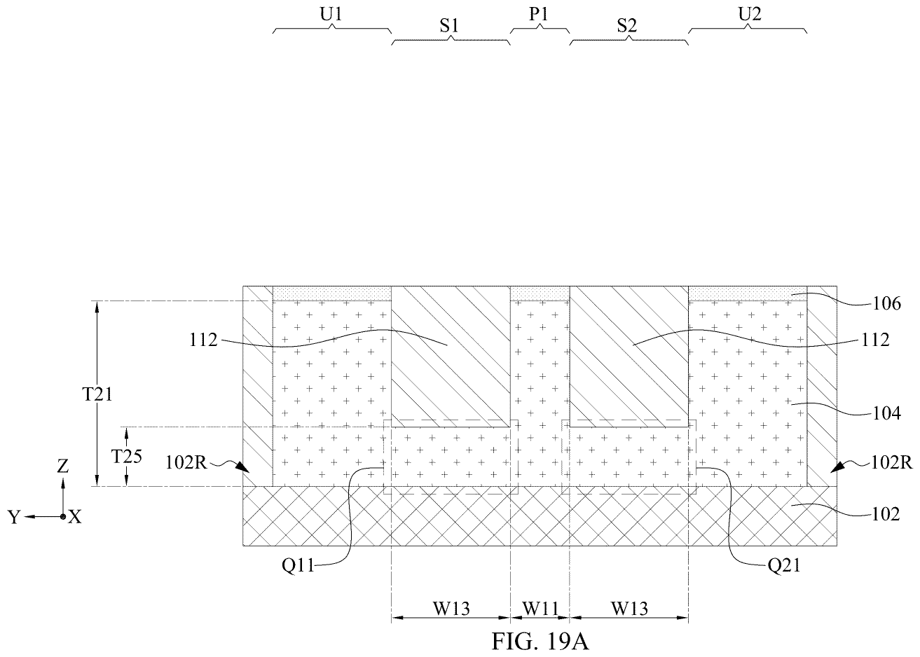

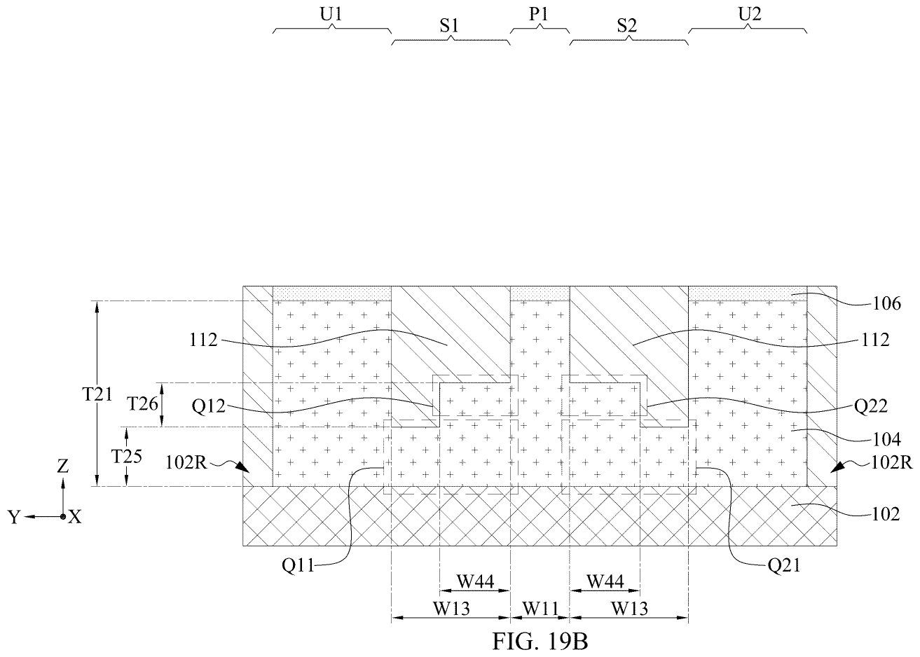

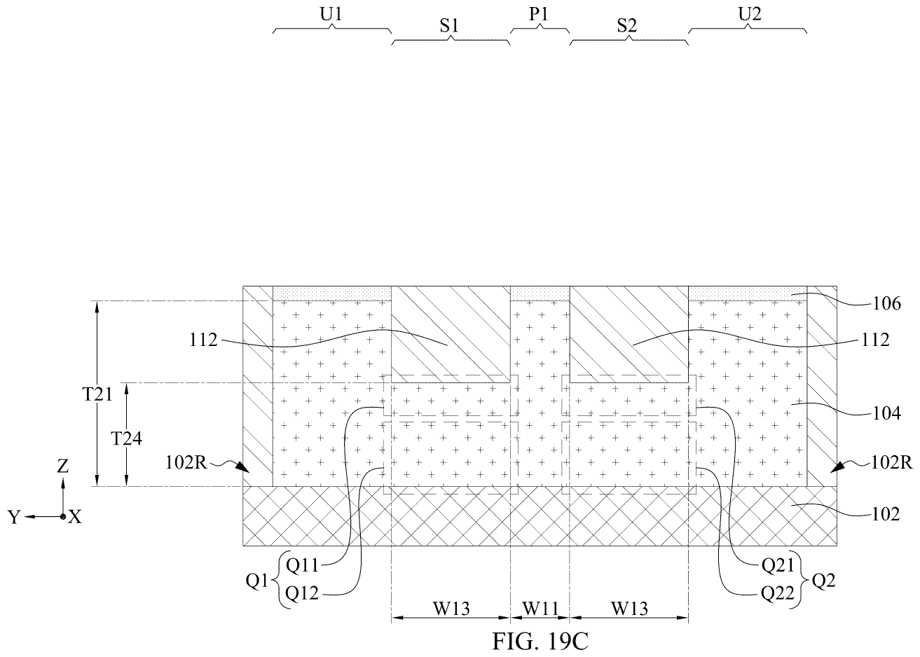

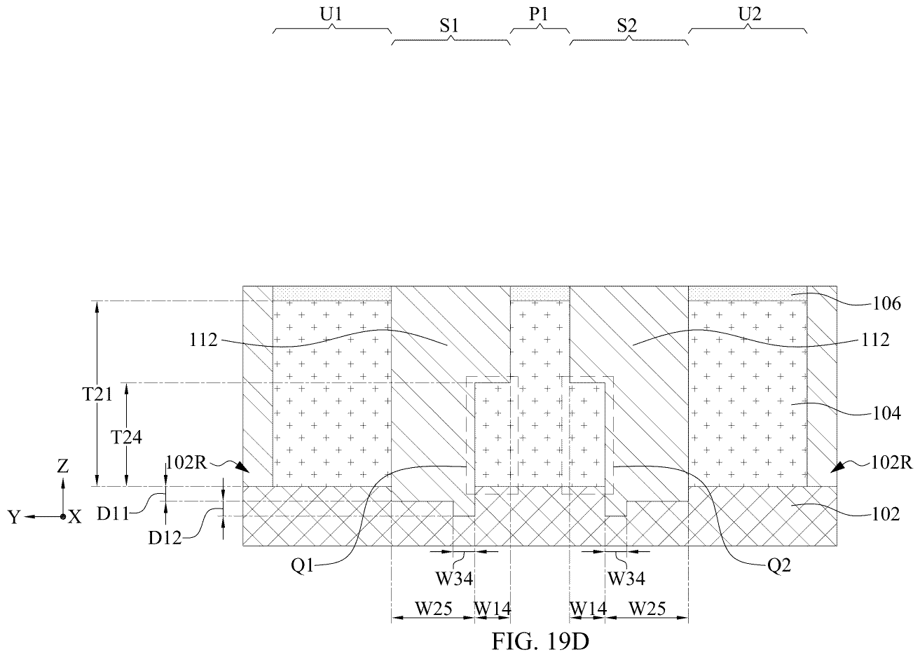

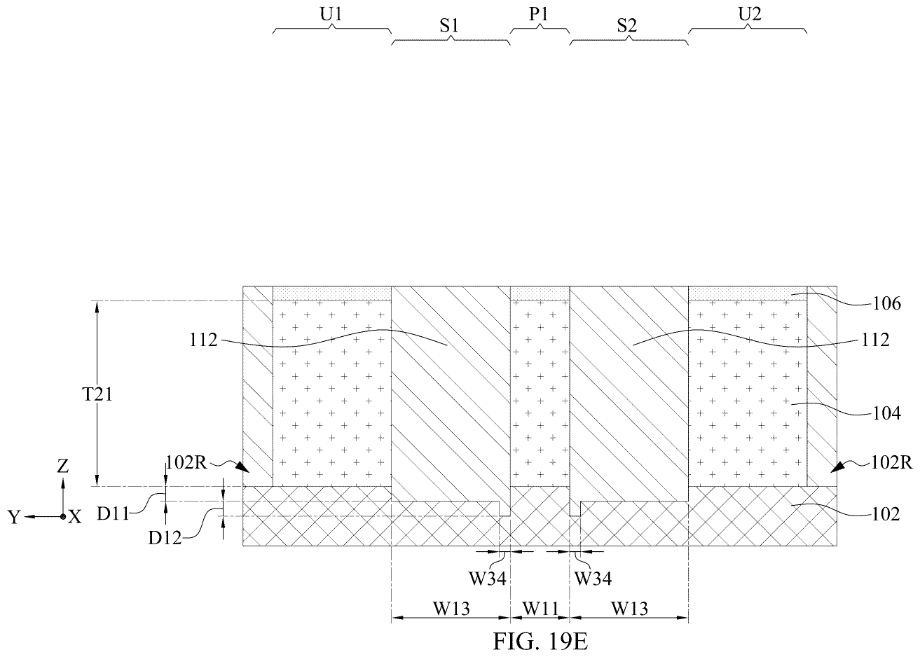

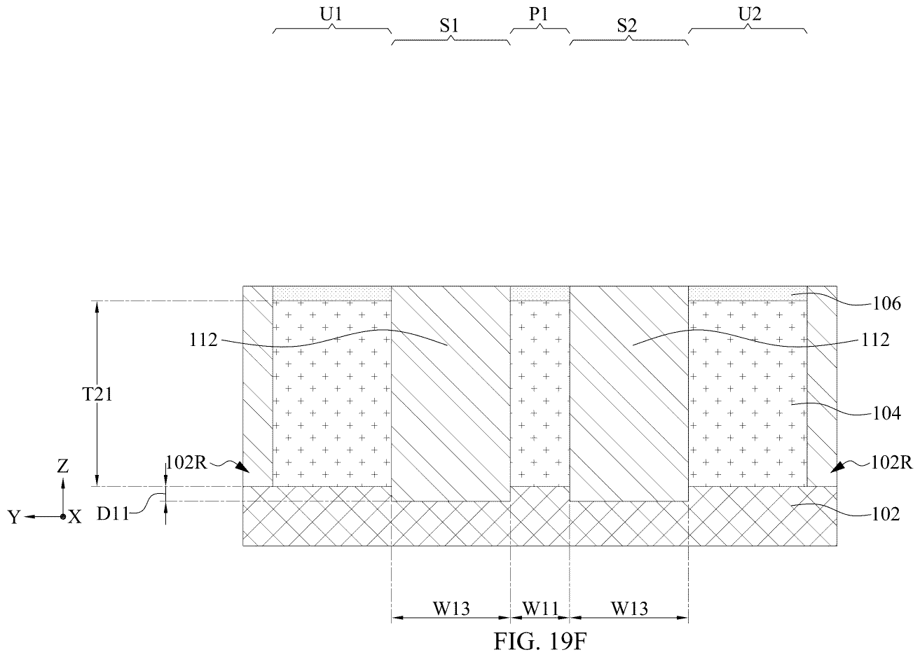

FIGS. 19A, 19B, 19C, 19D, 19E and 19F are schematic cross-sectional views of the semiconductor waveguide device 100, in accordance with some embodiments of the present disclosure. A planarization operation is performed on the semiconductor waveguide device 100. The planarization operation may include mechanical grinding, chemical mechanical planarization (CMP), or another suitable planarization or polishing operation. During the planarization operation, an upper surface of the semiconductor waveguide device 100 is planarized. According to some embodiments, the hard mask layer 106 is used as an etch stop layer of the planarization operation. After the planarization operation is completed, the mask layer 106 on the protrusion region P1 can protect the underlying silicon layer 104 from being damaged. According to some embodiments, the areas of the first support region U1 and the second support region U2 are made sufficiently large to ensure that the overall area of the hard mask layer 106 of the semiconductor waveguide device 100 is able to serve as the etch stop layer. Otherwise, if the areas of the first support region U1 and the second support region U2 are not large enough, the hard mask layer 106 over the protrusion region P1 may not be capable of serving as the etch stop layer of the planarization operation.

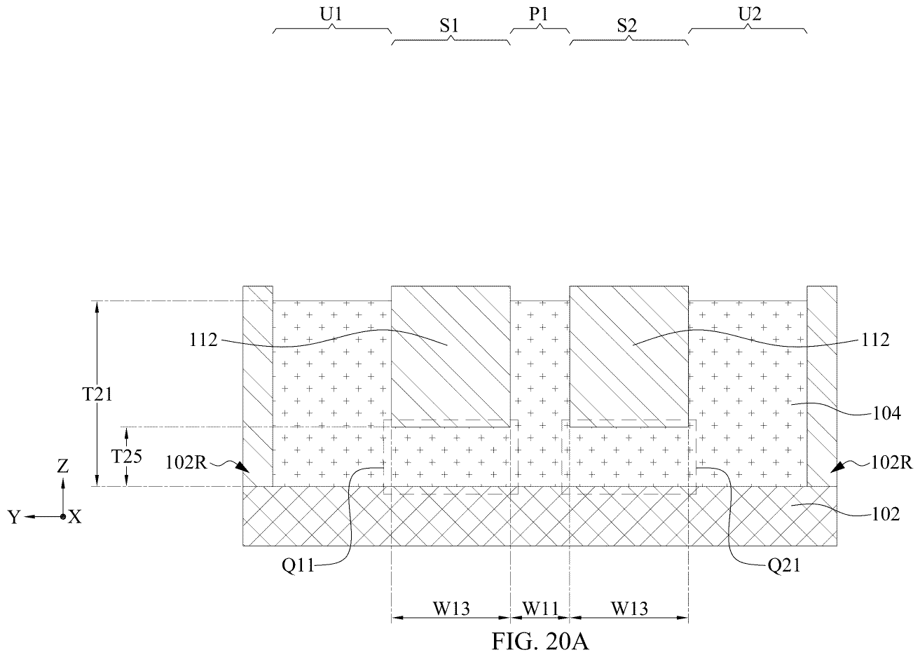

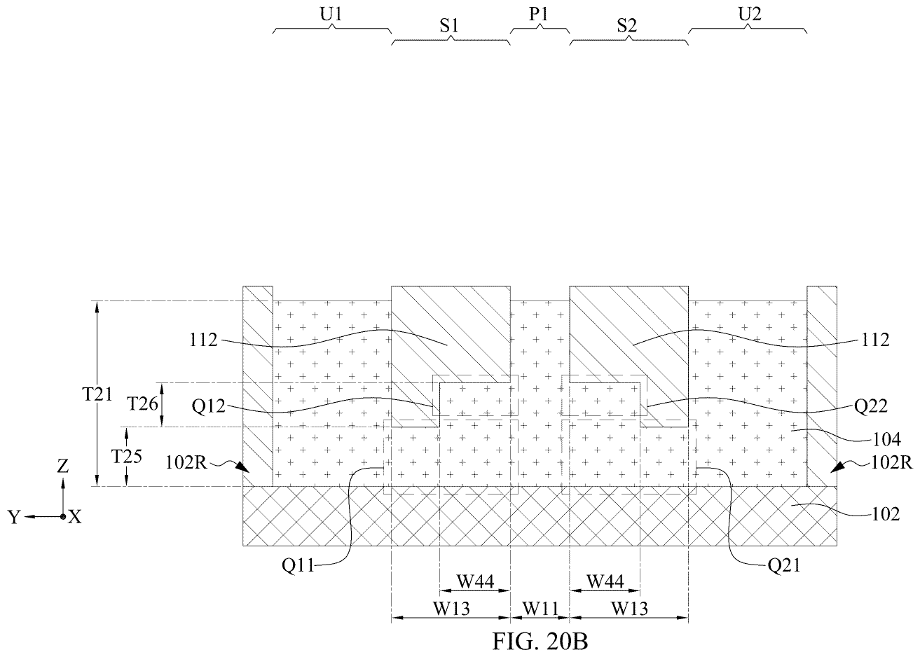

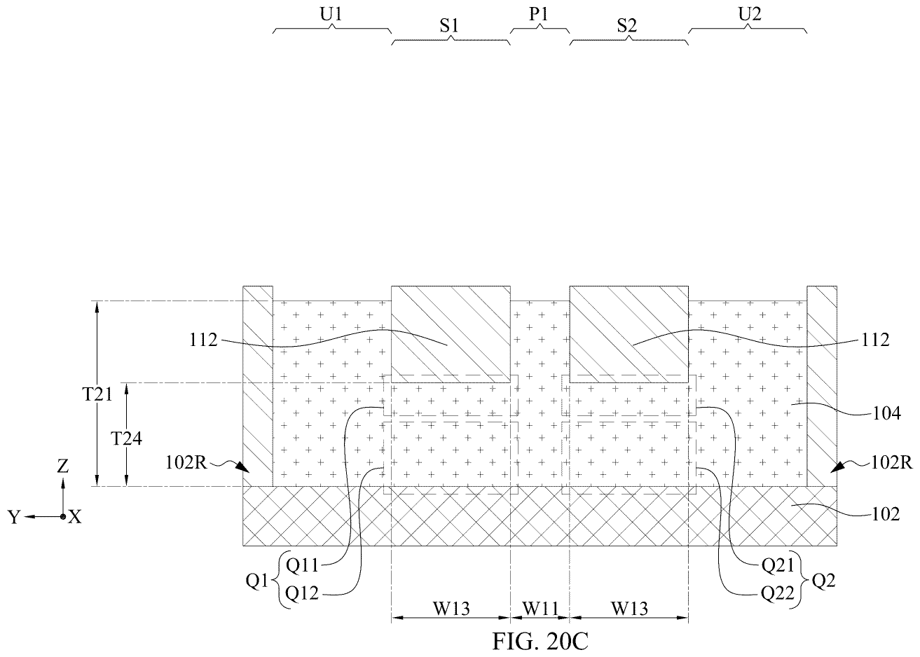

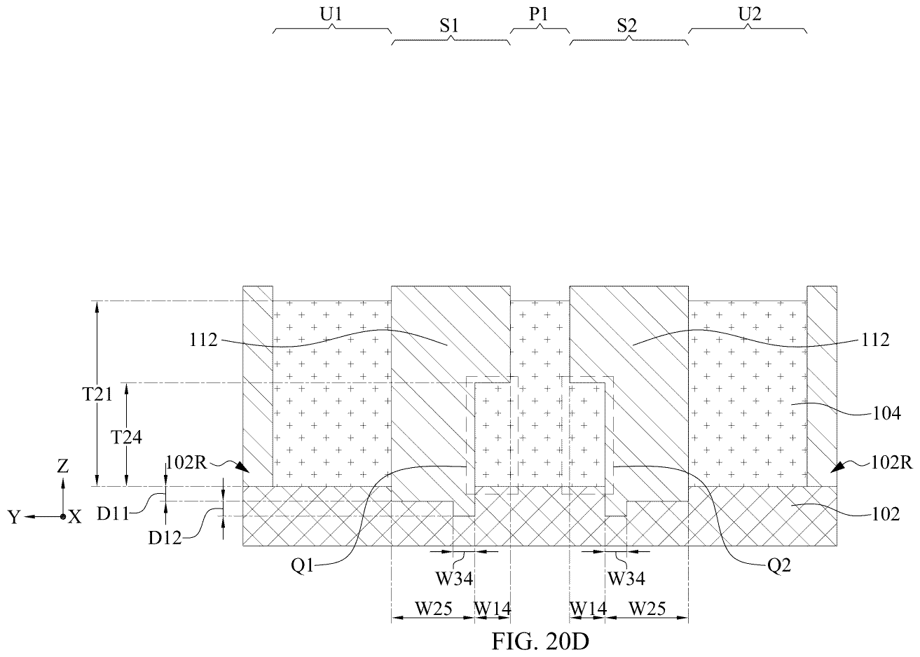

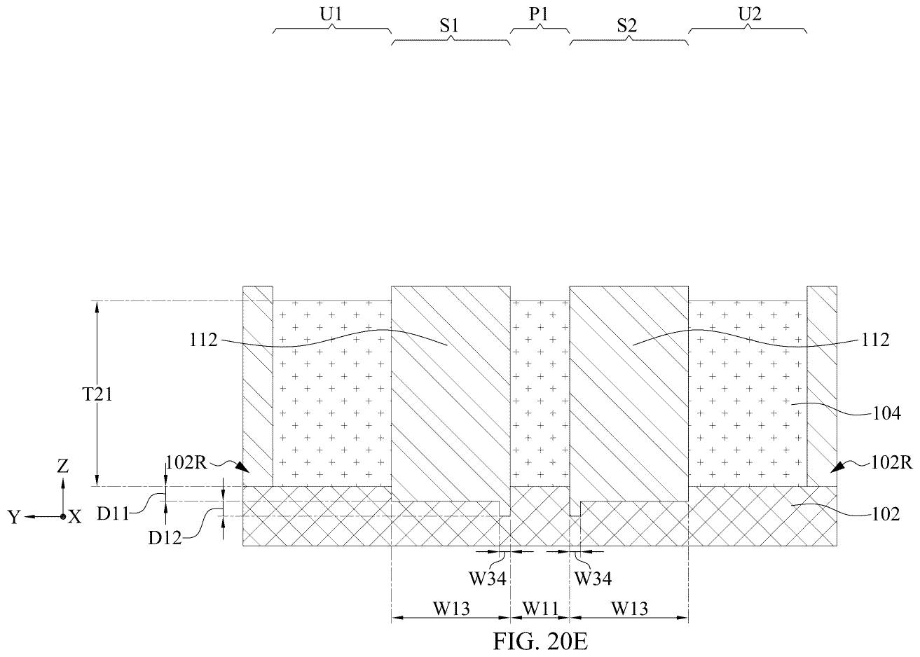

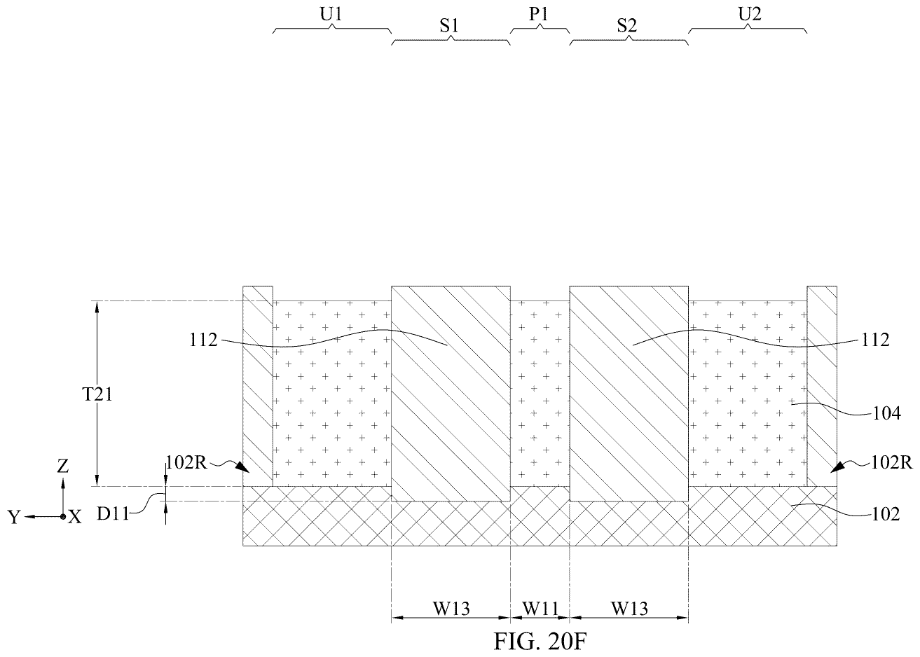

FIGS. 20A, 20B, 20C, 20D, 20E and 20F are schematic cross-sectional views of the semiconductor waveguide device 100, in accordance with some embodiments of the present disclosure. An etching operation is performed to remove a remaining portion of the hard mask layer 106 over the silicon layer. The etching operation may include a wet etch using hydrofluoric acid (HF). After the etching operation, the silicon layer 104 in the protrusion region P1, the first support region U1 and the second support region U2 are exposed. According to some embodiments, another etching operation is performed to reduce a thickness of the dielectric layer 112. Such other etching operation may include a wet etch.

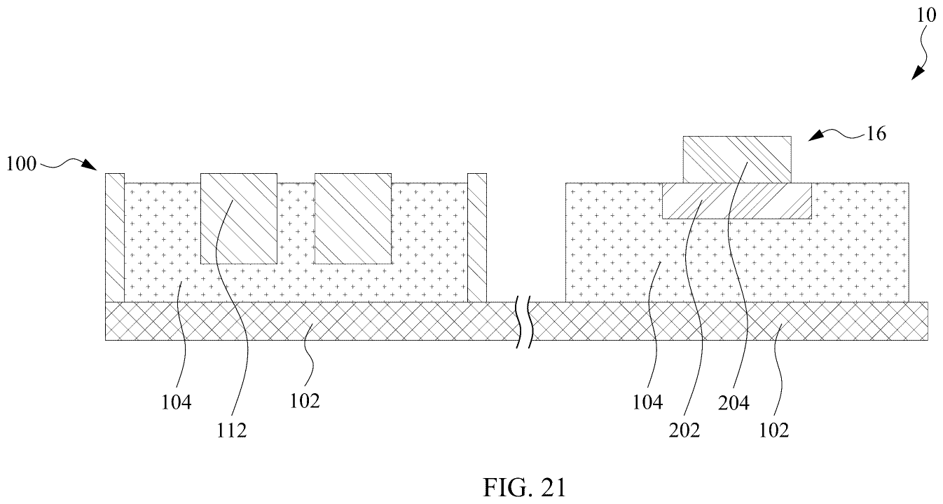

FIG. 21 is a schematic cross-sectional view of the semiconductor device 10, in accordance with some embodiments of the present disclosure. Referring to FIGS. 1A and 21, the semiconductor waveguide device 100 is formed along with other silicon photonic devices, such as the photonic devices 12 and 14, in the photonic device area 10A. According to some embodiments, a plurality of electronic devices, such as the electronic device 16, are formed in the electronic device area 10B. The photonic device area 10A and the electronic device area 10B may share a common substrate 101, such as a common dielectric layer 102, and a common silicon layer 104. According to some embodiments, the electronic device 16 includes at least one transistor, wherein the transistor includes a doped region 202 (e.g., a well region, a source/drain region, etc.) formed in the silicon layer 104 and a conductive region 204 arranged over the doped region 202. According to some embodiments, an upper surface of the silicon layer 104 has a substantially consistent height across the photonic device area 10A and the electronic device area 10B.

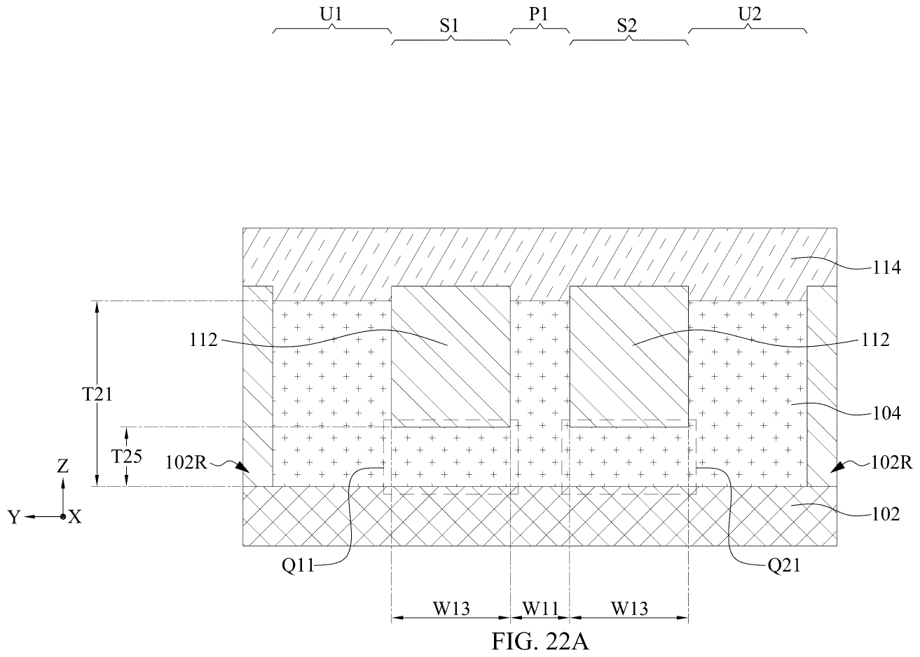

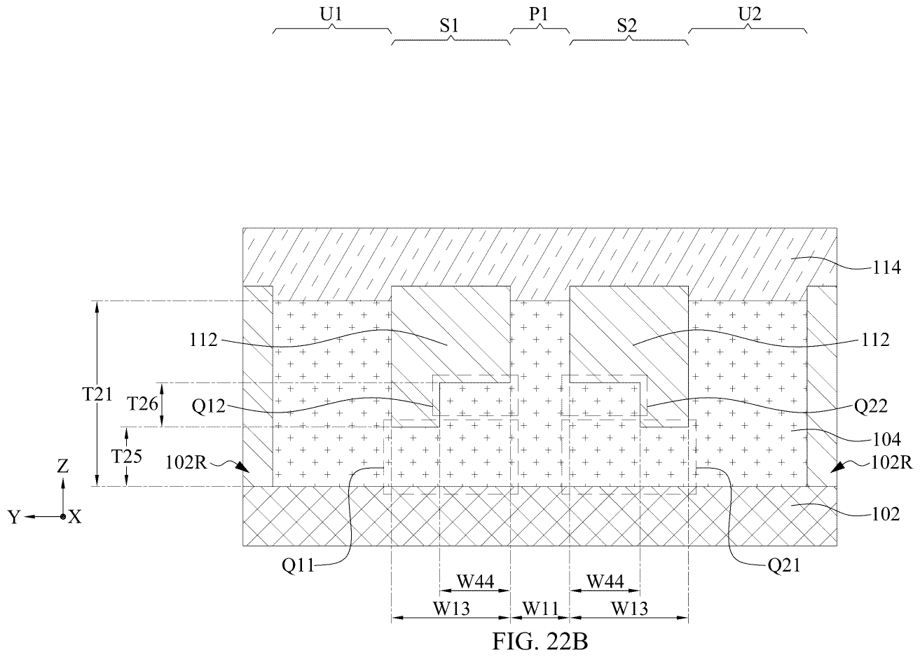

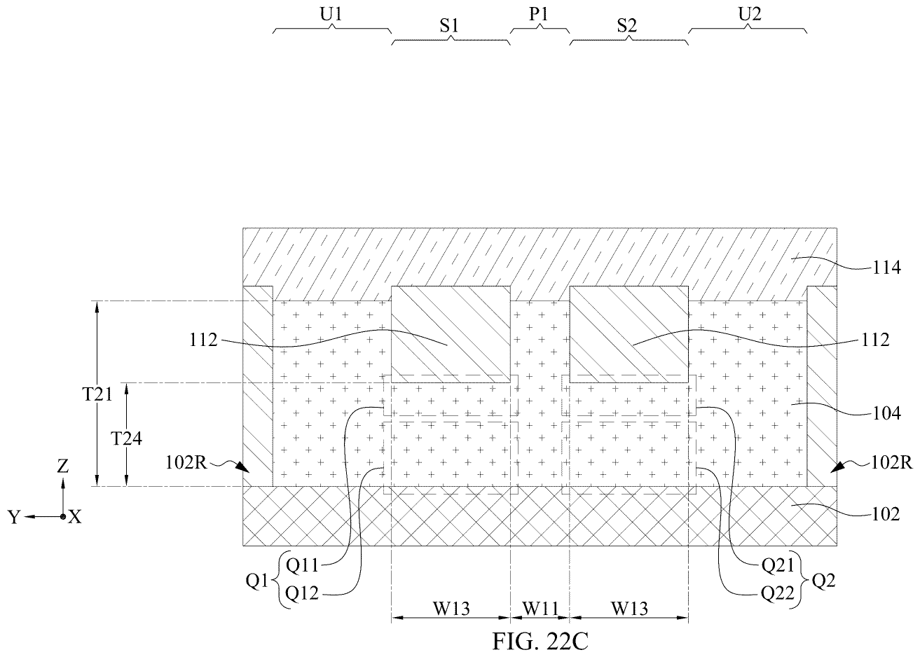

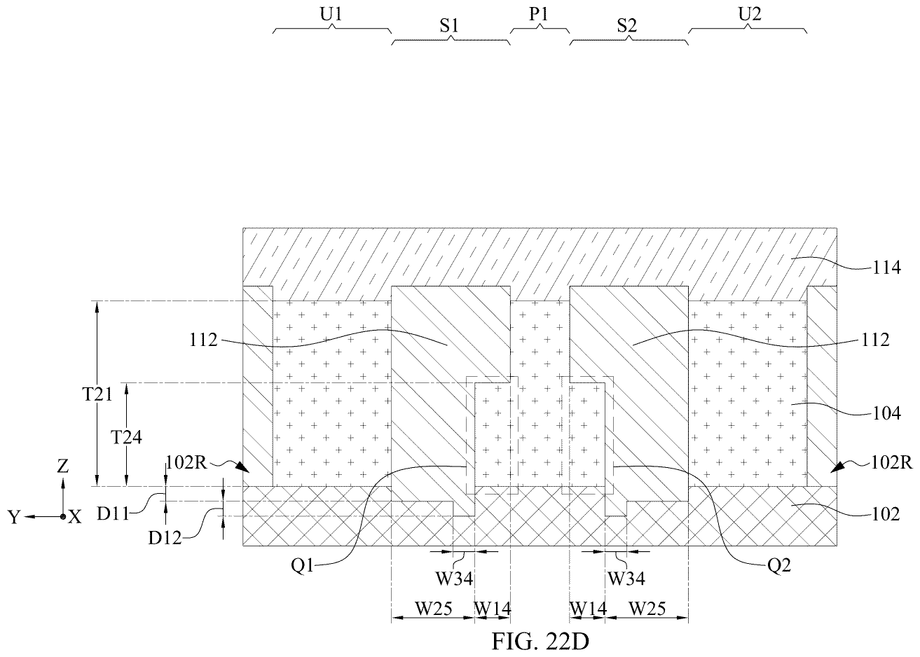

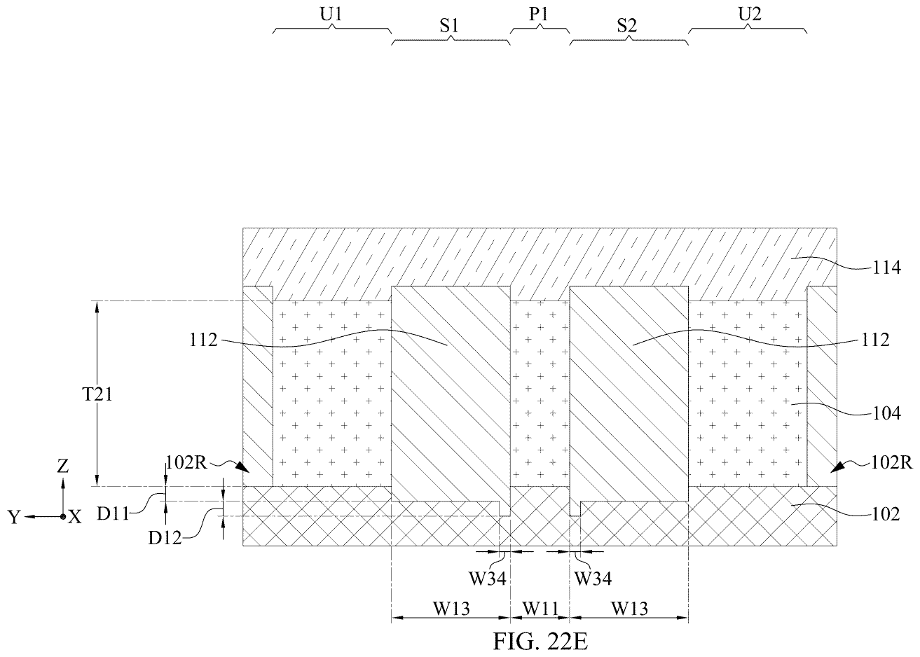

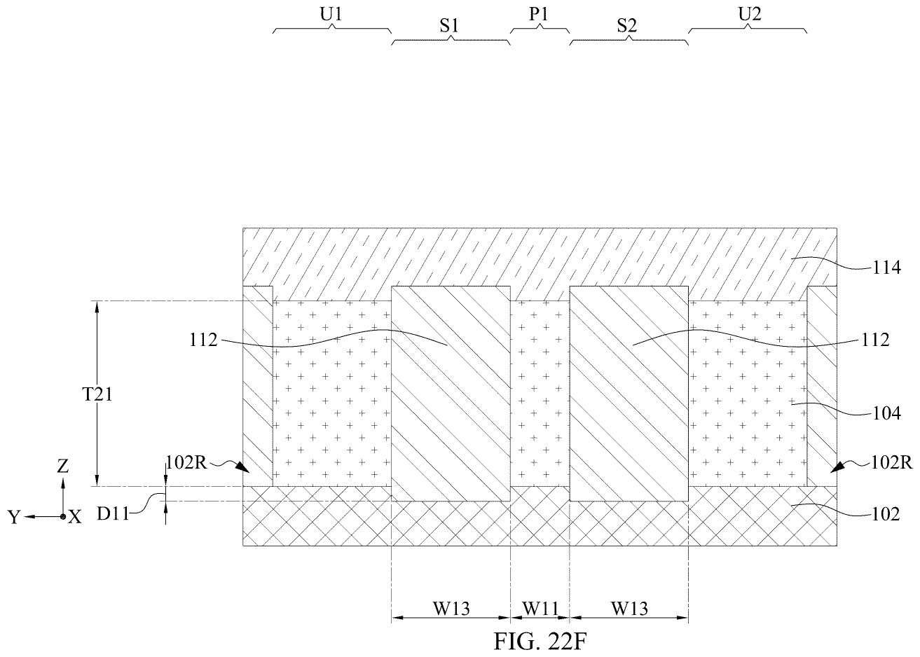

FIGS. 22A, 22B, 22C, 22D, 22E and 22F are schematic cross-sectional views of the semiconductor waveguide device 100, in accordance with some embodiments of the present disclosure. An inter-layer dielectric (ILD) layer 114 is formed over the silicon layer 104 in the photonic device area 10A. The ILD layer 114 may include a dielectric material, such as silicon oxide. The ILD layer 114 may be formed using a deposition operation, followed by a planarization operation.

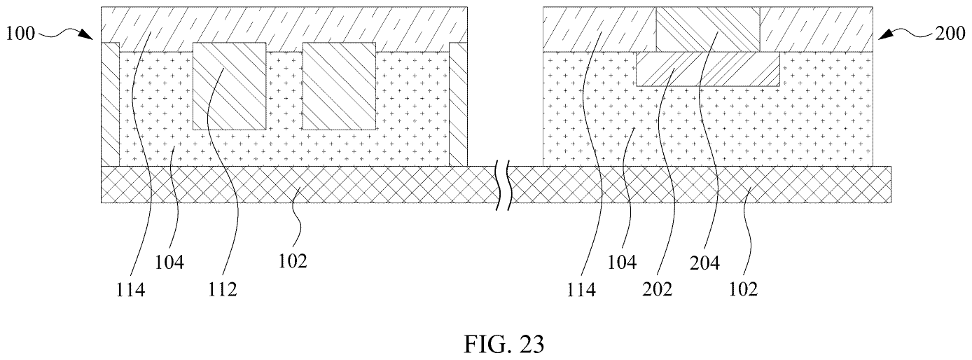

FIG. 23 is a schematic cross-sectional view of the semiconductor device 10, in accordance with some embodiments of the present disclosure. According to some embodiments, the ILD layer 114 is formed over the silicon layer 104 in the electronic device area 10B. The ILD layer 114 may laterally surround a conductive region 204 of the electronic device 16. One or more conductive vias or pads may be formed in the ILD layer 114 to electrically interconnect components of the electronic device 16 or electrically connect components of the electronic device 16 to overlying layers. According to some embodiments, the ILD layer 114 includes substantially equal heights or thicknesses across the photonic device area 10A and the electronic device area 10B.

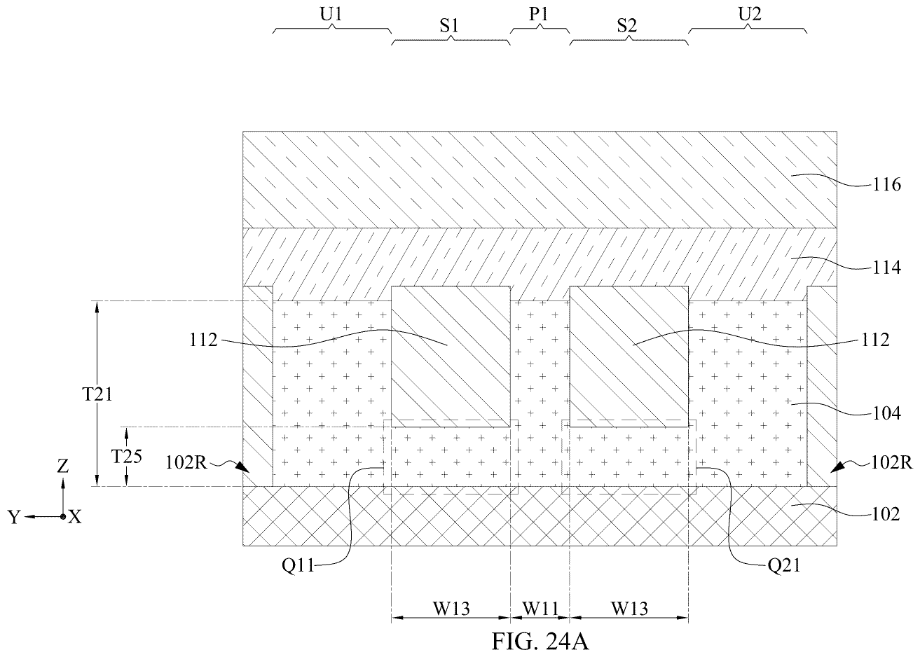

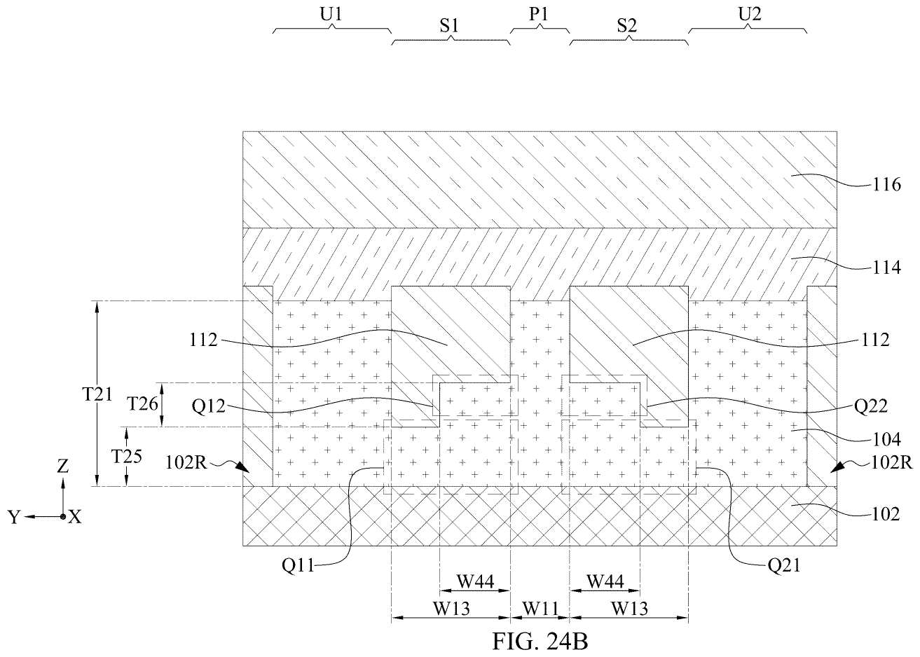

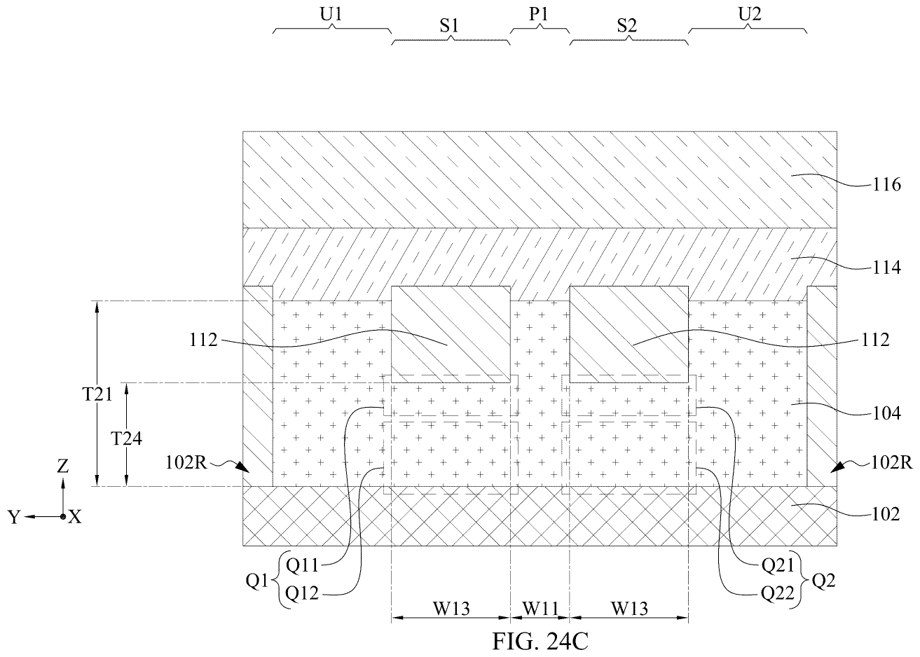

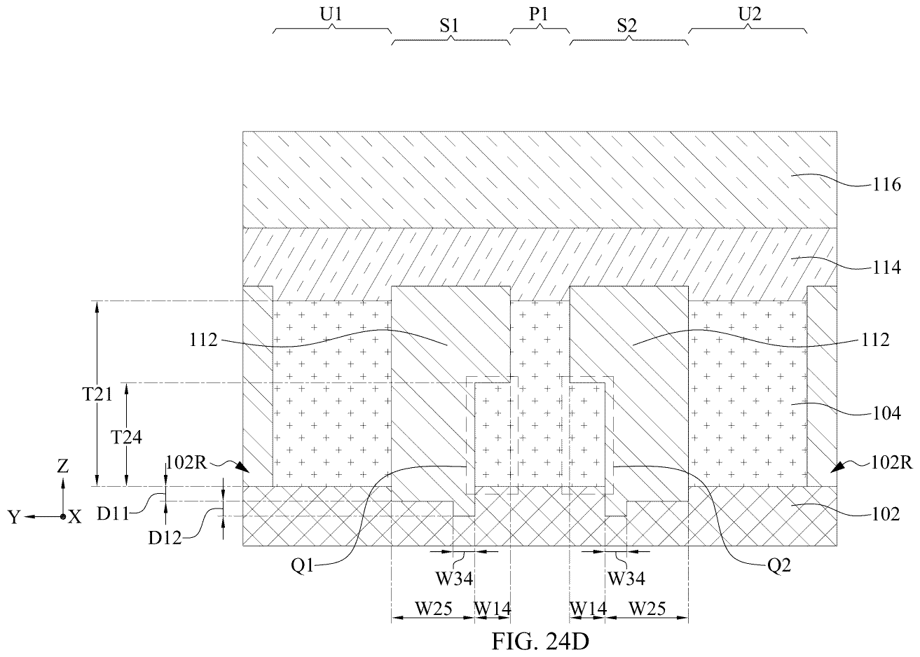

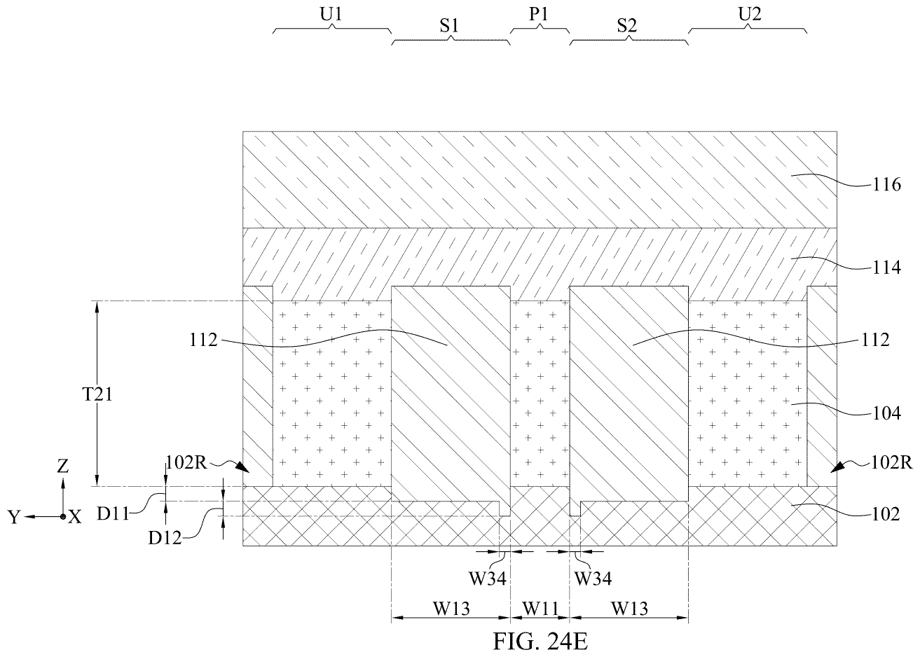

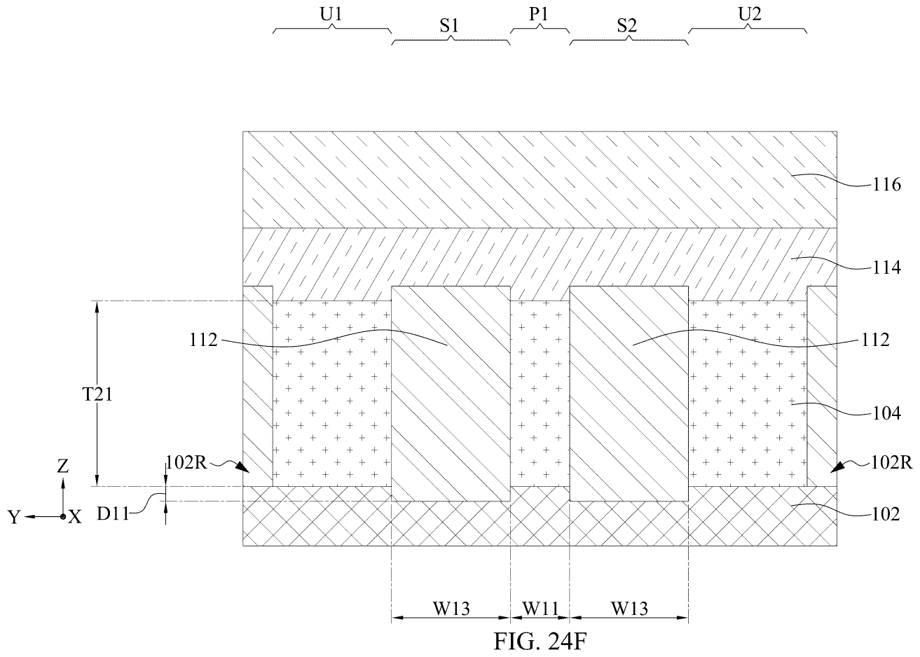

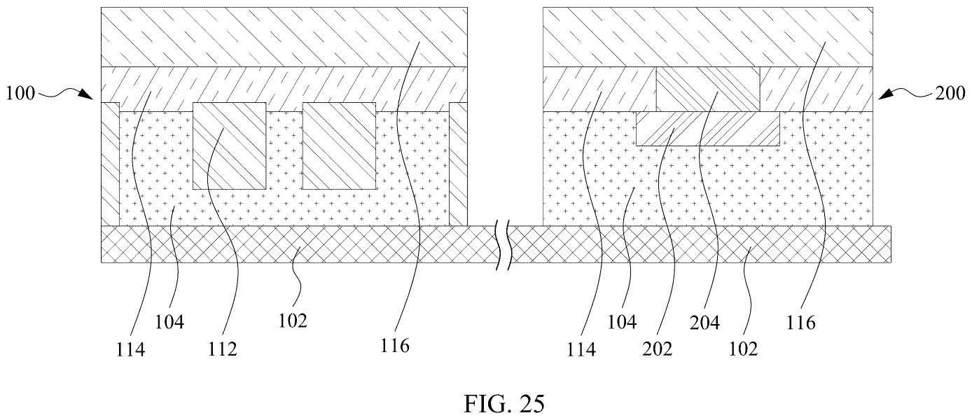

FIGS. 24A, 24B, 24C, 24D, 24E and 24F are schematic cross-sectional views of the semiconductor waveguide device 100, in accordance with some embodiments of the present disclosure. FIG. 25 is a schematic cross-sectional view of the semiconductor device 10, in accordance with some embodiments of the present disclosure. According to some embodiments, an interconnect layer 116 is formed over the ILD layer 114 in the photonic device area 10A and the electronic device area 10B. The interconnect layer 116 may include a plurality of metal line layers and a plurality of metal via layers, wherein metal lines in one metal line layer are electrically connected to metal lines in an adjacent metal line layer through a metal via in a metal via layer between the adjacent metal line layers. The metal lines and the metal vias are interconnected to form routing paths for electronic devices in the electronic device area 10B. Such metal lines may extend in the interconnect layer between different zones of the electronic device area 10B through the photonic device area 10A. According to some embodiments, the interconnect layer 116 further includes an insulation material electrically insulating the metal lines and the metal vias. The insulating material may include silicon oxide, silicon nitride, or other suitable dielectric materials.

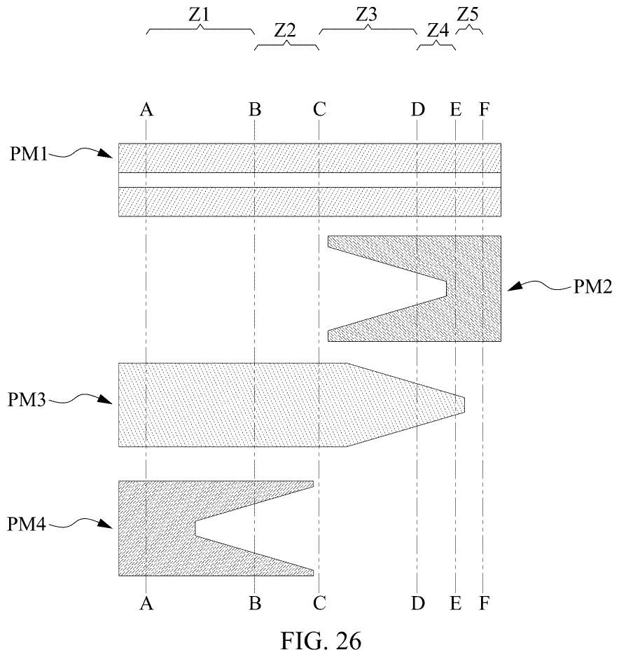

FIG. 26 is a schematic block diagram of photomasks PM1, PM2, PM3 and PM4 arranged in parallel, in accordance with some embodiments of the present disclosure. As discussed above, according to some embodiments, the deep-rib waveguide WG-dR is formed around the cross section AA, the strip waveguide WG-S is formed around the cross section FF, and the rib waveguide WG-R is formed around the cross-section CC. The transitional waveguides are formed in the zone areas between the deep-rib waveguide WG-dR and the rib waveguide WG-R and between the rib waveguide WG-R and the strip waveguide WG-S. Therefore, the proposed semiconductor waveguide device 100 includes a tri-waveguide structure with the rib waveguide WG-R disposed between the deep-rib waveguide WG-dR and the strip waveguide WG-S. Further, it can be seen from FIG. 26 that amounts of overall etching operations performed in each zone or each cross section are similar to one another. In other words, due to careful design of layouts of the photomasks PM1, PM2, PM3 and PM4, exposed areas in each of the four etching operations are carefully calculated, and thus any area of the semiconductor waveguide device 100 is subjected to about three times an amount of etching performed during the first, second, third and fourth etching operations. An area around the cross section FF used for forming a new photonic component having the strip waveguide WG-S can also be controlled to receive an amount of etching substantially equal to an amount of etching performed on an area around the cross section AA used for forming the existing photonic component having the deep-rib waveguide WG-dR. Thus, the manufacturing parameters of the hard mask layer 106 do not need to be redesigned, and manufacturing cost and time can be saved accordingly.

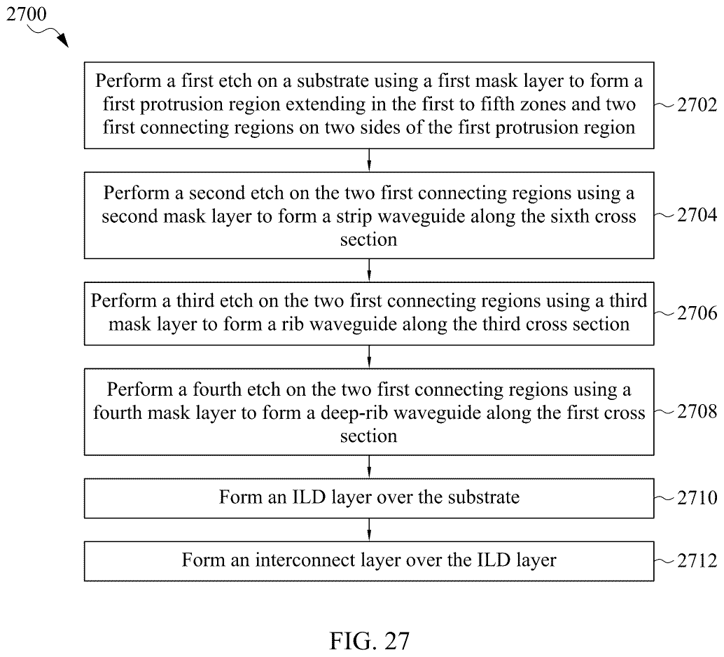

FIG. 27 shows a flowchart of a method 2700 of manufacturing a semiconductor waveguide device, in accordance with some embodiments of the present disclosure. It should be understood that additional steps can be provided before, during, and after the steps in the method 2700, and some of the steps described below can be replaced with other embodiments or eliminated altogether. An order of the steps shown in FIG. 27 may be interchangeable. Some of the steps may be performed concurrently or independently.

In step 2702, a first etch is performed on a substrate using a first mask layer to form a first protrusion region extending from the first to fifth zones and two first connecting regions on two sides of the first protrusion region. According to some embodiments, the substrate includes first, second, third, fourth, fifth and sixth cross sections arranged in sequence to define first, second, third, fourth and fifth zones along a first direction. According to some embodiments, the first mask layer exposes a first strip region and a second strip region of the substrate extending in the first direction, and the first mask layer covers a central region of the substrate between the first and second strip regions.

In step 2704, a second etch is performed on the two first connecting regions using a second mask layer to form a strip waveguide along the sixth cross section. According to some embodiments, the second mask layer exposes a first portion in the first and second strip regions and the central region in the fifth zone, and exposes a second portion extending from the first portion and tapering from the fifth zone to the third zone in the first and second strip regions.

In step 2706, a third etch is performed on the two first connecting regions using a third mask layer to form a rib waveguide along the third cross section. According to some embodiments, the third mask layer exposes a third portion in the first and second strip regions and the central region in the first, second and third zones, and exposes a fourth portion extending from the third portion and tapering from the third zone to the fifth zone.

In step 2708, a fourth etch is performed on the two first connecting regions using a fourth mask layer to form a deep-rib waveguide along the first cross section. According to some embodiments, the fourth mask layer exposes a fifth portion in the first and second strip regions and the central region in the first zone, and exposes a sixth portion extending from the fifth portion and tapering from the first zone to the second zone in the first and second strip regions.

In step 2710, an ILD layer is formed over the substrate.

In step 2712, an interconnect layer is formed over the ILD layer.

According to an embodiment, a method includes performing a first etch on a substrate, wherein the substrate includes a first cross section, a second cross section, a third cross section, a fourth cross section, a fifth cross section and a sixth cross section arranged in sequence to define a first zone, a second zone, a third zone, a fourth zone and a fifth zone along a first direction, wherein the first etch forms a first protrusion region extending from the first to fifth zones and two first connecting regions on two sides of the first protrusion region; performing a second etch on the two first connecting regions to form a strip waveguide along the sixth cross section; performing a third etch on the two first connecting regions to form a rib waveguide along the third cross section; and performing a fourth etch on the two first connecting regions to form a deep-rib waveguide along the first cross section.

According to an embodiment, a method includes performing a first etch on a substrate using a first mask layer, wherein the substrate includes a first cross section, a second cross section, a third cross section, a fourth cross section, a fifth cross section and a sixth cross section arranged in sequence to define a first zone, a second zone, a third zone, a fourth zone and a fifth zone along a first direction, wherein the first mask layer exposes a first strip region and a second strip region of the substrate extending in the first direction, and the first mask layer covers a central region of the substrate between the first and second strip regions; performing a second etch on the substrate using a second mask layer, wherein the second mask layer exposes a first portion in the first and second strip regions and the central region in the fifth zone, and exposes a second portion extending from the first portion and tapering from the fifth zone to the third zone in the first and second strip regions; performing a third etch on the substrate using a third mask layer, wherein the third mask layer exposes a third portion in the first and second strip regions and the central region in the first and second zones, and exposes a fourth portion extending from the third portion and tapering from the third zone to the fifth zone; and performing a fourth etch on the substrate using a fourth mask layer, wherein the fourth mask layer exposes a fifth portion in the first and second strip regions and the central region in the first zone, and exposes a sixth portion extending from the fifth portion and tapering from the first zone to the second zone in the first and second strip regions.

According to an embodiment, a semiconductor waveguide device includes a substrate including a first zone, a second zone, a third zone, a fourth zone and a fifth zone arranged in sequence in a first direction. The substrate includes a first protrusion region extending in the first direction from the first zone to the fifth zone, the first protrusion region having a first thickness; two first connecting regions extending in the first direction in the first zone and the second zone, and connected to two sides of the first protrusion region from a bottom of the first protrusion region, wherein each of the first connecting regions includes a base portion having a second thickness less than the first thickness and a wing portion over the base portion, the wing portion tapering from the second zone to the first zone from a top-view perspective; and two second connecting regions extending in the first direction and connected to the first protrusion region from the bottom of the first protrusion region in the third and fourth zones, wherein each of the second connecting regions tapers from the third zone to the fourth zone from a top-view perspective.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
performing a first etch on a substrate, wherein the substrate comprises a first cross section, a second cross section, a third cross section, a fourth cross section, a fifth cross section and a sixth cross section arranged in sequence to define a first zone, a second zone, a third zone, a fourth zone and a fifth zone along a first direction, wherein the first etch forms a first protrusion region extending in the first to fifth zones and two first connecting regions on two sides of the first protrusion region;
performing a second etch on the two first connecting regions to form a strip waveguide along the sixth cross section;
performing a third etch on the two first connecting regions to form a rib waveguide along the third cross section; and
performing a fourth etch on the two first connecting regions to form a deep-rib waveguide along the first cross section.

2. The method according to claim 1, wherein the substrate comprises a dielectric layer, a silicon layer over the dielectric layer and a hard mask layer over the silicon layer.

3. The method according to claim 2, wherein the rib waveguide comprises the first protrusion region and two second connecting regions connected to the first protrusion region, wherein the two second connecting regions have a first thickness.

4. The method according to claim 3, wherein the deep-rib waveguide comprises the first protrusion region and two third connecting regions connected to the first protrusion region, wherein the two third connecting regions have a second thickness less than the first thickness.

5. The method according to claim 4, wherein after the first, third and fourth etches, the silicon layer comprises a first transitional waveguide between the deep-rib waveguide and the rib waveguide, wherein the first transitional waveguide comprises the first protrusion region and two fourth connecting regions connected to the first protrusion region, wherein each of the fourth connecting regions includes a base portion having the second thickness and a first wing portion over the base portion.

6. The method according to claim 5, wherein the first wing portion tapers from the rib waveguide to the deep-rib waveguide from a top-view perspective.

7. The method according to claim 2, wherein the strip waveguide comprises the first protrusion region and has a substantially equal width from a bottom to a top of the strip waveguide.

8. The method according to claim 7, wherein after the first, second and third etches, the silicon layer includes a second transitional waveguide between the rib waveguide and the strip waveguide, wherein the second transitional waveguide comprises the first protrusion region and two fifth connecting regions connected to the first protrusion region, wherein each of the fifth connecting regions tapers from the rib waveguide to the strip waveguide.

9. The method according to claim 2, wherein the second etch causes a first recess of a first depth in the dielectric layer in the third, fourth and fifth zones.

10. The method according to claim 9, wherein the third etch causes a portion of the first recess to be etched to a second depth in the dielectric layer in the third and fourth zones.

11. A method comprising:
performing a first etch on a substrate using a first mask layer, wherein the substrate comprises a first cross section, a second cross section, a third cross section, a fourth cross section, a fifth cross section and a sixth cross section arranged in sequence to define a first zone, a second zone, a third zone, a fourth zone and a fifth zone along a first direction, wherein the first mask layer exposes a first strip region and a second strip region of the substrate extending in the first direction, and the first mask layer covers a central region of the substrate between the first and second strip regions;
performing a second etch on the substrate using a second mask layer, wherein the second mask layer exposes a first portion in the first and second strip regions and the central region in the fifth zone, and exposes a second portion extending from the first portion and tapering from the fifth zone to the third zone in the first and second strip regions;
performing a third etch on the substrate using a third mask layer, wherein the third mask layer exposes a third portion in the first and second strip regions and the central region in the first, second and third zones, and exposes a fourth portion extending from the third portion and tapering from the third zone to the fifth zone; and
performing a fourth etch on the substrate using a fourth mask layer, wherein the fourth mask layer exposes a fifth portion in the first and second strip regions and the central region in the first zone, and exposes a sixth portion extending from the fifth portion and tapering from the first zone to the second zone in the first and second strip regions.

12. The method according to claim 11, wherein the substrate comprises a silicon layer, wherein the first etch forms a first protrusion region, two first connecting regions, a first support region and a second support region in the silicon layer, wherein the first support region and the second support region are connected to the first protrusion region through the two first connecting regions, respectively.

13. The method according to claim 12, wherein the substrate further comprises a hard mask layer over the silicon layer, wherein the second etch forms a first step on a first corner of the hard mask layer of the first support region or the second support region facing the first protrusion region in the third, fourth and fifth zones.

14. The method according to claim 13, wherein the third etch forms a second step on a second corner of the hard mask layer of the first support region or the second support region facing the first protrusion region in the first and second zones.

15. The method according to claim 14, wherein the fourth etch forms a third step on the second step of the second corner.

16. The method according to claim 11, wherein the second mask layer covers the first and second strip regions and the central region of the substrate in the first and second zones.

17. The method according to claim 11, wherein the fourth mask layer covers the first and second strip regions and the central region in the third, fourth and fifth zones.

18. A semiconductor waveguide device comprising:
a substrate comprising a first zone, a second zone, a third zone, a fourth zone and a fifth zone arranged in sequence in a first direction, the substrate including:
a first protrusion region extending in the first direction from the first zone to the fifth zone, the first protrusion region having a first thickness;
two first connecting regions extending in the first direction in the first zone and the second zone, and connected to two sides of the first protrusion region from a bottom of the first protrusion region, wherein each of the first connecting regions comprises a base portion having a second thickness less than the first thickness and a wing portion over the base portion, the wing portion tapering from the second zone to the first zone from a top-view perspective; and
two second connecting regions extending in the first direction and connected to the first protrusion region from the bottom of the first protrusion region in the third and fourth zones, wherein each of the second connecting regions tapers from the third zone to the fourth zone from a top-view perspective.

19. The semiconductor waveguide device according to claim 18, configured to form a rib waveguide in a first cross section between the second zone and the third zone.

20. The semiconductor waveguide device according to claim 18, configured to form a deep-rib waveguide in a second cross section in the first zone and a strip waveguide in a third cross section in the fifth zone.
